(19) United States
(12) Patent Application Publication
(10) Pub. No.: US 2011/0161634 A1
(43) Pub. Date: Jun. 30, 2011

(54) Processor, co-processor, information processing system, and method for controlling processor, co-processor, and information processing system

(75) Inventor: Hiroaki Sakaguchi, Kanagawa (JP)

(73) Assignee: Sony Corporation, Tokyo (JP)

(21) Appl. No.: 12/926,350

(22) Filed: Nov. 12, 2010

(30) Foreign Application Priority Data
Dec. 28, 2009 (JP) 2009-297764

(51) Int. Cl. G06F 9/38; G06F 9/30

(52) U.S. Cl. 712/208; 712/E09.028; 712/E09.045

(57) ABSTRACT

A processor includes a buffer that separates a sequence of instructions having no operand into segments and stores the segments, a data holder that holds data to be processed, a decoder that references the data and sequentially decodes at least one of the instructions from the top of the sequence, an instruction execution unit that executes the instruction, and an instruction sequence control unit that controls updating of the instruction sequence in accordance with the decoding result. When the decoded top instruction is a branch instruction and if a branch is taken, the instruction sequence control unit updates the sequence so that the top instruction of one of the segments is located at the top of the sequence. If a branch is not taken, the instruction sequence control unit updates the sequence so that an instruction immediately next to the branch instruction is located at the top of the sequence.

### BACKGROUND OF THE INVENTION

1. Field of the Invention

The present invention relates to an information processing system and, in particular, to a processor for executing a sequence of instructions formed from a plurality of instructions having no operand, a co-processor, an information processing system, and a method for controlling the processor, co-processor, and information processing system.

2. Description of the Related Art

Microprocessors have basic arithmetic instructions (basic instructions). By combining a plurality of the instructions, microprocessors can perform a desired operation. In order to improve the performance of a microprocessor for a particular application, a new instruction that provides the operations of a plurality of selected instructions can be added. That is, by combining a plurality of instructions into a single instruction, an advantage of compressing instructions can be obtained. Thus, the performance can be increased. This is because the number of necessary processing cycles is reduced and the number of instructions is reduced. Even when a plurality of instructions are grouped into a single instruction, the instruction can be executed within a number of cycles that is the same as that necessary for a basic instruction (normally one cycle) if the processing load is not too high. However, if the processing load is high, the number of cycles of the instruction may be the same as the number of processing cycles necessary for the plurality of instructions even after the plurality of instructions are combined into a single instruction. Even in such a case, the number of instructions is decreased and, therefore, the following three advantages that may reduce the number of processing cycles can be obtained.

A first advantage is that in a processor with an instruction cache, an amount of processing that can be defined for one instruction cache line can be increased. In general, the capacity of a primary instruction cache is several KBs. If a sequence of an instructions that performs a large amount of processing are fetched into the limited capacity, an advantage that is the same as that obtained when the capacity is increased can be obtained, as compared with the case in which only basic instructions are used. Thus, the cache hit ratio can be increased and, therefore, the number of processing cycles can be reduced (an advantage of increasing the instruction cache hit ratio).

A second advantage is that, through loop unrolling, the number of loop processing instructions (e.g., a branch instruction) can be reduced and, therefore, the number of processing cycles can be reduced. In loop processing, about four instructions are necessary for loop condition variable initialization, loop condition variable update, loop condition variable comparison, and branch. For example, four loop processing is discussed below. If a loop includes 5 basic instructions, 20 instructions (5 instructions×4 loops) are generated. Thereafter, 4 loop processing instructions are removed. Thus, a total of 16 instructions are generated through loop unrolling. In contrast, when the five basic instructions are combined into a single instruction, only four instructions including four of the single instruction for loop are generated. In such a case, the number of instructions is smaller than five instructions before loop unrolling is performed, that is, four loop processing instructions plus an instruction to be looped. In general, a pipeline processor is designed so that a branch instruction has a number of cycles more than that of a normal instruction, since the branch instruction causes a branch operation. Accordingly, even when the number of instructions is increased from that before loop unrolling, the number of processing cycles may be reduced since the number of executions of the branch instruction is reduced (an advantage obtained when loop unrolling is employed).

A third advantage is that the number of bus accesses for instruction fetch is reduced since the program size is reduced. Thus, the degree of congestion of the bus can be reduced and, therefore, the access latency of instruction fetch and data fetch in a multi-processor system can be reduced. That is, the number of processing cycles can be indirectly reduced (an advantage of reducing bus traffic).

As described above, an advantage of combining several instructions into a single instruction is significant. However, the number of combined instructions is limited, since the number of bits of the ope code is limited and the processing speed of an instruction decoder is reduced. Accordingly, by providing a certain number of grouped instructions for each application, a processor having an improved performance for a particular application can be realized.

In addition, in recent years, computers that execute instructions having no operand (e.g., stack machines and queue machines) have been developed. For example, an information processing apparatus that uses a stack machine in a pixel combining module of a graphic object co-processor has been developed (refer to, for example, Japanese Unexamined Patent Application Publication No. 2001-005776 and, in particular, FIG. 9).

### SUMMARY OF THE INVENTION

In the above-described existing technology, by combining a plurality of instructions into a single instruction or using instructions having no operand in a stack machine or a queue machine, the instructions can be compressed and, therefore, the number of processing cycles can be reduced.

However, even when instructions are compressed using such techniques, a branch instruction is necessary in order to provide branch of processing. Accordingly, it is necessary to hold or generate a branch address in some way. In addition, if no restrictions are imposed on a branch address, it is difficult to determine the candidates of a branch address before instruction decoding. Accordingly, efficient pre-fetch of the branch destination is difficult.

Accordingly, the present invention provides a technique for increasing the efficiency of compressing an instruction by limiting branch destinations of a branch instruction.

In order to solve the above-described problem, according to an embodiment of the present invention, a processor includes an instruction buffer that separates a sequence of instructions formed from a plurality of instructions having no operand into a plurality of segments and stores the segments, a data holding unit that holds data to be processed by using the plurality of instructions, a decoder that references the data held in the data holding unit and sequentially decodes at least one of the instructions from the instruction located at the top of the sequence of instructions one by one, an instruction execution unit that executes the instruction in accordance with a result of decoding performed by the decoder, and an instruction sequence update control unit that controls updating of the sequence of instructions in accordance with the result of decoding performed by the decoder. When the decoded top instruction is a branch instruction and if a branch is taken, the instruction sequence update control unit updates the sequence of instructions so that the top instruction of any one of the segments comes to be located at the top of the sequence of instructions, and if a branch is not taken, the instruction sequence update control unit updates the sequence of instructions so that an instruction immediately next to the branch instruction comes to be located at the top of the sequence of instructions. In this way, an advantage of limiting a branch destination to the top of a segment can be provided.

A branch destination of the branch instruction can be limited to an instruction at the top of the segment ahead of the segment including the branch instruction. In this way, the occurrence of deadlock can be prevented.

The decoder can decode a function type regarding a function for executing an instruction and an execution type regarding updating of the sequence of instructions after the instruction is executed, the instruction execution unit can execute the instruction in accordance with the function type, and the instruction sequence update control unit can control updating of the sequence of instructions in accordance with the execution type. In this way, the sequence of instructions can be updated in accordance with the function type and the execution type.

The decoder can reference the data held in the data holding unit and sequentially decode a plurality of the instructions starting from the instruction located at the top of the sequence of instructions, and the instruction execution unit can concurrently execute a number of the instructions equal to a number determined in accordance with the function type. The instruction sequence update control unit can control updating of the sequence of instructions so that a number of the instructions equal to a number determined in accordance with the execution type are output from the instruction buffer. In this way, the instructions can be executed through folding.

The instruction sequence update control unit has a function for shifting the instructions of only the top segment of the plurality of segments one by one and holds a state flag indicating whether each of the instructions contained in the top segment is held in only the top segment.

Data stored in the data holding unit can include a stack, and a data item held at the top of the stack can be output when execution of the sequence of instructions is completed. In such a case, the stack can have a predetermined number of stages, and if a number of data items that exceeds the predetermined number of stages are input to the stack, data items can disappear from a data item held at the bottom of the stack. In this way, the number of stages of the stack can be limited.

The data held in the data holding unit can include a queue, and a data item held at the tail of the queue can be output when execution of the sequence of instructions is completed.

The processor can further include a data format specifying unit that specifies a format of the data item output when execution of the sequence of instructions is completed.

According to another embodiment of the present invention, a co-processor and an information processing system including the co-processor are provided. The co-processor includes an instruction buffer that receives, from a higher-layer processor, a sequence of instructions formed from a plurality of instructions having no operand, separates the instructions into a plurality of segments, and stores the segments, a data holding unit that holds data to be processed by using the plurality of instructions, a decoder that references the data held in the data holding unit and sequentially decodes at least one of the instructions from the instruction located at the top of the sequence of instructions, an instruction execution unit that executes the instruction in accordance with a result of decoding performed by the decoder, an instruction sequence update control unit that controls updating of the sequence of instructions in accordance with the result of decoding performed by the decoder, and an output unit that outputs the data held in the data holding unit when execution of the sequence of instructions is completed. When the decoded top instruction is a branch instruction and if a branch is taken, the instruction sequence update control unit updates the sequence of instructions so that the top instruction of any one of the segments comes to be located at the top of the sequence of instructions, and if a branch is not taken, the instruction sequence update control unit updates the sequence of instructions so that an instruction immediately next to the branch instruction comes to be located at the top of the sequence of instructions. In this way, in processing performed in the co-processor, an advantage of limiting a branch destination to the top of a segment can be provided.

According to still another embodiment of the present invention, an instruction sequence update control method for use in a processor is provided. The processor includes an instruction buffer that separates a sequence of instructions formed from a plurality of instructions having no operand into a plurality of segments and stores the segments, a data holding unit that holds data to be processed by using the plurality of instructions, a decoder that references the data held in the data holding unit and sequentially decodes at least one of the instructions from the instruction located at the top of the sequence of instructions, an instruction execution unit that executes the instruction in accordance with a result of decoding performed by the decoder, and an instruction sequence update control unit that controls updating of the sequence of instructions in accordance with the result of decoding performed by the decoder. The method includes the steps of, when the decoded top instruction is a branch instruction and if a branch is taken, updating the sequence of instructions so that the top instruction of any one of the segments comes to be located at the top of the sequence of instructions, and if a branch is not taken, updating the sequence of instructions so that an instruction immediately next to the branch instruction comes to be located at the top of the sequence of instructions. In this way, an advantage of limiting a branch destination to the top of a segment can be provided.

According to the present invention, by limiting branch destinations of a branch instruction, a significant advantage in that the efficiency of compressing an instruction is increased can be provided.

### BRIEF DESCRIPTION OF THE DRAWINGS

FIG. 1 illustrates an example configuration of an information processing system according to a first embodiment of the present invention;

FIG. 2 illustrates an example configuration of a microinstruction processing co-processor according to the first embodiment of the present invention;

FIGS. 3A to 3C illustrate example structures of microprograms stored in a microprogram memory according to the first embodiment of the present invention;

FIG. 4 illustrates an example configuration of a microprogram execution unit according to the first embodiment of the present invention;

FIGS. 5A and 5B illustrate an example structure of working data stored in a working register according to the first embodiment of the present invention;

FIGS. 6A to 6D illustrate examples of a relationship between a write back format stored in a write back format register and the processing of data according to the first embodiment of the present invention;

FIG. 7 illustrates an example configuration of a microinstruction buffer according to the first embodiment of the present invention;

FIG. 8 illustrates example configurations of four instruction buffers according to the first embodiment of the present invention;

FIG. 9 illustrates an example configuration of a segment update selector according to the first embodiment of the present invention;

FIG. 10 illustrates an example of a microinstruction set of the information processing system according to the first embodiment of the present invention;

FIGS. 11A to 11C illustrate branch destinations of branch instructions of the information processing system according to the first embodiment of the present invention;

FIG. 12 illustrates the state of a microinstruction buffer according to the first embodiment of the present invention;

FIG. 13 illustrates an example of a state transition of an instruction buffer state flag (when a single instruction is executed per cycle) according to the first embodiment of the present invention;

FIG. 14 illustrates an example of a state transition of an instruction buffer state flag (when a maximum of two instructions are executed per cycle) according to the first embodiment of the present invention;

FIG. 15 illustrates an example of a state transition of an instruction buffer state flag (when a maximum of three instructions are executed per cycle) according to the first embodiment of the present invention;

FIG. 16 illustrates an example of a state transition of an instruction buffer state flag (when a maximum of four instructions are executed per cycle) according to the first embodiment of the present invention;

FIG. 17 illustrates a first example of the configuration of a microprogram instruction decoder according to the first embodiment of the present invention;

FIG. 18 illustrates the processing procedure performed by a first configuration of a function type determination unit according to the first embodiment of the present invention;

FIG. 19 illustrates the processing procedure of a first configuration of an execution type determination unit according to the first embodiment of the present invention;

FIG. 20 illustrates a second example of the configuration of the microprogram instruction decoder according to the first embodiment of the present invention;

FIG. 21 illustrates the processing procedure (example 1) of the second example configuration of the function type determination unit according to the first embodiment of the present invention;

FIG. 22 illustrates the processing procedure (example 2) of the second example configuration of the function type determination unit according to the first embodiment of the present invention;

FIG. 23 illustrates the processing procedure (example 3) performed by the second example configuration of the function type determination unit according to the first embodiment of the present invention;

FIG. 24 illustrates the processing procedure (example 1) performed by the second example configuration of the execution type determination unit according to the first embodiment of the present invention;

FIG. 25 illustrates the processing procedure (example 2) performed by the second example configuration of the execution type determination unit according to the first embodiment of the present invention;

FIG. 26 illustrates an example of a data operation performed by a NOP instruction in a micro instruction set according to the first embodiment of the present invention;

FIG. 27 illustrates an example of a data operation performed by a DUP instruction in the micro instruction set according to the first embodiment of the present invention;

FIG. 28 illustrates an example of a data operation performed by a POP instruction in the micro instruction set according to the first embodiment of the present invention;

FIG. 29 illustrates an example of a data operation performed by a POPX2 instruction in the micro instruction set according to the first embodiment of the present invention;

FIG. 30 illustrates an example of a data operation performed by a ROT instruction in the micro instruction set according to the first embodiment of the present invention;

FIG. 31 illustrates an example of a data operation performed by a ROT4 instruction in the micro instruction set according to the first embodiment of the present invention;

FIG. 32 illustrates an example of a data operation performed by a SWAP instruction in the micro instruction set according to the first embodiment of the present invention;

FIG. 33 illustrates an example of a data operation performed by a SORT instruction in the micro instruction set according to the first embodiment of the present invention;

FIG. 34 illustrates an example of a data operation performed by a first operand arithmetic instruction, such as a NOT instruction, in the micro instruction set according to the first embodiment of the present invention;

FIG. 35 illustrates an example of a data operation performed by a second operand arithmetic instruction, such as an EQ instruction, in the micro instruction set according to the first embodiment of the present invention;

FIG. 36 illustrates an example of a data operation performed by a SER instruction in the micro instruction set according to the first embodiment of the present invention;

FIG. 37 illustrates an example of a data operation performed by a ONE instruction or a ZERO instruction in the micro instruction set according to the first embodiment of the present invention;

FIG. 38 illustrates an example of a data operation performed by an LD0 instruction in the micro instruction set according to the first embodiment of the present invention;

FIG. 39 illustrates an example of a data operation performed by an LD1 instruction in the micro instruction set according to the first embodiment of the present invention;

FIG. 40 illustrates an example of a data operation performed by an LD2 instruction in the micro instruction set according to the first embodiment of the present invention;

FIG. 41 illustrates an example of a data operation performed by an ST0 instruction in the micro instruction set according to the first embodiment of the present invention;

FIG. 42 illustrates an example of a data operation performed by an ST1 instruction in the micro instruction set according to the first embodiment of the present invention;

FIG. 43 illustrates an example of a data operation performed by an ST2 instruction in the micro instruction set according to the first embodiment of the present invention;

FIG. 44 illustrates an example of the configuration of a two-operand arithmetic unit used for the microinstruction set according to the first embodiment of the present invention;

FIG. 45 illustrates an example of the configuration of a MIN arithmetic unit used for the microinstruction set according to the first embodiment of the present invention;

FIG. 46 illustrates an example of the configuration of a MAX arithmetic unit used for the microinstruction set according to the first embodiment of the present invention;

FIG. 47 illustrates an example of the configuration of a GT arithmetic unit used for the microinstruction set according to the first embodiment of the present invention;

FIG. 48 illustrates an example of the configuration of a GE arithmetic unit used for the microinstruction set according to the first embodiment of the present invention;

FIG. 49 illustrates an example of the configuration of an EQ arithmetic unit used for the microinstruction set according to the first embodiment of the present invention;

FIG. 50 illustrates an example of the configuration of an SER arithmetic unit used for the microinstruction set according to the first embodiment of the present invention;

FIG. 51 illustrates an example of the configuration of a PAR arithmetic unit used for the microinstruction set according to the first embodiment of the present invention;

FIG. 52 illustrates an example of the configuration of a one-operand arithmetic unit used for the microinstruction set according to the first embodiment of the present invention;

FIG. 53 illustrates an example of the configuration of an ORLU arithmetic unit used for the microinstruction set according to the first embodiment of the present invention;

FIG. 54 illustrates an example of the configuration of an LU arithmetic unit used for the microinstruction set according to the first embodiment of the present invention;

FIGS. 55A and 55B illustrate examples of folding of DUP_ST0 according to the first embodiment of the present invention;

FIGS. 56A and 56B illustrate examples of folding of LD0_EQ_ST1 according to the first embodiment of the present invention;

FIGS. 57A and 57B illustrate examples of folding of LD0_EQ_SWAP according to the first embodiment of the present invention;

FIG. 58 illustrates an example of a list of microprograms for the information processing system according to the first embodiment of the present invention;

FIG. 59 illustrates a branch path of a NULL microprogram according to the first embodiment of the present invention;

FIG. 60 illustrates a branch path of a MEAN microprogram according to the first embodiment of the present invention;

FIG. 61 illustrates a branch path of a MEDIAN3 microprogram according to the first embodiment of the present invention;

FIG. 62 illustrates a branch path of a MEDIAN4 microprogram according to the first embodiment of the present invention;

FIG. 63 illustrates a branch path of a MEDCND microprogram according to the first embodiment of the present invention;

FIG. 64 illustrates a branch path of a MED3 microprogram according to the first embodiment of the present invention;

FIG. 65 illustrates a branch path of a SMOD microprogram according to the first embodiment of the present invention;

FIG. 66 illustrates a branch path of a DBMD_FRM microprogram according to the first embodiment of the present invention;

FIG. 67 illustrates a branch path of a DBMD_FLD microprogram according to the first embodiment of the present invention;

FIG. 68 illustrates a branch path of a DBIDX microprogram according to the first embodiment of the present invention;

FIG. 69 illustrates a branch path of a first sample using a JP instruction according to the first embodiment of the present invention;

FIG. 70 illustrates a branch path of a second sample using a JP instruction according to the first embodiment of the present invention;

FIG. 71 illustrates an example of a list of co-processor instructions of the higher-layer processor according to the first embodiment of the present invention;

FIGS. 72A and 72B illustrate examples of an instruction format according to the first embodiment of the present invention;

FIGS. 73A to 73E illustrate an example of an instruction group for instructing execution of a microprogram from the higher-layer processor according to the first embodiment of the present invention; and

FIGS. 74A and 74B illustrate an example of the configuration of a queue register stored in a working register according to a second embodiment of the present invention.

### DESCRIPTION OF THE PREFERRED EMBODIMENTS

Embodiments of the present invention are described below. Descriptions are made in the following order:

1. First Embodiment (Example Configuration Including Stack Machine)

2. Second Embodiment (Example Configuration Including Queue Machine)

3. Modifications

### 1. First Embodiment

### Example Configuration of Information Processing System

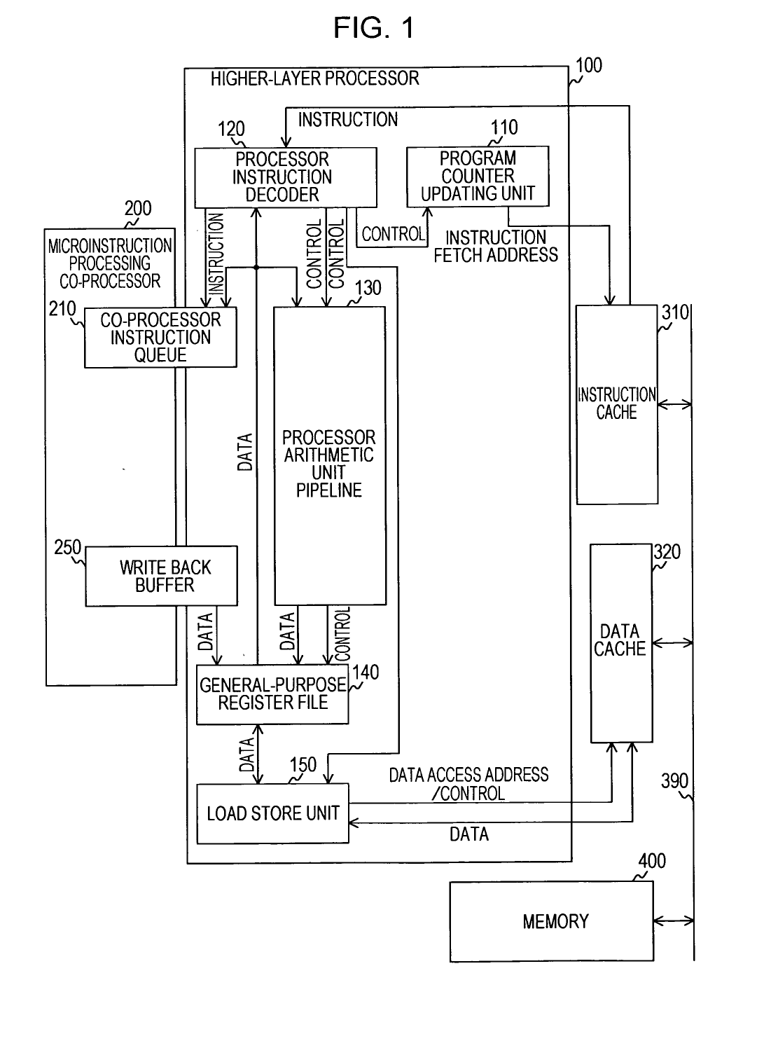

FIG. 1 illustrates an example configuration of an information processing system according to a first embodiment of the present invention. The information processing system includes a higher-layer processor 100, a microinstruction processing co-processor 200, an instruction cache 310, a data cache 320, a memory bus 390, and a memory 400.

The higher-layer processor 100 is located in a layer higher than that of the microinstruction processing co-processor 200. The higher-layer processor 100 instructs the microinstruction processing co-processor 200 to execute a co-processor instruction. The higher-layer processor 100 performs processing using data stored in the memory 400. The instruction cache 310 and the data cache 320 are connected between the higher-layer processor 100 and the memory 400 using the memory-bus 390.

The memory 400 holds an instruction and data necessary for processing performed by the higher-layer processor 100. A copy of part of the data in the memory 400 is held in the instruction cache 310 and the data cache 320. The instruction cache 310 is a cache memory for storing an instruction (a processor instruction) of the higher-layer processor 100. The data cache 320 is a cache memory for storing data necessary for the higher-layer processor 100 to process the instruction. The memory bus 390 is used for connecting the memory 400 to the instruction cache 310 and the data cache 320.

The higher-layer processor 100 includes a program counter updating unit 110, a processor instruction decoder 120, a processor arithmetic unit pipeline 130, a general-purpose register file 140, and a load store unit 150.

The program counter updating unit 110 includes a program counter that stores an instruction (processor instruction) address of a program that is currently executed. The program counter updating unit 110 further includes a circuit for updating the program counter. The program counter updating unit 110 updates the program counter in response to a control signal sent from the processor instruction decoder 120. The address stored in the program counter is supplied to the instruction cache 310 and serves as an instruction fetch address.

The processor instruction decoder 120 decodes an instruction (a processor instruction) fetched using the instruction fetch address. As a result of decoding performed by the processor instruction decoder 120, control signals are supplied to a variety of components of the higher-layer processor 100.

The processor arithmetic unit pipeline 130 is an arithmetic unit that performs an arithmetic operation in the higher-layer processor 100. The general-purpose register file 140 stores general-purpose registers (GPRs) of the higher-layer processor 100. The load store unit 150 loads data from the memory 400 and stores data in the memory 400.

The microinstruction processing co-processor 200 is a co-processor that operates under the control of the higher-layer processor 100. When the processor instruction decoder 120 detects a co-processor instruction, the microinstruction processing co-processor 200 is instructed to execute the co-processor instruction via a co-processor instruction queue 210. The result of execution of the microinstruction processing co-processor 200 is written back to the general-purpose register file 140 via a write back buffer 250.

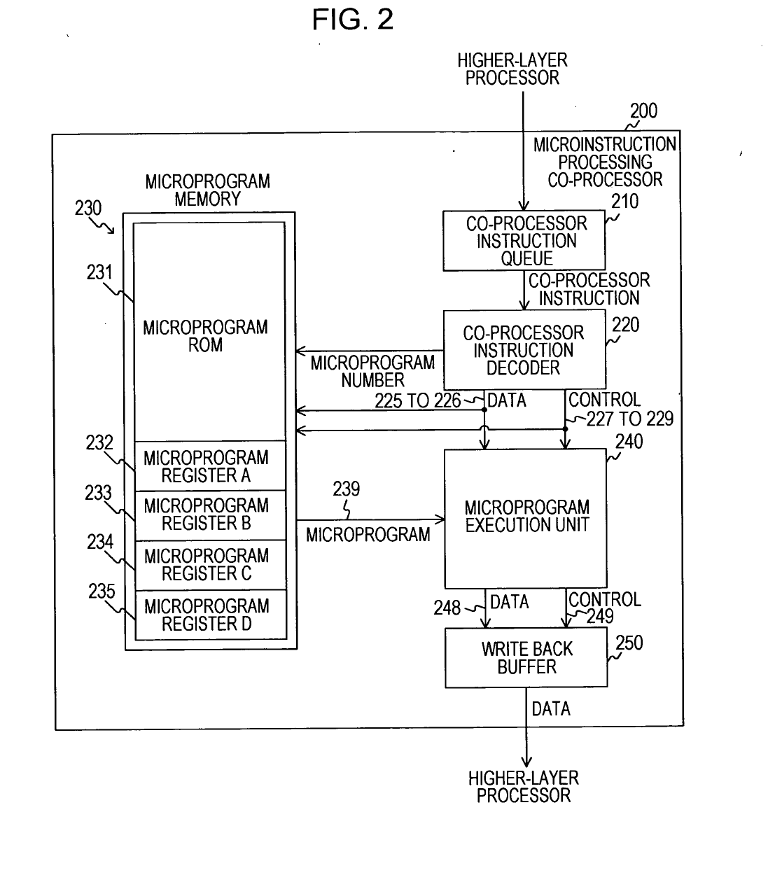

FIG. 2 illustrates an example configuration of the microinstruction processing co-processor 200 according to the first embodiment of the present invention. The microinstruction processing co-processor 200 includes the co-processor instruction queue 210, a co-processor instruction decoder 220, a microprogram memory 230, a microprogram execution unit 240, and a write back buffer 250.

The co-processor instruction queue 210 is a first-in first-out (FIFO) queue for storing co-processor instructions submitted from the higher-layer processor 100. The co-processor instructions stored in the co-processor instruction queue 210 are sequentially supplied to the co-processor instruction decoder 220. Note that the co-processor instructions stored in the co-processor instruction queue 210 are not necessarily the same as the co-processor instructions used in the higher-layer processor 100. For example, only values necessary for the general-purpose registers may be embedded in the co-processor instruction queue 210.

The co-processor instruction decoder 220 is a decoder that decodes a co-processor instruction supplied from the co-processor instruction queue 210. As a result of a decoding operation performed by the co-processor instruction decoder 220, a microprogram number (an MPID) in the microprogram memory 230, data, and a control signal are generated.

The microprogram memory 230 is a memory for storing a microprogram group. The microprogram memory 230 includes a microprogram ROM 231 and microprogram registers A to D (232 to 235). The microprogram ROM 231 is a memory for storing a predetermined microprogram group. In general, the microprogram ROM 231 is not rewritable. In contrast, the microprogram registers A to D (232 to 235) serve as memories that can store a microprogram group that can be defined by a user. The microprogram registers A to D (232 to 235) are rewritable through a microprogram update instruction. Upon receiving a microprogram number from the co-processor instruction decoder 220, the microprogram memory 230 supplies a microprogram stored at a corresponding address to the microprogram execution unit 240 via a signal line 239.

The microprogram execution unit 240 executes the microprogram supplied from the microprogram memory 230. The microprogram execution unit 240 outputs the result of execution to the write back buffer 250. According to the first embodiment, the microprogram execution unit 240 has a stack machine configuration. Note that the microprogram execution unit 240 is an example of an instruction execution unit defined in the Claims. The microprogram execution unit 240 is described in more detail below.

The write back buffer 250 is a buffer for storing the result of execution output from the microprogram execution unit 240. The write back buffer 250 writes back the result of execution performed by the microinstruction processing co-processor 200 to the general-purpose register file 140 of the higher-layer processor 100.

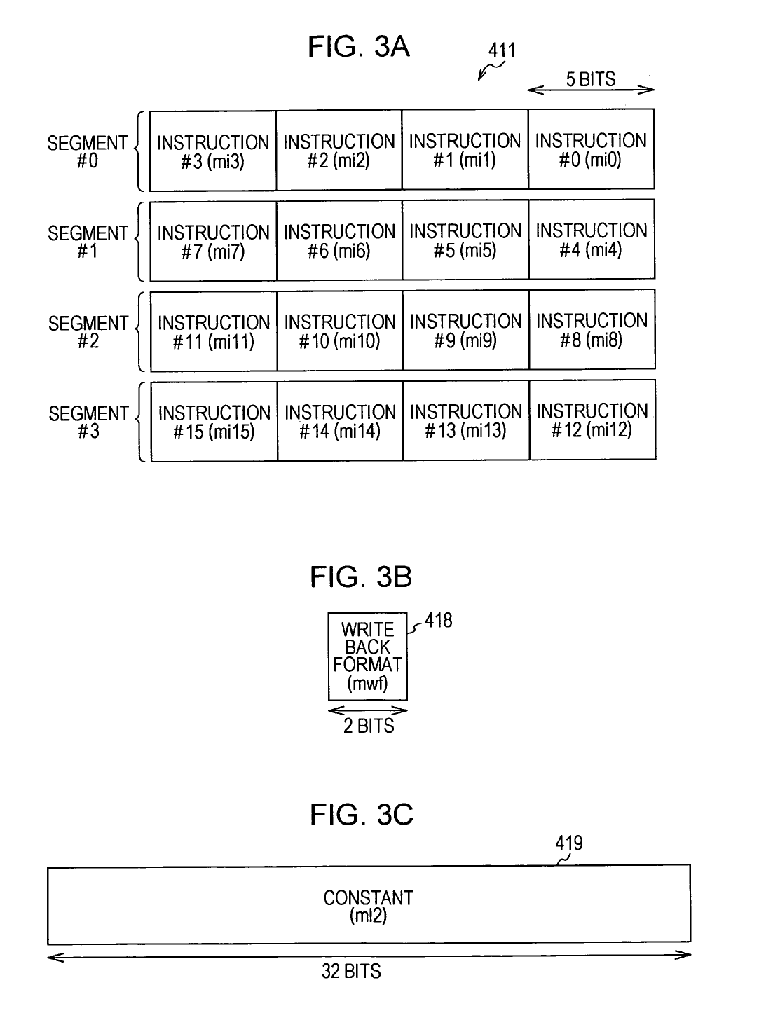

FIGS. 3A to 3C illustrate example structures of the microprograms stored in the microprogram memory 230 according to the first embodiment of the present invention. In this example, each of the microprograms includes 16 microinstructions (mi0 to mi15) 411, a write back format (mwf) 418, and a constant (m12) 419.

Each of the microinstructions 411 has a 5-bit data structure. The microinstructions 411 are sequentially executed from that having the smallest number (mi0). However, as described below, a plurality of microprocessors may be executed at the same time. As shown in FIG. 3A, four microinstructions 411 form a segment. That is, the microinstructions #0 to #3 form a segment #0. The microinstructions #4 to #7 form a segment #1. The microinstructions #8 to #11 form a segment #2. The microinstructions #12 to #15 form a segment #3.

As shown in FIG. 3B, the write back format (mwf) 418 has a 2-bit data structure. The write back format (mwf) 418 defines a data format used when data is written back to the higher-layer processor 100. The write back format (mwf) 418 is described in more detail below.

As shown in FIG. 3C, the constant 419 has a 32-bit data structure. The constant 419 serving as a constant data is referenced by each of the microinstructions.

According to the first embodiment of the present invention, the microprogram execution unit 240 has a stack machine configuration. Thus, an operand is not necessary, and specification of a branch address is not necessary. In this way, 5-bit fixed length microinstructions are defined. In addition, since the length of an instruction can be decreased and data can be manipulated in simplified working registers, the circuit can be simplified. Accordingly, high-frequency operation can be achieved.

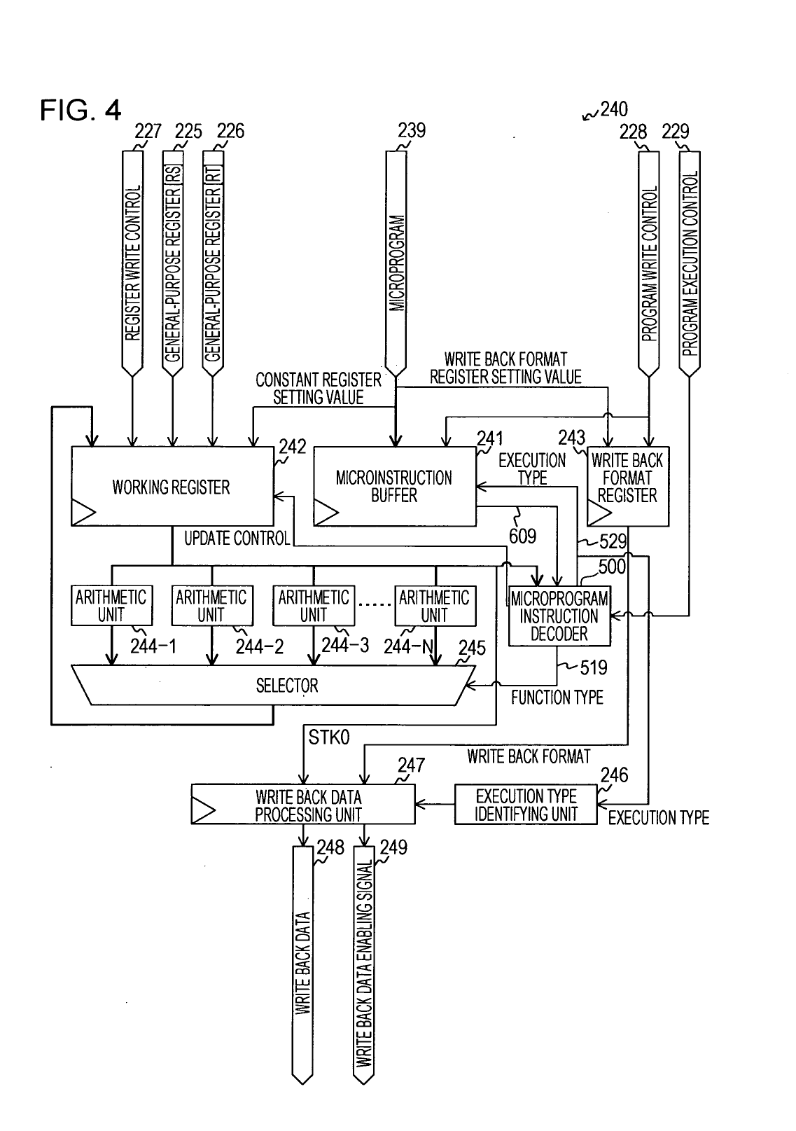

FIG. 4 illustrates an example configuration of the microprogram execution unit 240 according to the first embodiment of the present invention. The microprogram execution unit 240 includes a microinstruction buffer 241, a working register 242, a microprogram instruction decoder 500, a write back format register 243, arithmetic units 244-1 to 244-N, a selector 245, an execution type identifying unit 246, and a write back data processing unit 247.

The microinstruction buffer 241 stores 16 microinstructions 411 among the microinstructions 411 supplied from the microprogram memory 230. The microinstructions 411 stored in the microinstruction buffer 241 are supplied to the microprogram instruction decoder 500 via a signal line 609.

The working register 242 is a register for storing working data necessary for execution of a microprogram. An exemplary data structure of the working data is described in more detail below. Note that the working register 242 is an example of a data holding unit defined in the Claims.

The microprogram instruction decoder 500 decodes the microinstructions 411 stored in the microinstruction buffer 241. When the microprogram instruction decoder 500 performs a decoding operation, the working data stored in the working register 242 is referenced. As a result of the decoding operation, a function type and an execution type are determined. The function type and the execution type are output via signal lines 519 and 529. The function type is used for identifying the function of instruction execution. The execution type is a type regarding updating of the microinstruction buffer 241 and writing back of data after an instruction is executed. Note that the microprogram instruction decoder 500 is an example of a decoder defined in the Claims.

The write back format register 243 is a register for storing the write back format 418 of the microprogram supplied from the microprogram memory 230. The write back format stored in the write back format register 243 remains unchanged until execution of the microprogram is completed. When execution of the microprogram is completed, the write back format is supplied to the write back data processing unit 247. Note that the write back format register 243 is an example of a data format specifying unit defined in the Claims.

The arithmetic units 244-1 to 244-N are N SIMD (Single Instruction Multiple Data) arithmetic units that can operate in parallel. The arithmetic units 244-1 to 244-N may perform different functional types of computation or the same type of computation. Note that hereinafter, the arithmetic units 244-1 to 244-N are collectively referred to as “arithmetic units 244” as appropriate.

The selector 245 is a selector that selects one of the results of computation performed by the N arithmetic units 244 in accordance with the function type, which is the result of a decoding operation performed by the microprogram instruction decoder 500. Thereafter, the selector 245 supplies the selected one to the working register 242. As described below, a plurality of the results of computation may be selected for a certain function type.

The execution type identifying unit 246 identifies an execution type, which is the result of a decoding operation performed by the microprogram instruction decoder 500. That is, the execution type identifying unit 246 determines whether the execution type indicates a RET instruction that represents completion of execution of a microprogram. If the execution type indicates a RET instruction, the execution type identifying unit 246 instructs the write back data processing unit 247 to process the write back data.

Upon being instructed by the execution type identifying unit 246, the write back data processing unit 247 processes the data stored in the working register 242 and outputs the processed data to a signal line 248 in the form of write back data. The write back data processing unit 247 processes the data in accordance with the write back format supplied from the write back format register 243. In addition, when effective write back data is output, a write back data enabling signal is output from a signal line 249.

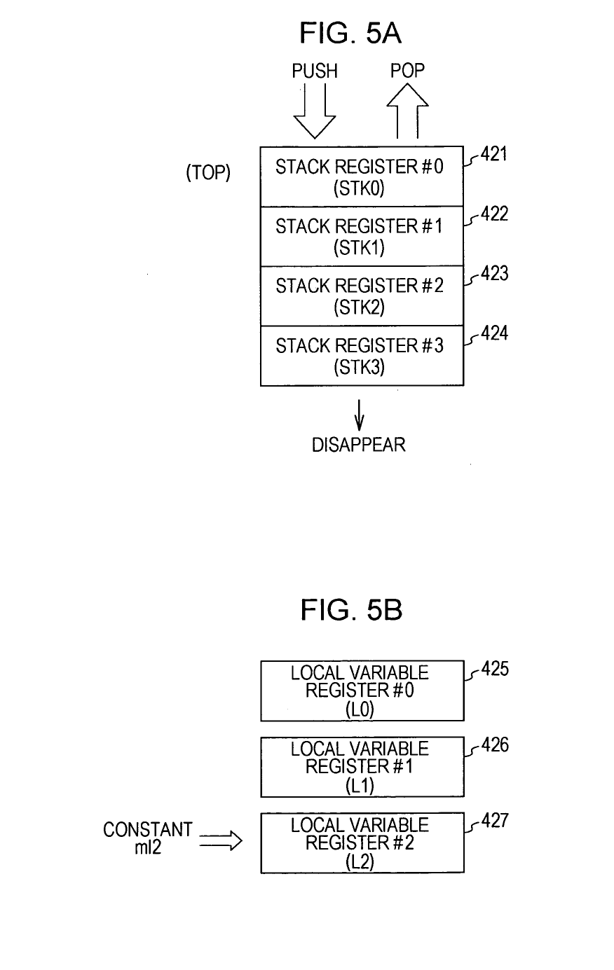

FIGS. 5A and 5B illustrate an example structure of the working data stored in the working register 242 according to the first embodiment of the present invention. According to the first embodiment, the microprogram execution unit 240 operates as a component of a stack machine. Accordingly, the working data includes 4-stage stack registers 421 to 424 and three local variable registers 425 to 427 each having a 32-bit length. The registers can be read and written at the same time.

The stack registers 421 to 424 are referred to as “stack registers #0 to #3 (STK0 to STK3)”, respectively. A new data item is pushed onto the stack register having a smaller number. Each time a new data item is pushed, all data items are shifted. That is, when no data items are stored and if a first data item is pushed, the first data is stored in the stack register #0. Thereafter, if a second data item is pushed, the first data item is shifted into the stack register #1 and the second data item is stored in the stack register #0. In this way, each time the push operation is performed, the data items are shifted downwards. When all the stack registers #0 to #3 store data items and if a new data item is pushed, all of the data items are shifted. As a result, the data item stored in the stack register #3 disappears.

In contrast, when a pop operation is performed, a data item stored in the stack register #0 is output. Thereafter, all of the data items are shifted upwards. The data item stored in the stack register #3 remains unchanged.

When execution of a microprogram is completed, a data item stored in the stack register #0 (421) is supplied to the write back data processing unit 247 and is used to generate write back data.

Note that a set of the stack registers 421 to 424 is an example of a stack defined in the Claims.

Each of the local variable registers 425 to 427 represents an area used as a stand-alone register. The value in each of the local variable registers 425 to 427 can be pushed onto the stack register #0 using a load microinstruction. In addition, each of the local variable registers 425 to 427 can store a value popped from the stack register #0 using a store microinstruction. The local variable register 427 is a special register. When a microprogram is supplied from the microprogram memory 230, the constant (m12) 419 included in the microprogram is set in the local variable register 427. Thus, the constant 419 can be used by the microinstructions 411.

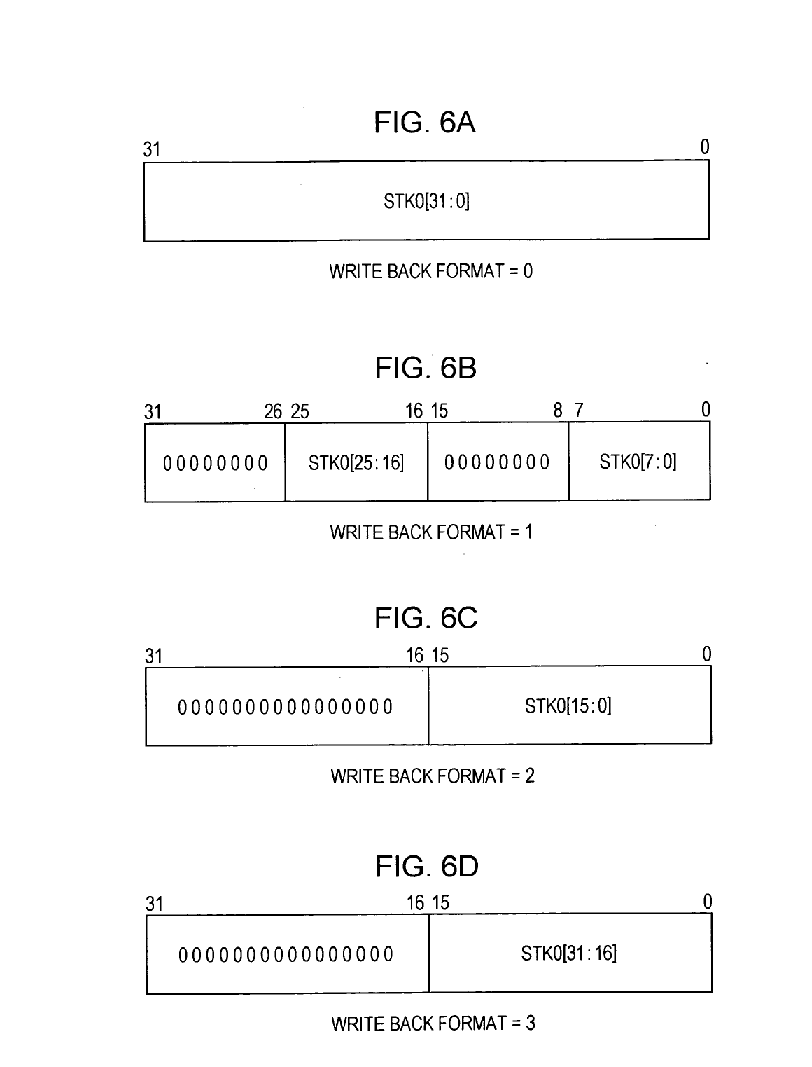

FIGS. 6A to 6D illustrate examples of a relationship between the write back format stored in the write back format register 243 and the processing of data according to the first embodiment of the present invention. In this example, the write back format has a 2-bit length. Thus, the value of the write back format ranges from “0” to “3”. In accordance with the write back format, the following data processing is performed on the 32-bit data STK0 stored in the stack register #0 by the write back data processing unit 247.

First, when the write back format represents “0”, the data STK0[31:0] stored in the stack register #0 is directly output as write back data. Alternatively, when the write back format represents “1”, eight bits from the 8th bit to 15th bit and eight bits from the 26th bit to 31st bit in the data STK0[31:0] are filled with “0”. Thereafter, the value is output as write back data. Still alternatively, when the write back format represents “2”, a value having lower 16 bits that are the same as those of STK0[15:0] and upper 16 bits of “0”s is output as write back data. Yet still alternatively, when the write back format represents “3”, a value having lower 16 bits that are the same as those of STK0[31:16] and upper 16 bits of “0”s is output as write back data. In this way, the result of computation can be obtained in accordance with the desired data format without additional computation performed by the higher-layer processor 100.

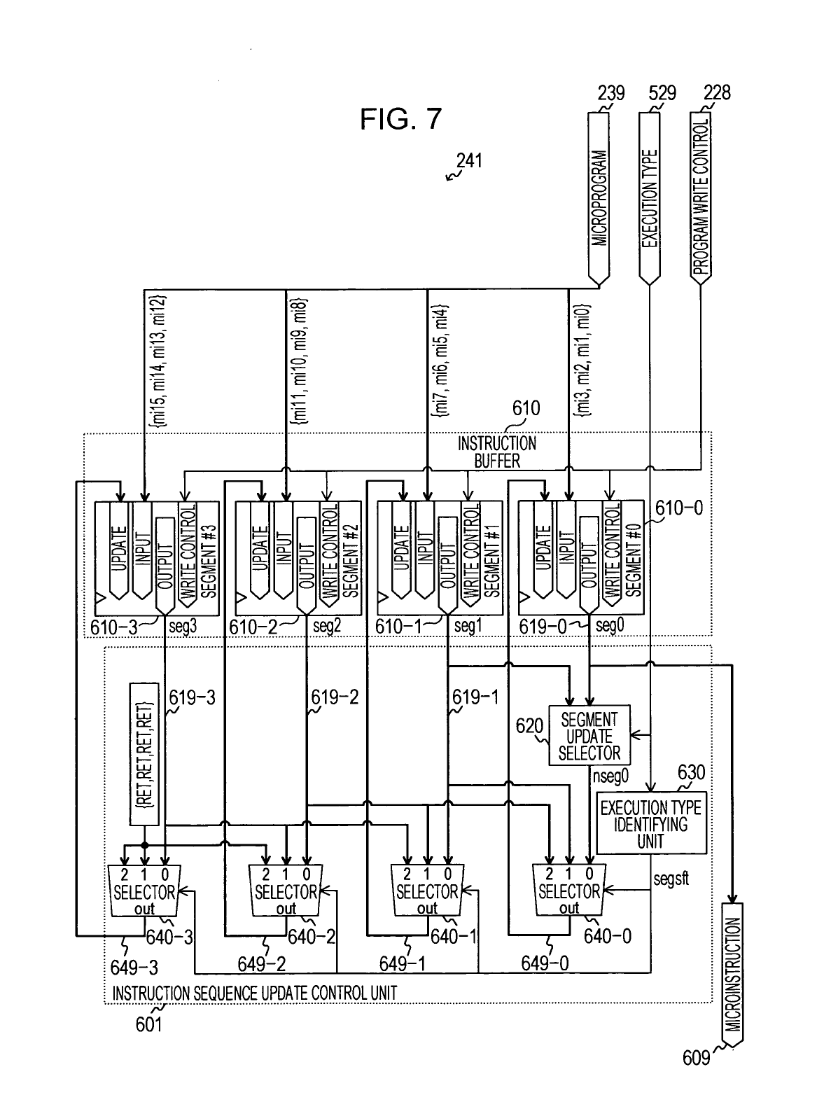

FIG. 7 illustrates an example configuration of the microinstruction buffer 241 according to the first embodiment of the present invention. The microinstruction buffer 241 includes an instruction buffer 610 that stores a sequence of microinstructions and an instruction sequence update control unit 601 that updates the sequence of instructions of the microinstruction.

The instruction buffer 610 includes instruction buffers 610-0 to 610-3 for four segments #0 to #3, respectively. Each of the instruction buffers 610-0 to 610-3 holds four microinstructions. The configuration of each of the instruction buffers 610-0 to 610-3 is described in more detail below.

The instruction sequence update control unit 601 includes a segment update selector 620, an execution type identifying unit 630, and selectors 640-0 to 640-3.

The segment update selector 620 is a selector for selecting four microinstructions nseg0, which are candidates to be subsequently stored in the instruction buffer 610-0, from among eight microinstructions seg0 and seg1 stored in the instruction buffers 610-0 and 610-1. That is, the segment to be updated by the segment update selector 620 is the segment #0. An example of the configuration of the segment update selector 620 is described in more detail below.

The execution type identifying unit 630 identifies an execution type that is the result of a decoding operation performed by the microprogram instruction decoder 500. That is, if the execution type indicates a BR instruction, which is a conditional branch instruction, the execution type identifying unit 630 supplies a selection signal segsft having a value of “2” to the selectors 640-0 to 640-3. However, if the execution type is a JP instruction, which is an unconditional branch instruction, the execution type identifying unit 630 supplies a selection signal segsft having a value of “1” to the selectors 640-0 to 640-3. Otherwise, the execution type identifying unit 630 supplies a selection signal segsft having a value of “0” to the selectors 640-0 to 640-3.

The selectors 640-0 to 640-3 are selectors for selecting four microinstructions to be subsequently stored in the instruction buffers 610-0 to 610-3. Four RET instructions are input to each of the selectors 640-2 and 640-3. This operation is described in more detail below together with description of a branch type.

The microinstruction buffer 241 sequentially supplies, to the microprogram instruction decoder 500 via the signal line 609, the microinstructions from the top in the instruction buffer 610-0 that corresponds to the segment #0.

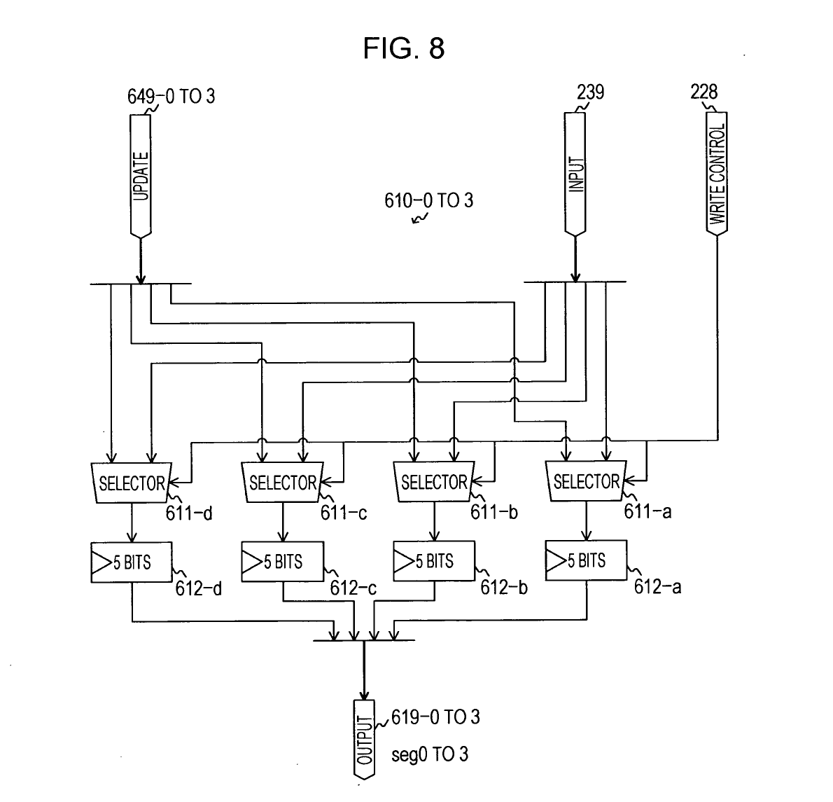

FIG. 8 illustrates an example configuration of each of the instruction buffers 610-0 to 610-3 according to the first embodiment of the present invention. Each of the instruction buffers 610-0 to 610-3 includes four selectors 611-a to 611-d and four registers 612-a to 612-d.

Each of the selectors 611-a to 611-d is a selector for selecting one of a microinstruction supplied from the microprogram memory 230 and a set of outputs from the selectors 640-0 to 640-3. A selection signal for the selectors 611-a to 611-d is supplied from the co-processor instruction decoder 220 via a signal line 228.

The registers 612-a to 612-d stores a 5-bit microinstruction selected by the selectors 611-a to 611-d, respectively. The microinstructions stored in the registers 612-a to 612-d are output via signal lines 619-0 to 619-3, respectively.

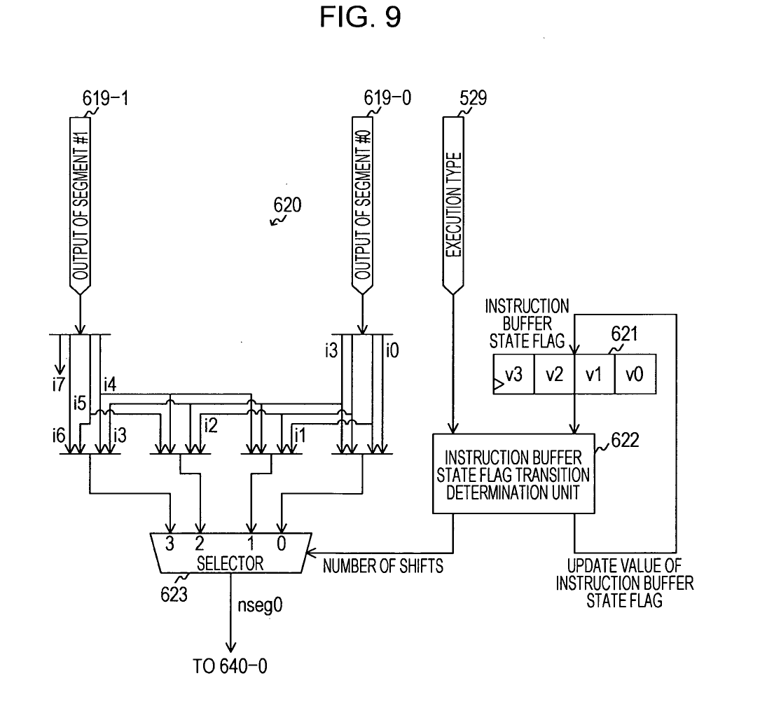

FIG. 9 illustrates an example configuration of the segment update selector 620 according to the first embodiment of the present invention. The segment update selector 620 is a selector for selecting four microinstructions nseg0, which are candidates to be subsequently stored in the instruction buffer 610-0, from among eight microinstructions seg0 and seg1 stored in the instruction buffers 610-0 and 610-1. The segment update selector 620 includes an instruction buffer state flag 621, an instruction buffer state flag transition determination unit 622, and a selector 623.

The instruction buffer state flag 621 is a flag for indicating whether each of the four microinstructions stored in the instruction buffer 610-0 is an instruction that is stored in only the instruction buffer 610-0. In general, the instruction buffer 610-0 stores microinstructions of the segment #0, and the instruction buffer 610-1 stores microinstructions of the segment #1. However, as described below, in order to simplify the shift operation, an exceptional state may occur. Accordingly, for four microinstructions stored in the instruction buffer 610-0, the instruction buffer state flag 621 is provided in order to determine whether the microinstructions are also stored in the instruction buffers 610-1 to 610-3.

The instruction buffer state flag transition determination unit 622 determines an update value of the instruction buffer state flag 621 in accordance with the value of the instruction buffer state flag 621 and the execution type decoded by the microprogram instruction decoder 500. In addition, the instruction buffer state flag transition determination unit 622 determines the amount of shift for the selector 623. In this example, the execution type indicates that a branch is taken in the BR instruction, which is a conditional branch instruction. The transition caused by the instruction buffer state flag transition determination unit 622 is described in more detail below.

The selector 623 is a selector for selecting a shift operation in which eight microinstructions stored in the instruction buffers 610-0 and 610-1 are shifted in accordance with the amount of shift determined by the instruction buffer state flag transition determination unit 622. The output of the selector 623 is input to the input “0” of the selector 640-0.

### State Transition of Microinstruction Buffer

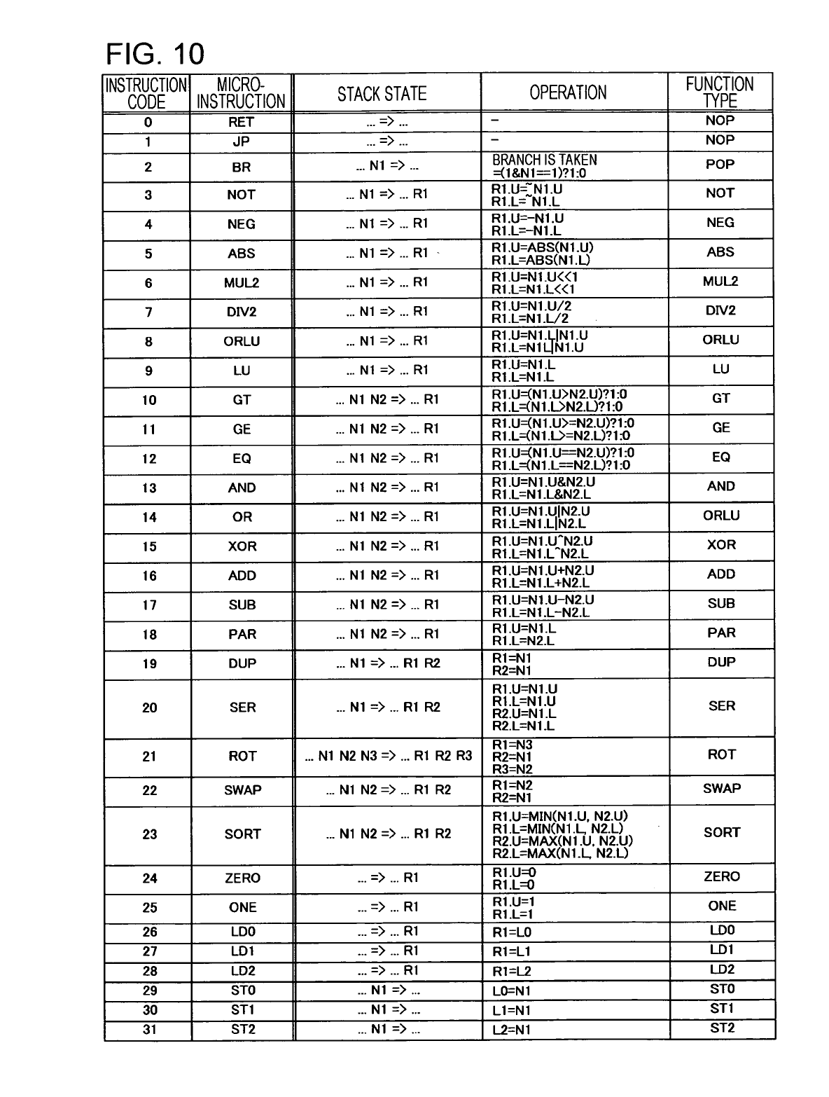

FIG. 10 illustrates an example of a microinstruction set of the information processing system according to the first embodiment of the present invention. In this example, 32 types of microinstruction are provided. In “Stack State” of FIG. 10, the stack state before a microinstruction is executed is shown on the left of “=>”, and the stack state after a microinstruction has been executed is shown on the right of “=>”. In each of the stack states, the top of the stack is on the right. The entries “Operation” indicate how the processing is performed in the microinstruction. The entries “Function Type” indicate the type of function to be executed by using the instruction.

A RET instruction (the instruction code=0) is a return instruction for completing the currently executed microprogram. The RET instruction is one of unconditional branch instructions. Even after the RET instruction is executed, the stack state remains unchanged. A JP instruction (the instruction code=1) is an unconditional branch instruction for jumping to a microinstruction located at the top of the segment next to the currently executed segment. After the JP instruction is executed, the stack state remains unchanged. Note that the function type of the RET instruction and JP instruction is “NOP”, which indicates an instruction that does not substantially manipulate data.

A BR instruction (the instruction code=2) is a conditional branch instruction for branching to a microinstruction located at the top of the segment two segments ahead of the current segment if a branch is taken. The function type of the BR instruction is “POP”, which indicates that data manipulation is popping data from a stack register. That is, in order to determine whether a branch is to be taken or not, one data item (N1) is popped from the stack register. If the LSB of the popped data item (N1) is “1”, a branch is taken. However, if the LSB of the popped data item (N1) is “0”, a branch is not taken.

A NOT instruction (the instruction code=3) is a logical inversion instruction that inverts each of the logical values of the upper 16-bit data and lower 16-bit data of the 32-bit data. A 32-bit data item (N1) is popped up from the stack register. Thereafter, 32-bit execution result data (R1) is pushed onto the stack register. Note that the function types of the instructions subsequent to the NOT instruction are the same as the names of the instructions. The function types indicate how the data is processed.

A NEG instruction (the instruction code=4) is a sign inversion instruction that inverts the sign of each of the upper 16-bit data and lower 16-bit data of the 32-bit data. A 32-bit data item (N1) is popped up from the stack register. Thereafter, 32-bit execution result data (R1) is pushed onto the stack register.

An ABS instruction (the instruction code=5) is an instruction for generating an absolute value of each of the upper 16-bit data and lower 16-bit data of the 32-bit data. A 32-bit data item (N1) is popped up from the stack register. Thereafter, 32-bit execution result data (R1) is pushed onto the stack register.

A MUL2 instruction (the instruction code=6) is a double value generating instruction that performs a 1-bit arithmetic left shift on each of the upper 16-bit data and lower 16-bit data of the 32-bit data. A 32-bit data item (N1) is popped up from the stack register. Thereafter, 32-bit execution result data (R1) is pushed onto the stack register.

A DIV2 instruction (the instruction code=7) is a half value generating instruction that performs a 1-bit arithmetic right shift on each of the upper 16-bit data and lower 16-bit data of the 32-bit data. A 32-bit data item (N1) is popped up from the stack register. Thereafter, 32-bit execution result data (R1) is pushed onto the stack register.

An ORLU instruction (the instruction code=8) is a logical sum distribution instruction that generates the logical sum of the upper 16-bit data and the lower 16-bit data of 32-bit data, distributes the resultant values as upper 16-bit data and lower 16-bit data of the 32-bit data, and outputs the 32-bit data. That is, the resultant values of a plurality of arithmetic units are logically summed, and the resultant value is considered as the resultant value of all of the arithmetic units. A 32-bit data item (N1) is popped up from the stack register. Thereafter, 32-bit execution result data (R1) is pushed onto the stack register.

An LU instruction (the instruction code=9) is a distribution instruction that distributes the lower 16-bit data of 32-bit data as the upper 16-bit data and the lower 16-bit data of the 32-bit data and outputs the 32-bit data. A 32-bit data item (N1) is popped up from the stack register. Thereafter, 32-bit execution result data (R1) is pushed onto the stack register.

A GT instruction (the instruction code=10) is an arithmetic comparison instruction that compares the lower 16-bit data of a 32-bit data item (N1) and the lower 16-bit data of a 32-bit data item (N2) and compares the upper 16-bit data of the 32-bit data item (N1) and the upper 16-bit data of the 32-bit data item (N2). If N1>N2, “1” is output. Otherwise, “0” is output. Two 32-bit data items are popped up from the stack register (firstly, N2 and secondly N1). Thereafter, 32-bit execution result data (R1) is pushed onto the stack register.

A GE instruction (the instruction code=11) is an arithmetic comparison instruction that compares the lower 16-bit data of a 32-bit data item (N1) and the lower 16-bit data of a 32-bit data item (N2) and compares the upper 16-bit data of the 32-bit data item (N1) and the upper 16-bit data of the 32-bit data item (N2). If N1≧N2, “1” is output. Otherwise, “0” is output. Two 32-bit data items are popped up from the stack register (firstly, N2 and secondly N1). Thereafter, 32-bit execution result data (R1) is pushed onto the stack register.

An EQ instruction (the instruction code=12) is an arithmetic comparison instruction that compares the lower 16-bit data of a 32-bit data item (N1) and the lower 16-bit data of a 32-bit data item (N2) and compares the upper 16-bit data of the 32-bit data item (N1) and the upper 16-bit data of the 32-bit data item (N2). If N1=N2, “1” is output. Otherwise, “0” is output. Two 32-bit data items are popped up from the stack register (firstly, N2 and secondly N1). Thereafter, 32-bit execution result data (R1) is pushed onto the stack register.

An AND instruction (the instruction code=13) is a logical AND generating instruction that generates the logical AND of the lower 16-bit data of a 32-bit data item (N1) and the lower 16-bit data of a 32-bit data item (N2) and generates the logical AND of the upper 16-bit data of the 32-bit data item (N1) and the upper 16-bit data of the 32-bit data item (N2). Two 32-bit data items are popped up from the stack register (firstly, N2 and secondly N1). Thereafter, 32-bit execution result data (R1) is pushed onto the stack register.

An OR instruction (the instruction code=14) is a logical OR generating instruction that generates the logical OR of the lower 16-bit data of a 32-bit data item (N1) and the lower 16-bit data of a 32-bit data item (N2) and generates the logical OR of the upper 16-bit data of the 32-bit data item (N1) and the upper 16-bit data of the 32-bit data item (N2). Two 32-bit data items are popped up from the stack register (firstly, N2 and secondly N1). Thereafter, 32-bit execution result data (R1) is pushed onto the stack register.

An XOR instruction (the instruction code=15) is an exclusive logical OR generating instruction that generates the exclusive logical OR of the lower 16-bit data of a 32-bit data item (N1) and the lower 16-bit data of a 32-bit data item (N2) and generates the exclusive logical OR of the upper 16-bit data of the 32-bit data item (N1) and the upper 16-bit data of the 32-bit data item (N2). Two 32-bit data items are popped up from the stack register (firstly, N2 and secondly N1). Thereafter, 32-bit execution result data (R1) is pushed onto the stack register.

An ADD instruction (the instruction code=16) is an arithmetic add instruction that performs arithmetic add of the lower 16-bit data of a 32-bit data item (N1) and the lower 16-bit data of a 32-bit data item (N2) and performs arithmetic add of the upper 16-bit data of the 32-bit data item (N1) and the upper 16-bit data of the 32-bit data item (N2). Two 32-bit data items are popped up from the stack register (firstly, N2 and secondly N1). Thereafter, 32-bit execution result data (R1) is pushed onto the stack register.

A SUB instruction (the instruction code=17) is an arithmetic subtract instruction that performs arithmetic subtraction between the lower 16-bit data of a 32-bit data item (N1) and the lower 16-bit data of a 32-bit data item (N2) and performs arithmetic subtraction between the upper 16-bit data of the 32-bit data item (N1) and the upper 16-bit data of the 32-bit data item (N2) (N1−N2). Two 32-bit data items are popped up from the stack register (firstly, N2 and secondly N1). Thereafter, 32-bit execution result data (R1) is pushed onto the stack register.

A PAR instruction (the instruction code=18) is a packaging instruction that combines the lower 16-bit data of a 32-bit data item (N1) with the lower 16-bit data of a 32-bit data item (N2) and outputs a 32-bit data item. Two 32-bit data items N1 and N2 are popped up from the stack register (firstly, N2 and secondly N1). Thereafter, 32-bit execution result data (R1) is pushed onto the stack register. In general, a plurality of data items are sequentially popped up from the top of the stack. The data at a predetermined bit position of the data items or data items of predetermined stacks are concatenated into one data item, which is pushed onto the stack top.

A DUP instruction (the instruction code=19) is a copy instruction that pops up a 32-bit data item (N1) from a stack register and pushes the data items onto the stack register twice so that two 32-bit data items (R1 and R2) are stacked.

A SER instruction (the instruction code=20) is a packaging instruction that retrieves the upper 16 bits of a 32-bit data item (N1), uses the 16 bits as the upper 16 bits of a 32-bit data item (R1), retrieves the lower 16 bits of the data item (N1) and uses the 16 bits as the upper 16 bits or the lower 16 bits of another 32-bit data item (R2). The 32-bit data item (N1) serving as a source is popped from a stack register. Thereafter, two 32-bit execution result data items (R1 and R2) are pushed onto the stack register (firstly, R1 and secondly R2). In general, a data item at the top of the stack is separated into a plurality of data items, and each of the separated data items is processed in a predetermined manner. Thereafter, the data items are sequentially pushed onto the stack top.

A ROT instruction (the instruction code=21) is a rotation instruction that pops up three 32-bit data items from a stack register and performs a push operation three times so that the data item at the top is moved to the third position.

A SWAP instruction (the instruction code=22) is a swap instruction that pops up two 32-bit data items from a stack register and performs a push operation twice so that the data items are exchanged in the stack register.

A SORT instruction (the instruction code=23) is a sort instruction that compares the upper 16-bit data of a 32-bit data item (N1) and the upper 16-bit data of a 32-bit data item (N2) and compares the lower 16-bit data of the 32-bit data item (N1) and the lower 16-bit data of the 32-bit data item (N2). Thereafter, the smaller one serves as execution result data R1, and the larger one serves as execution result data R2. Two 32-bit data items are popped up from a stack register (firstly, N2 and secondly N1). Thereafter, the two execution result data items R1 and R2 are pushed onto the stack register (firstly, R1 and secondly R2). That is, data items at the top and second to the top of the stack register are popped up. One of the two data items is selected using a greater-lesser relationship between the two. Thereafter, the data item that is not selected is pushed and, subsequently, the data item that is selected is pushed.

A ZERO instruction (the instruction code=24) is a zero push instruction that additionally pushes a 32-bit data item having upper 16 bits of “0” and lower 16 bits of “0” into a stack register. ONE instruction (the instruction code=25) is a one push instruction that additionally pushes a 32-bit data item having upper 16 bits of “1” and lower 16 bits of “1” into a stack register.

An LD0 instruction (the instruction code=26) is a load 0 instruction that additionally pushes a value stored in the local register #0 (425) into a stack register. An LD1 instruction (the instruction code=27) is a load 1 instruction that additionally pushes a value stored in the local register #1 (426) into a stack register. An LD2 instruction (the instruction code=28) is a load 2 instruction that additionally pushes a value stored in the local register #2 (427) into a stack register.

An ST0 instruction (the instruction code=29) is a store 0 instruction that stores, in the local variable register #0 (425), data that is popped from a stack register. ST1 instruction (the instruction code=30) is a store 1 instruction that stores, in the local variable register #1 (426), data that is popped from a stack register. An ST2 instruction (the instruction code=31) is a store 0 instruction that stores, in the local variable register #2 (427), data that is popped from a stack register.

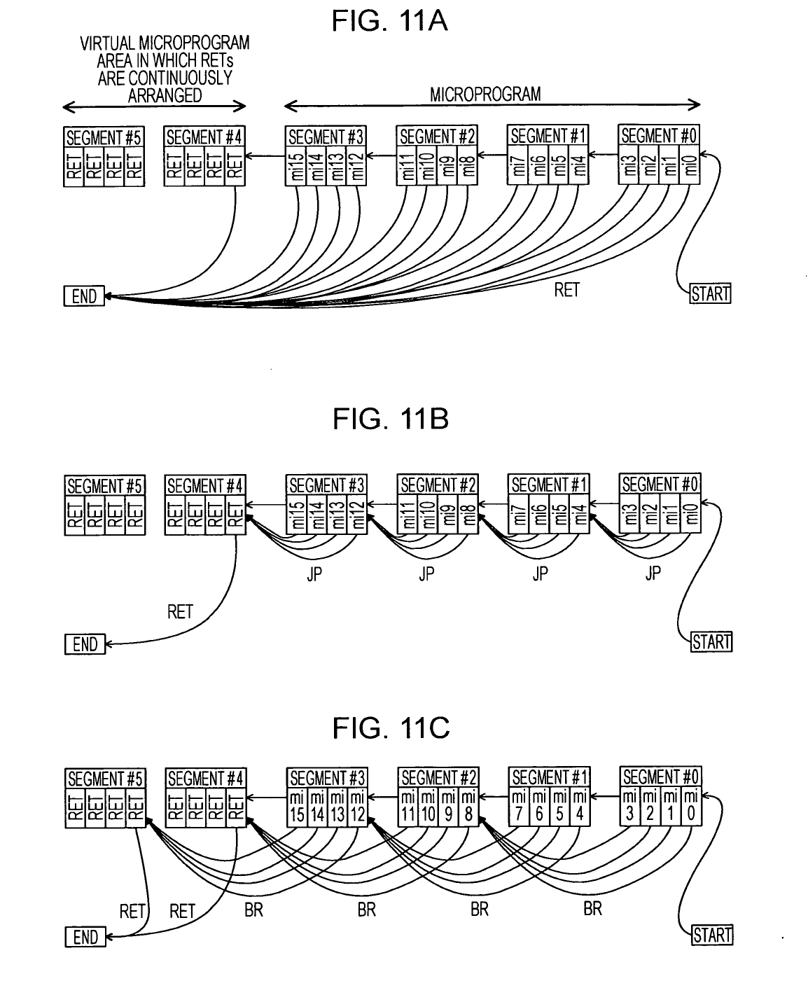

FIGS. 11A to 11C illustrate examples of a branch destination of a branch instruction in the information processing system according to the first embodiment of the present invention. As described above, the microprogram includes four segments and 16 microinstructions. In order to unify the operations of branch instructions, two virtual segments are provided. That is, a segment #4 and a segment #5 each including four RET instructions are provided. However, it is not necessary that the segments #4 and #5 be stored in the microprogram memory 230. As illustrated in FIG. 7, the segments #4 and #5 are easily realized by devising some type of inputs to the selector 640-2 and 640-3.

FIG. 11A illustrates a branch destination when a RET instruction is present in a microprogram. Normal instructions are executed from the instruction having the smallest number to the instruction having the largest number. If a RET instruction is executed, the microprogram is completed. Even when the 16th microinstruction is a normal instruction, the microprogram can be completed if the top of the virtual segment #4 is a RET instruction.

FIG. 11B illustrates a branch destination when a JP instruction is present in a microprogram. Normal instructions are executed from the instruction having the smallest number to the instruction having the largest number. If a JP instruction is executed, control passes to the microinstruction at the top of the next segment. Even when a JP instruction is executed in the segment #3, the microprogram can be completed if the top of the virtual segment #4 is a RET instruction.

FIG. 11C illustrates the branch destinations when the conditional branch of a BR instruction in a microprogram is taken. Normal instructions are executed in sequence from an instruction having the smallest number to that having the largest number. However, if the conditional branch of a BR instruction is taken, control passes to an instruction at the top of a segment two segments ahead of the segment. Even when the branch of a BR instruction in the segment #2 or #3 is taken, the microprogram can be completed by setting a RET instruction at the top of the virtual segment #3 or #4.

That is, by not implicitly specifying the microaddress of the branch destination using a BR instruction, a change in the specification of the branch instruction is not necessary even when the number of instructions in the microprogram is increased and, therefore, the number of bits of the branch destination address is changed. Accordingly, a change in the simple rule indicating whether control passes to the top of the segment one ahead of the current segment or the top of the segment two ahead of the current segment is not necessary. In this way, the first embodiment of the present invention can provide the scalability for extension of the number of instructions in a microprogram.

In addition, according to the first embodiment of the present invention, since the branch destination in a segment has only three types, pre-fetch can be efficiently performed. That is, it can be designed so that the following three instructions are referenced: the next instruction, the instruction at the top of the segment one ahead of the current segment, and the instruction at the top of the next segment two ahead of the current segment. Thus, the circuit configuration can be simplified.

Furthermore, according to the first embodiment of the present invention, by limiting the branch destination of a BR instruction to a forward branch destination, deadlock can be prevented. The microprogram registers 232 to 235 can store user-defined microprogram. If a backward branch is allowed as for a normal processor instruction, deadlock caused by an infinite loop may occur. Therefore, according to the first embodiment of the present invention, to prevent such deadlock, only a forward branch destination is allowed at all times.

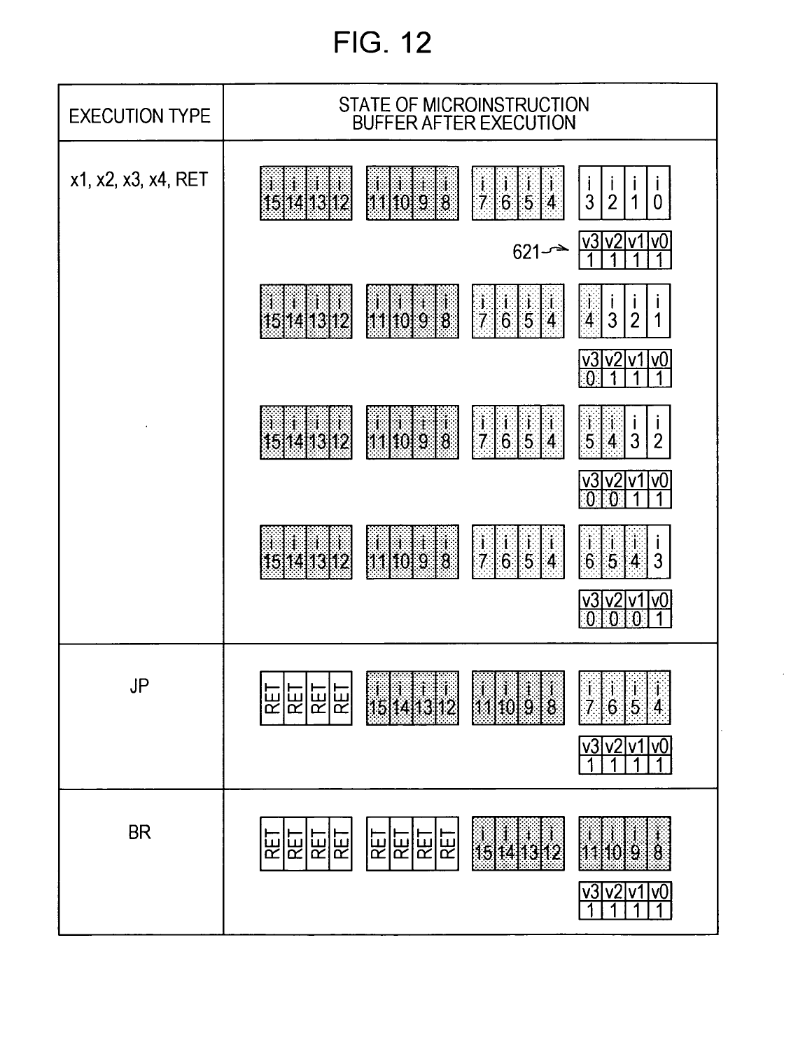

FIG. 12 illustrates the state of the microinstruction buffer 241 according to the first embodiment of the present invention. The state of the microinstruction buffer 241 after a microinstruction is executed varies in accordance with the execution type. Execution types of x1, x2, x3, and x4 indicate execution of a single instruction, execution of two instructions at the same time, execution of three instructions at the same time, and execution of four instructions at the same time, respectively. In addition, the execution types indicate that a branch does not occur. Execution types of RET, JP, and BR indicate execution of a RET instruction, a JP instruction, and a BR instruction when a branch is taken, respectively.

When the execution type is x1, x2, x3, x4, or RET, the states of the segments other than the first segment remain unchanged. Only the first segment is subjected to a shift operation during execution. During the shift operation, a microinstruction is shifted from the next segment into the first segment. Even in such a case, the segments other than the first segment remain unchanged. Each of the instruction buffer state flags 621 illustrated in FIG. 9 indicates whether a corresponding one of four microinstructions stored in the instruction buffer 610-0 is an instruction that is stored in only the instruction buffer 610-0.

In this way, shift in the entire microinstruction buffer 241 is not performed each time an instruction is executed. Thus, the first segment can be differentiated from the other segments using the instruction buffer state flags 621 until a shift operation is performed on a segment-by-segment basis.

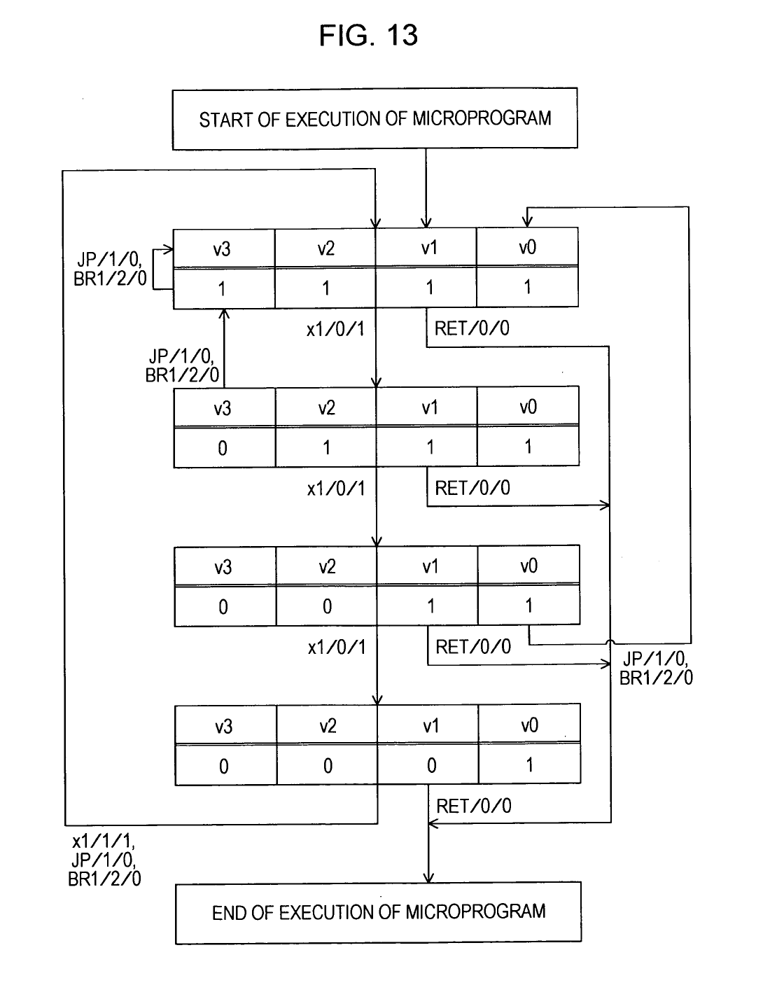

FIGS. 13 to 16 illustrate examples of a state transition of the instruction buffer state flags 621 according to the first embodiment of the present invention. In FIGS. 13 to 16, the format A indicates an execution type, the format B indicates the number of shift operations on a segment-by-segment basis, and the format C indicates the number of shift operations on a microinstruction-by-microinstruction basis in the segment update selector 620. In the format A, the execution type “BR1” indicates that a branch is to be taken in a BR instruction. In the format B, “0” indicates that a shift on a segment-by-segment basis is not performed, and “1” indicates that a shift on a segment-by-segment basis is performed by one segment. “2” indicates that a shift on a segment-by-segment basis is performed by two segments. In the format C, “0” indicates that a shift on a microinstruction-by-microinstruction basis is not performed, and “1” indicates that a shift on a microinstruction-by-microinstruction is performed by one microinstruction. “2” indicates that shift on a microinstruction-by-microinstruction basis is performed by two microinstructions.

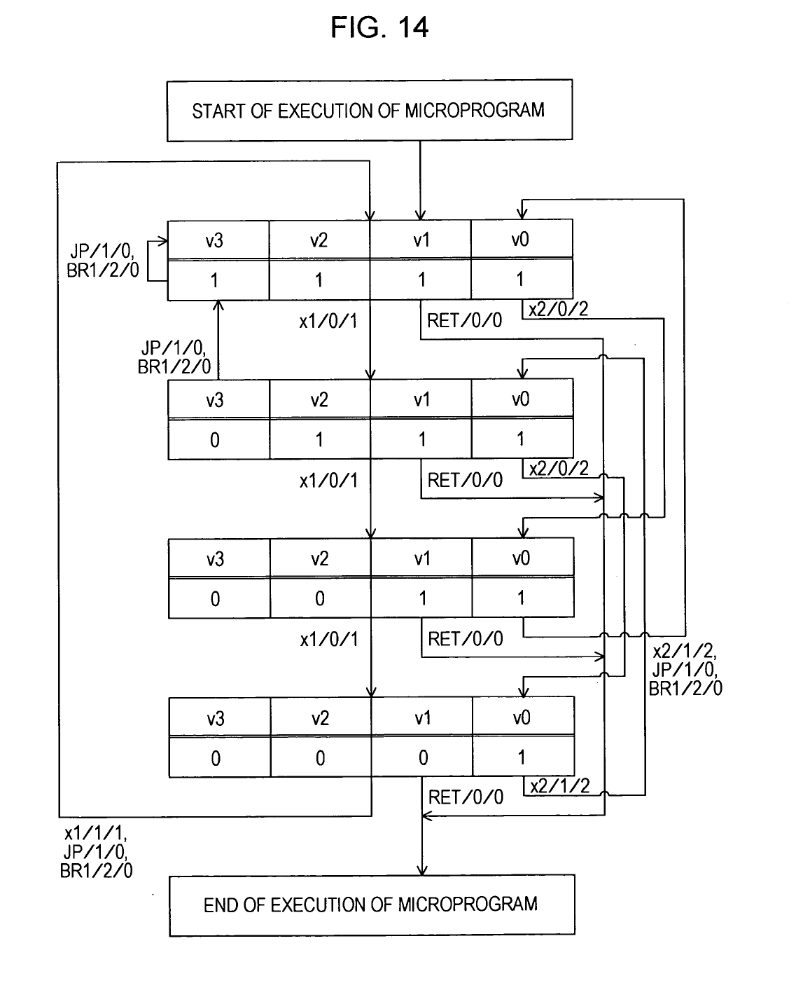

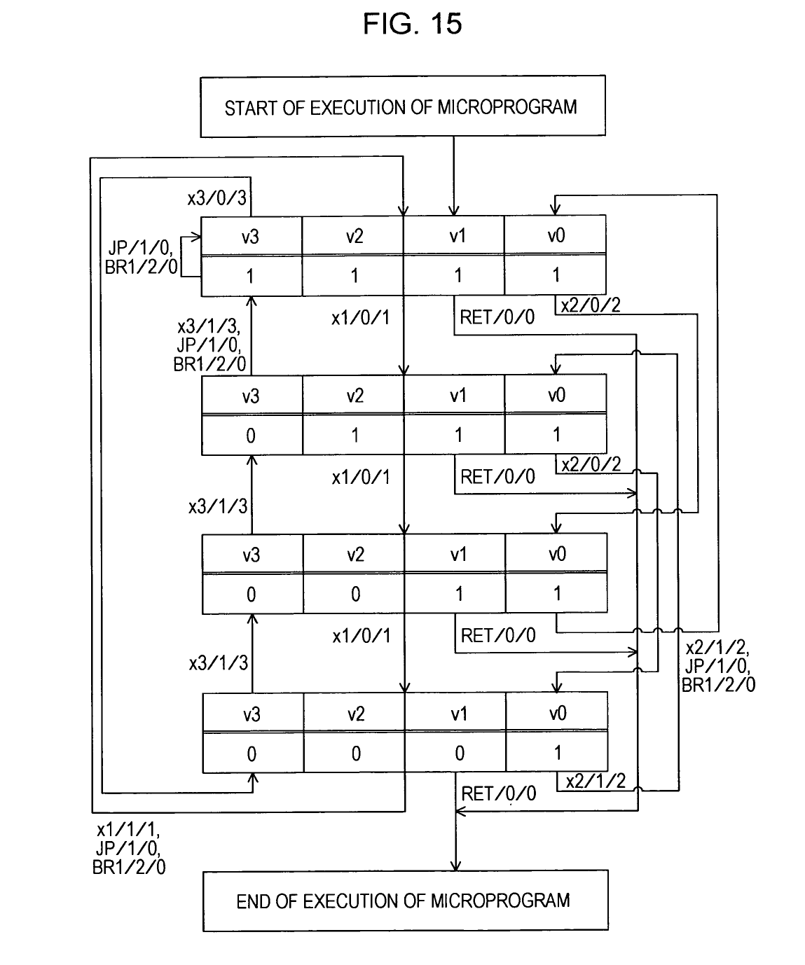

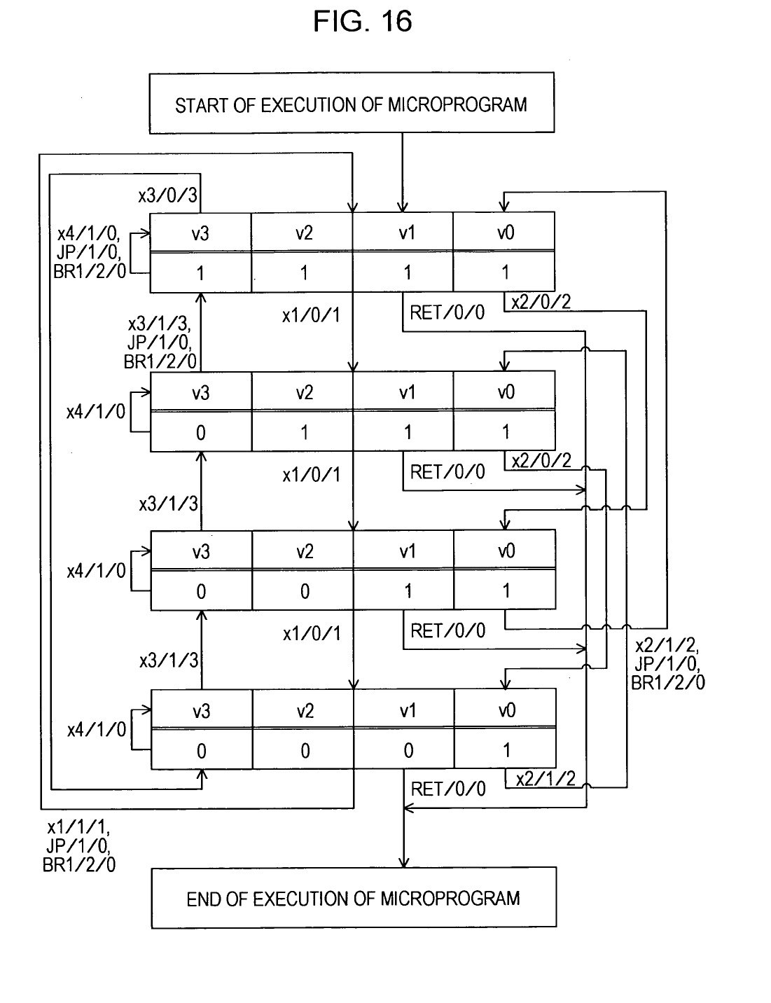

In FIG. 13, one instruction is executed per cycle. In FIG. 14, a maximum of two instructions are executed per cycle. In FIG. 15, a maximum of three instructions are executed per cycle. In FIG. 16, a maximum of four instructions are executed per cycle. There is a tradeoff between the maximum number of microinstructions concurrently executable and each of the circuit dimensions and the maximum operating frequency. Thus, the maximum number of microinstructions concurrently executable is determined in accordance with the use environment. As illustrated in FIG. 13, as the number of branches is decreased, the circuit becomes simpler, the circuit dimensions become smaller, and the maximum operating frequency becomes higher. Decoding of a microinstruction performed when a single instruction is executed per cycle and when a maximum of three instructions are executed per cycle is described below.

### Decoding of Microinstruction

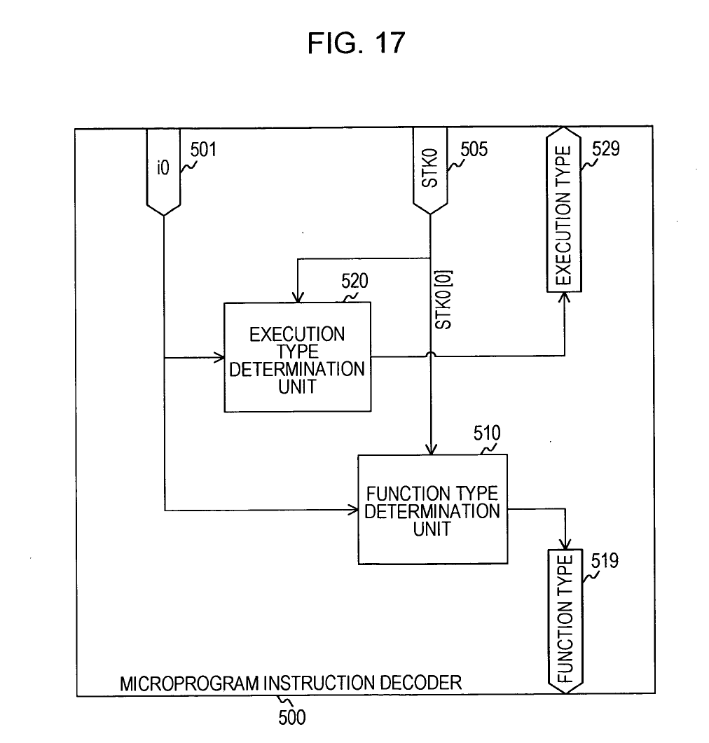

FIG. 17 illustrates a first example of the configuration of the microprogram instruction decoder 500 according to the first embodiment of the present invention. In the first example of the configuration, a single instruction is executed per cycle. The first example of the configuration of the microprogram instruction decoder 500 includes a function type determination unit 510 and an execution type determination unit 520.

The function type determination unit 510 is used for determining a function type regarding the function of execution of an instruction. In the first example of the configuration, the function type determination unit 510 determines a function type 519 using a first instruction i0 (501) at the top of the microinstruction buffer 241 and a data item (505) popped from the stack register.

The execution type determination unit 520 is used for determining an execution type regarding updating of the microinstruction buffer 241 after an instruction is executed and write-back. In the first example of the configuration, the execution type determination unit 520 determines an execution type 529 using the first instruction i0 (501) at the top of the microinstruction buffer 241 and a data item (505) popped from the stack register.

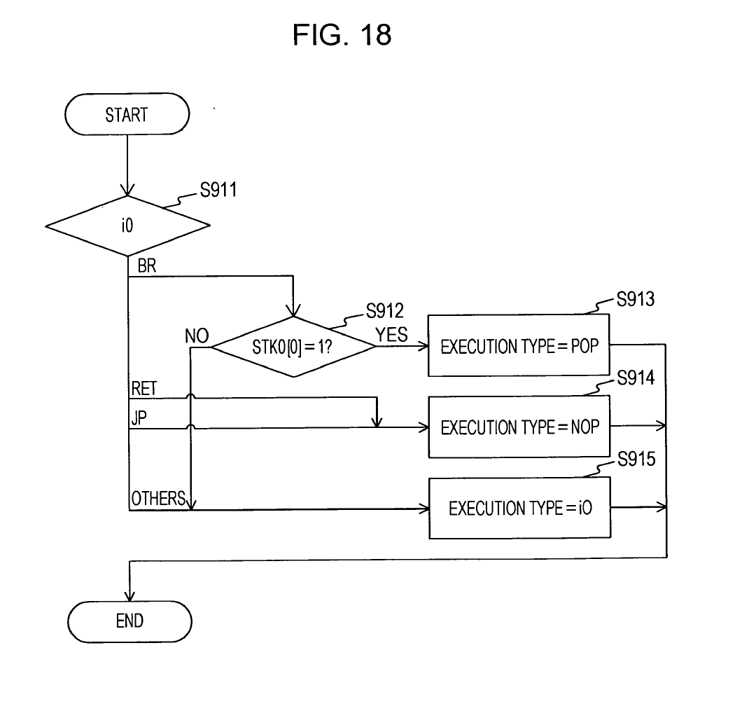

FIG. 18 illustrates the processing procedure performed by a first configuration of the function type determination unit 510 according to the first embodiment of the present invention.

The instruction code of the first instruction i0 (501) at the top of the microinstruction buffer 241 is determined first (step S911). If the instruction i0 is a RET instruction or a JP instruction, the function type is determined to be “NOP” (step S914).

When the instruction i0 is a BR instruction and if the LSB of the data item (505) popped from the stack register is “1” (step S912), the function type is determined to be “POP” (step S913). However, when the instruction i0 is a BR instruction and if the LSB of the data item (505) popped from the stack register is “0” (step S912), the function type is determined to be “i0” (step S915).

If the instruction i0 is an instruction other than the above-described instructions (step S911), the function type is determined to be “i0” (step S915). Note that the function type “i0” is a function type indicating that a data operation of a single instruction is performed per cycle.

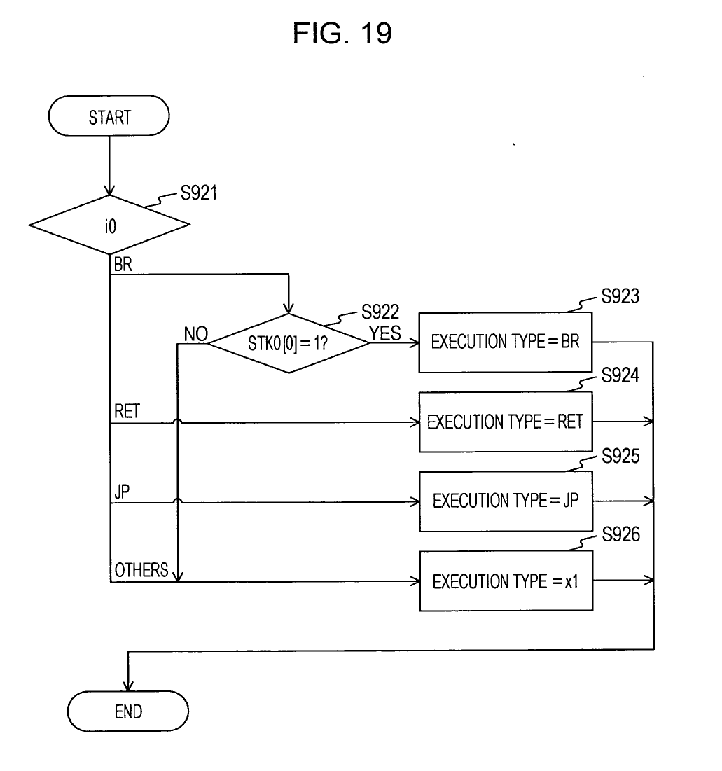

FIG. 19 illustrates the processing procedure performed by a first configuration of the execution type determination unit 520 according to the first embodiment of the present invention.

The instruction code of the first instruction i0 (501) at the top of the microinstruction buffer 241 is determined first (step S921). If the instruction 10 is a RET instruction, the execution type is determined to be “RET” (step S924). However, if the instruction i0 is a JP instruction, the execution type is determined to be “JP” (step S925).

When the instruction i0 is a BR instruction and if the LSB of the data item (505) popped from the stack register is “1” (step S922), the execution type is determined to be “BR” (step S923). However, when the instruction 10 is a BR instruction and if the LSB of the data item (505) popped from the stack register is “0” (step S922), the execution type is determined to be “x1” (step S926).

If the instruction i0 is an instruction other than the above-described instructions (step S921), the execution type is determined to be “x1” (step S926).

As described above, when a single instruction is executed per cycle, the instruction decoder is significantly simplified.

Note that step S923 or S925 is an example of a first step defined in Claims. In addition, step S926 is an example of a second step defined in Claims.

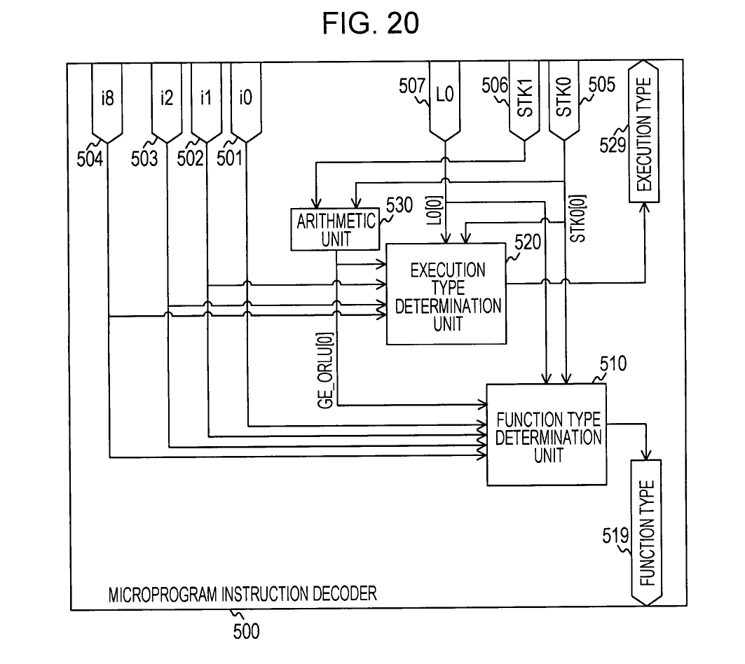

FIG. 20 illustrates a second example of the configuration of the microprogram instruction decoder 500 according to the first embodiment of the present invention.

In the second example of the configuration of the microprogram instruction decoder 500, a maximum of three instructions are executed per cycle. The second example of the configuration of the microprogram instruction decoder 500 includes a function type determination unit 510, an execution type determination unit 520, and an arithmetic unit 530.

In the second configuration, the function type determination unit 510 references three instructions i0 to i2 (501 to 503) located from the top of the microinstruction buffer 241 and an instruction i8 (504) which is the ninth instruction from the top. In addition, the function type determination unit 510 references a data item (505) that is popped up from the stack register first, a data item (507) stored in the local variable register #0, and the output of the arithmetic unit 530. By referencing these data items, the function type determination unit 510 can determine the function type 519.

In addition, in the second example of the configuration, the execution type determination unit 520 references a second instruction i1 (502) which is a second instruction from the top of the microinstruction buffer 241, a third instruction i2 (503), and the ninth instruction i8 (504). Furthermore, the execution type determination unit 520 references the data item (505) that is popped up from the stack register first, the data item (507) stored in the local variable register #0, and the output of the arithmetic unit 530. By referencing these data items, the execution type determination unit 520 can determine the execution type 529.

When the arithmetic unit 530 executes the GE, ORLU, or BR in one cycle, the arithmetic unit 530 computes GE_ORLU[0] which is a bit indicating whether a branch is to be taken or not using the following equation:

GE_{—}ORLU[0]=(STK1[15:0]>=STK0[15:0]?1:0)|

(STK1[31:16]>=STK0[31:16]?1:0)

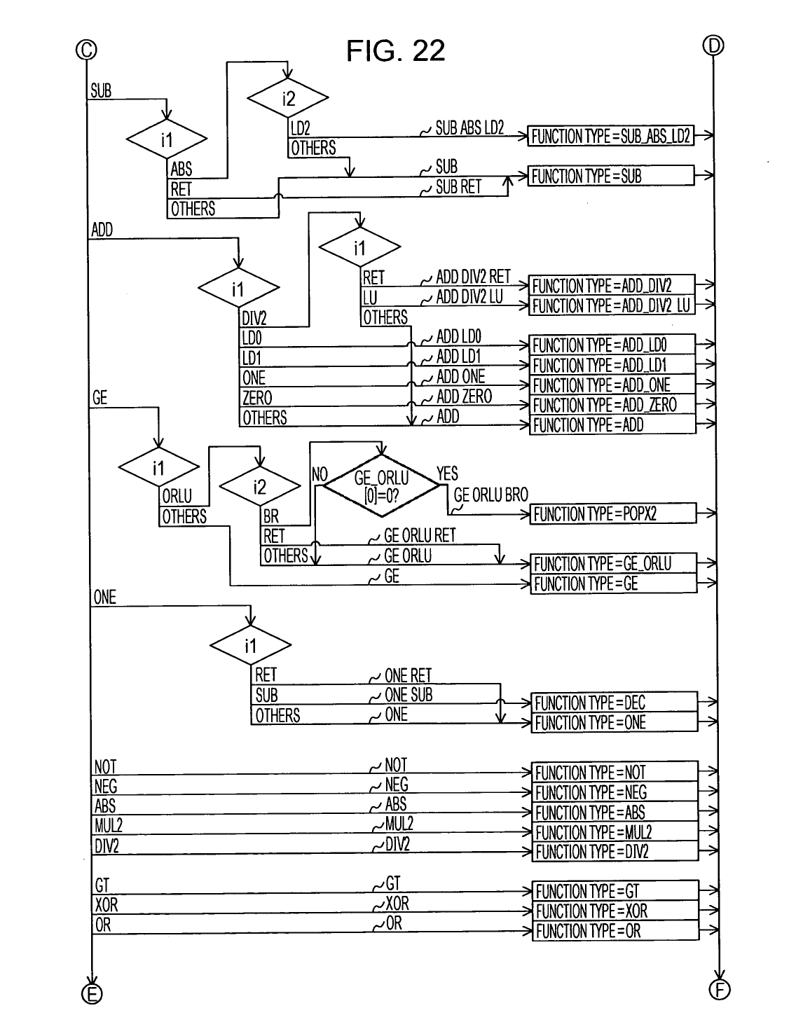

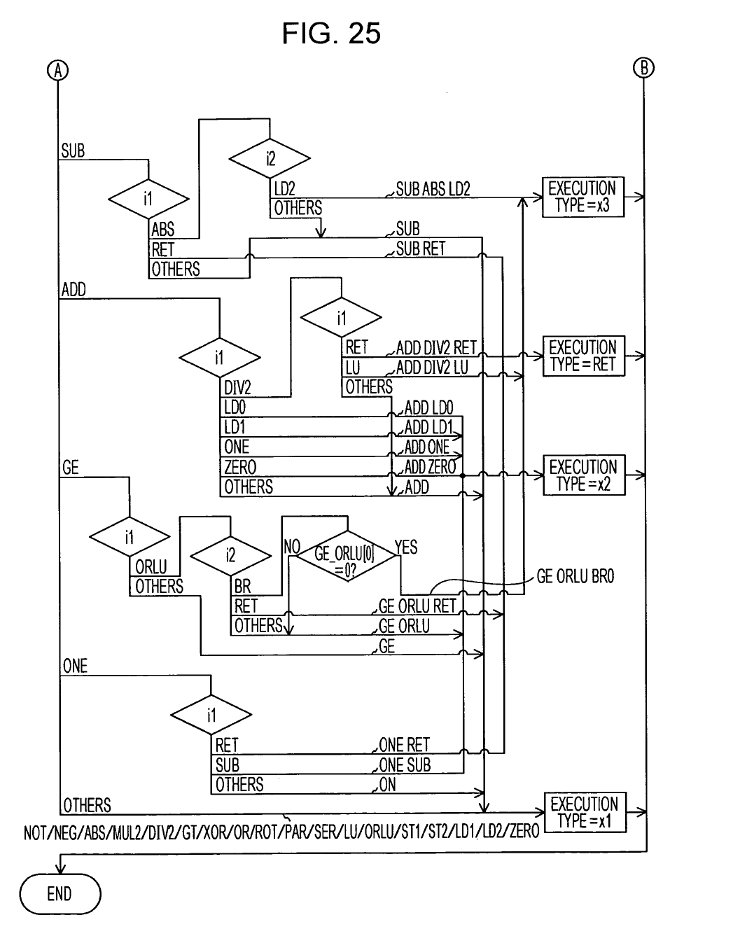

GE_ORLU[0] is used for determining the function type and execution type in the processes illustrated in FIGS. 22 and 25 described below.

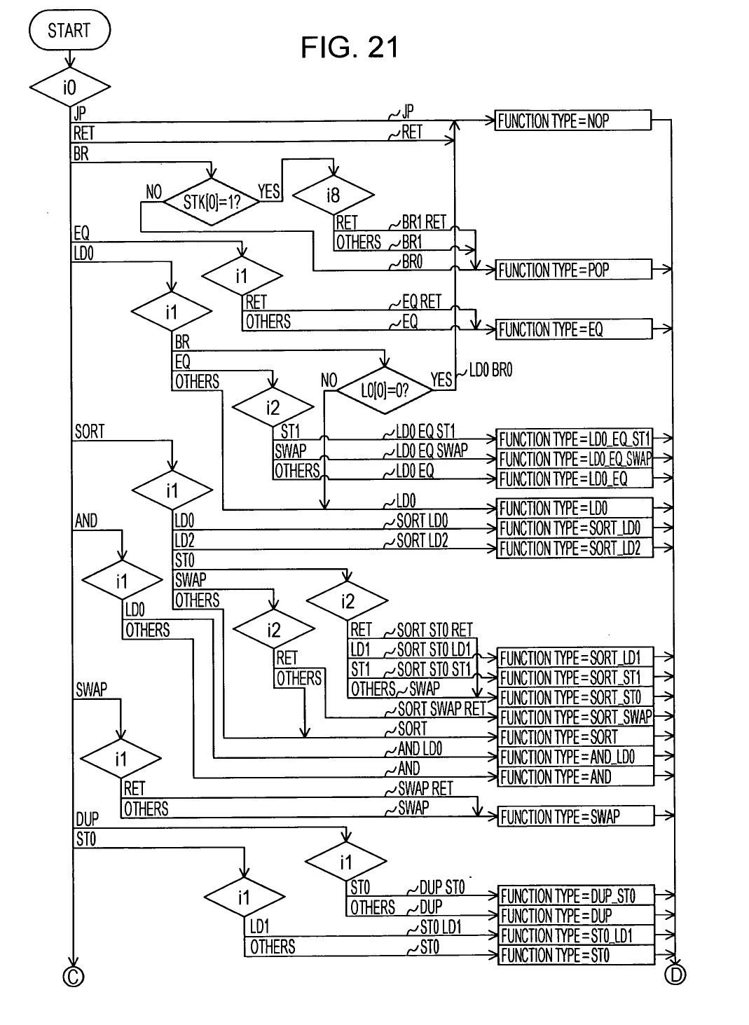

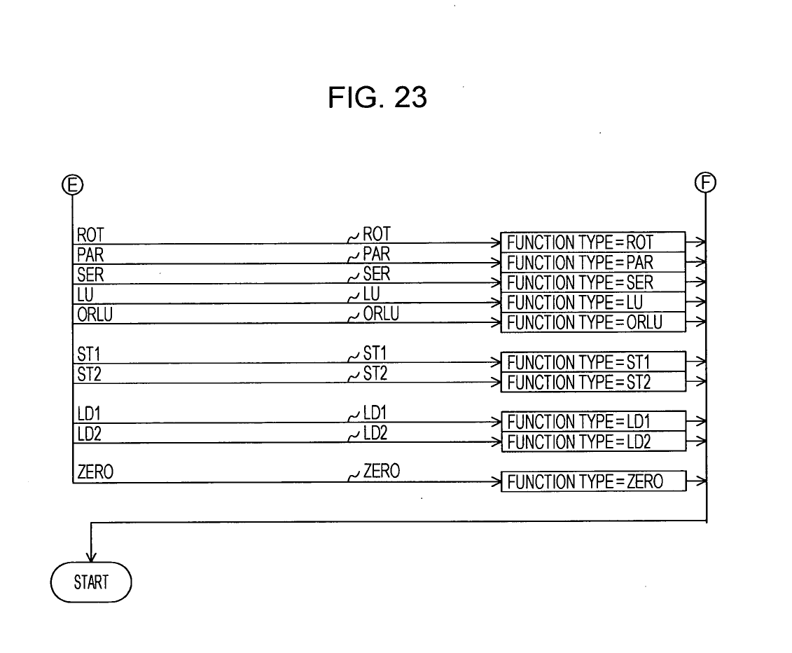

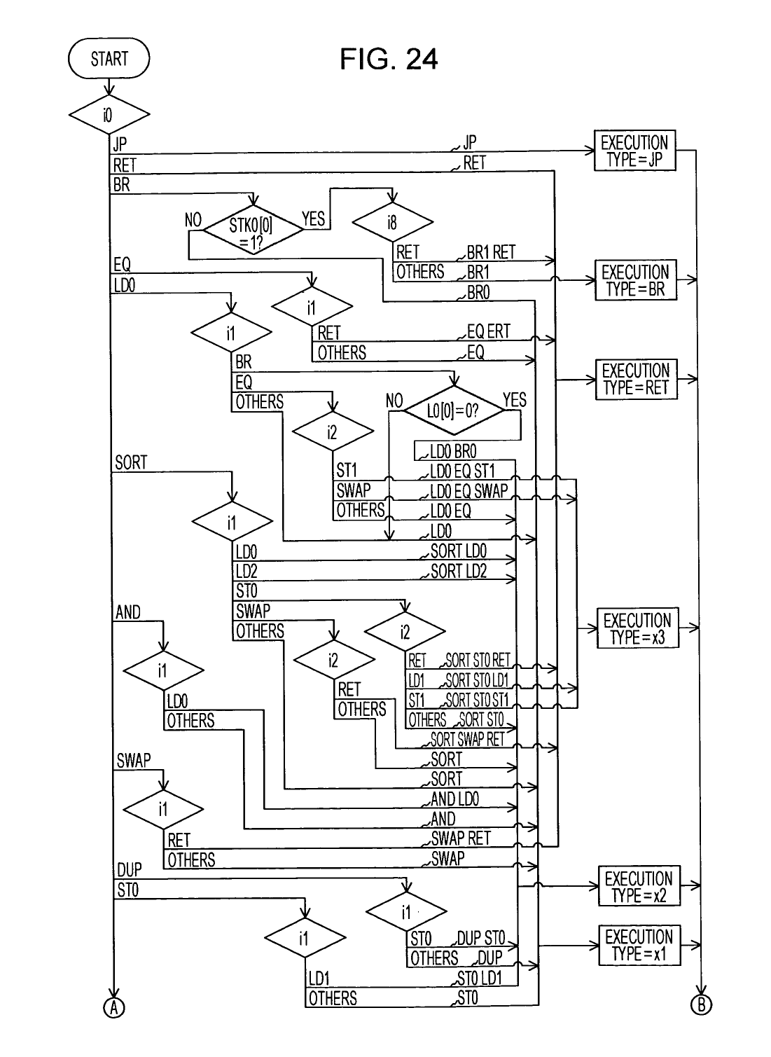

FIGS. 21 to 23 illustrate the processing procedure performed by the second example configuration of the function type determination unit 510 according to the first embodiment of the present invention. FIGS. 24 and 25 illustrate the processing procedure performed by the second configuration of the execution type determination unit 520 according to the first embodiment of the present invention. Although detailed description is not provided in FIGS. 21 to 25, it can be seen that the second examples of the configuration are more complicated than those of the first examples of the configuration.

In the processing procedure, an instruction pattern that performs folding is indicated by an underline. Such a pattern is shown in a decoded path. As used herein, the term “folding” refers to concurrent execution of a plurality of instructions. For example, in the case of ADD_DIV2_RET, the microinstructions: ADD instruction, DIV2 instruction, and RET instruction are arranged in this order, and these instructions are concurrently executed in one cycle. Which instructions are concurrently executed in one cycle is predetermined for each of the combinations of the instructions.

When a RET instruction is executed after a plurality of microinstructions other than a branch instruction have been concurrently executed, the microprogram is completed after the microinstructions other than the RET instruction have been executed. When a BR instruction is executed after a plurality of microinstructions excluding a branch instruction have been concurrently executed and if the branch is taken, the instructions up to the instruction immediately before the BR instruction are executed. The next instruction is the BR instruction. However, if a branch is not taken, the BR instruction is also executed. The next instruction is an instruction immediately after the BR instruction. When a JP instruction is executed after a plurality of microinstructions other than a branch instruction have been concurrently executed, the instructions up to the instruction immediately before the JP instruction are executed. The next instruction is an instruction at the top of a segment next to the segment including the JP segment.

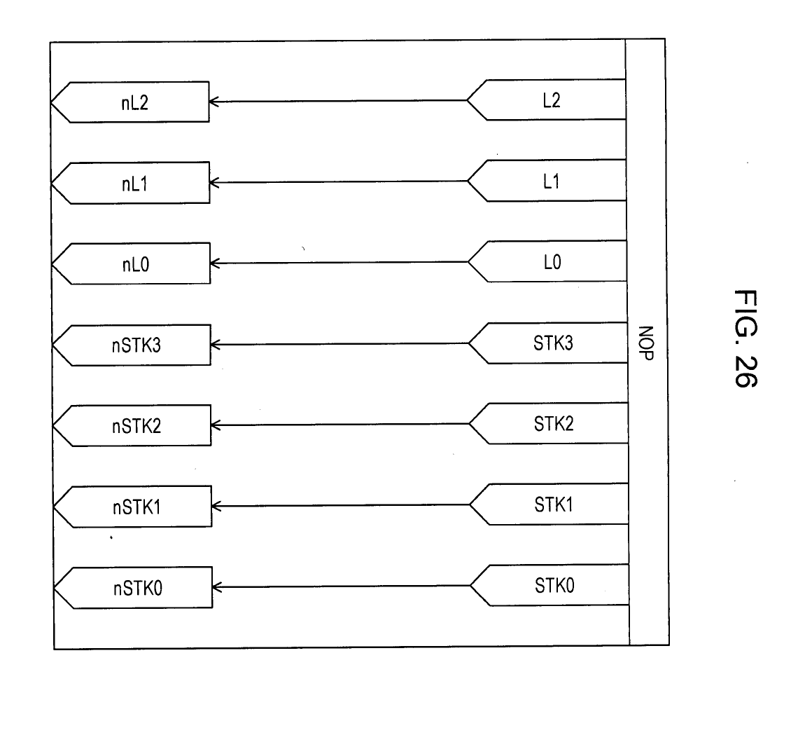

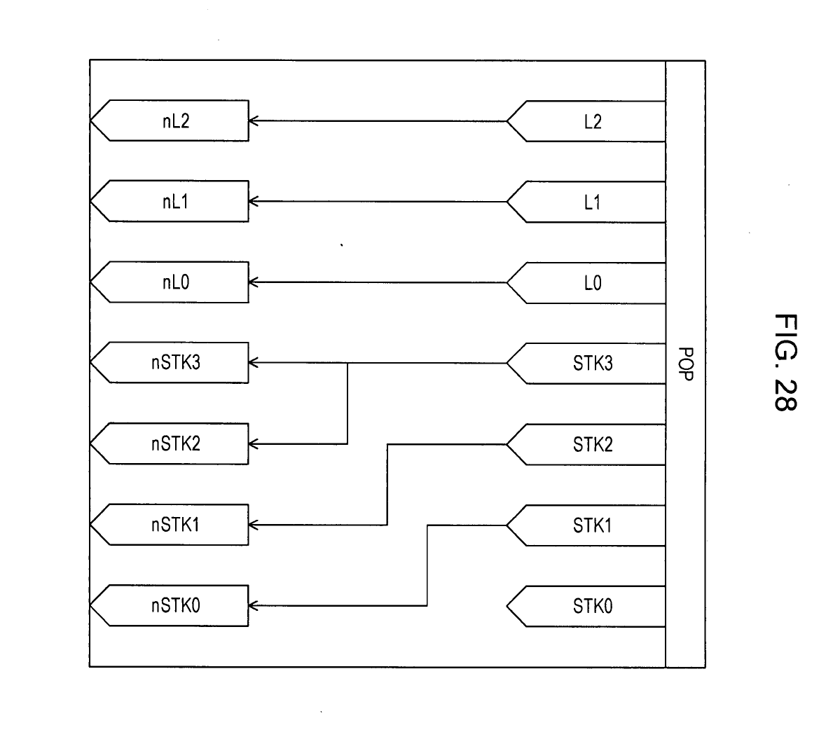

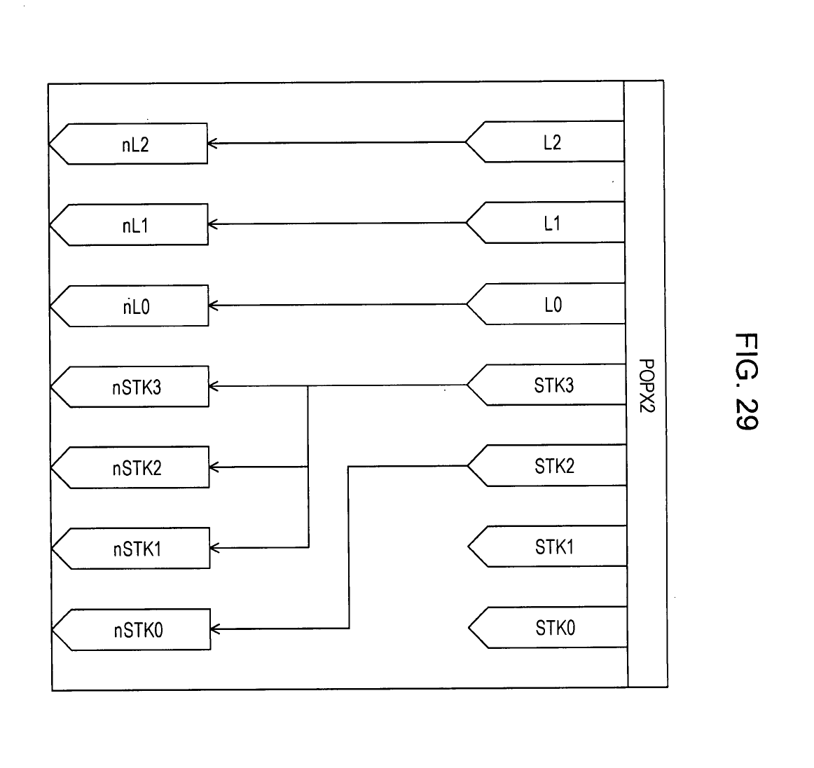

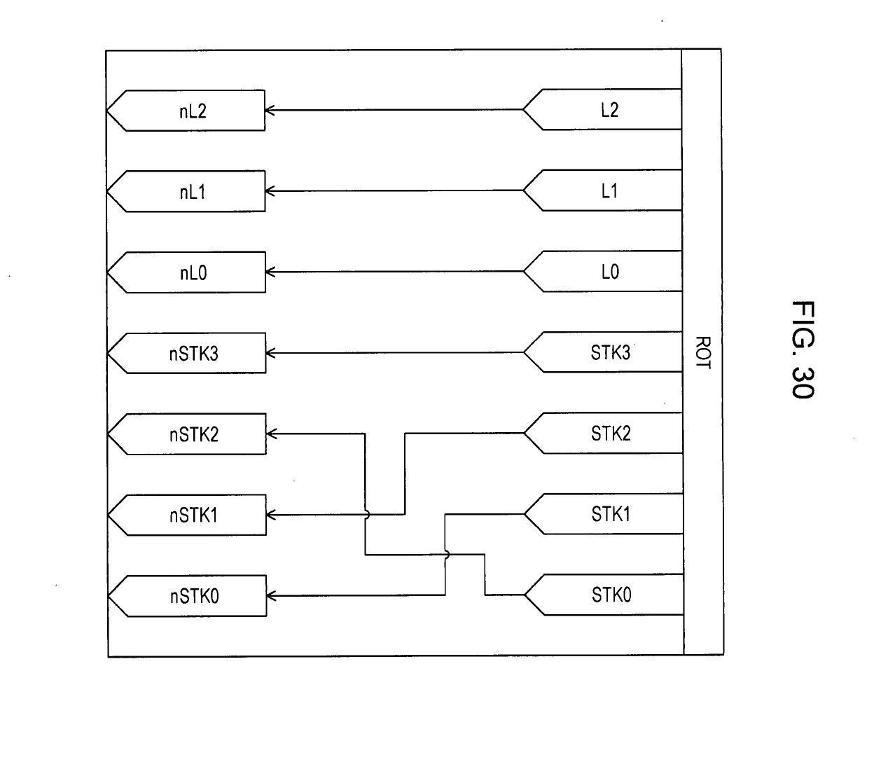

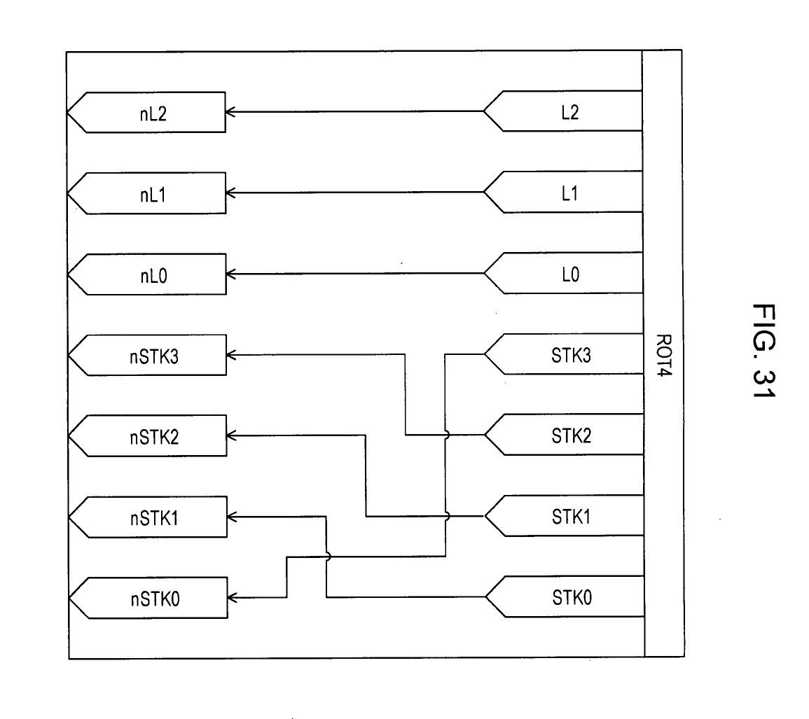

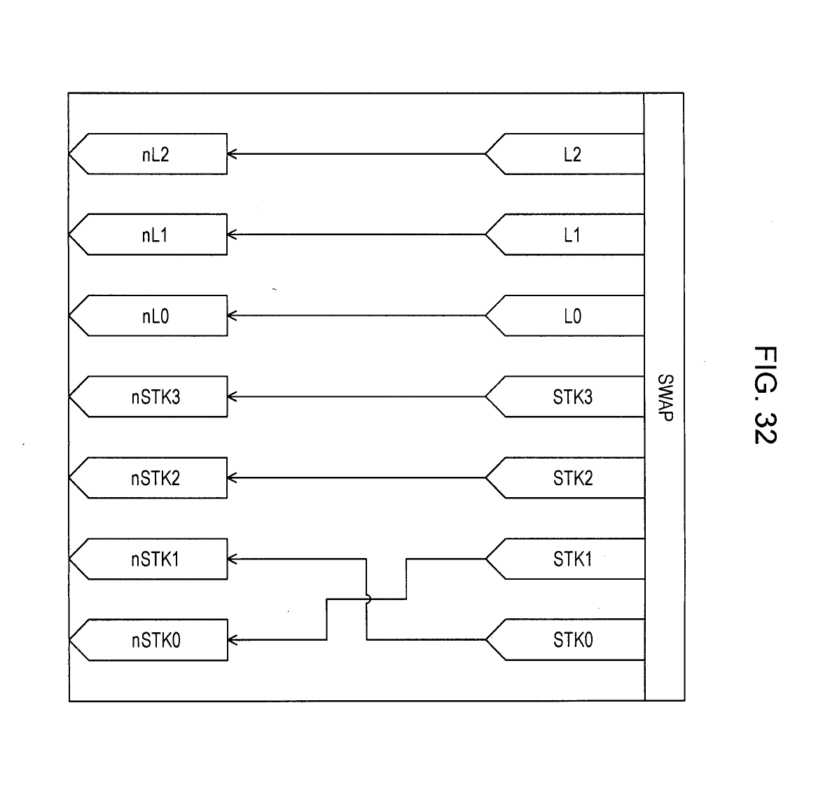

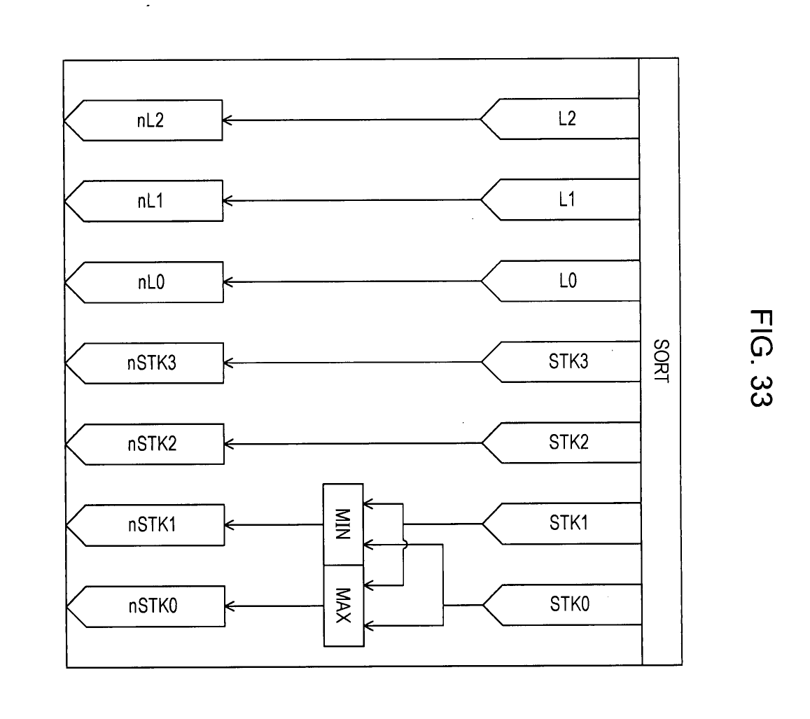

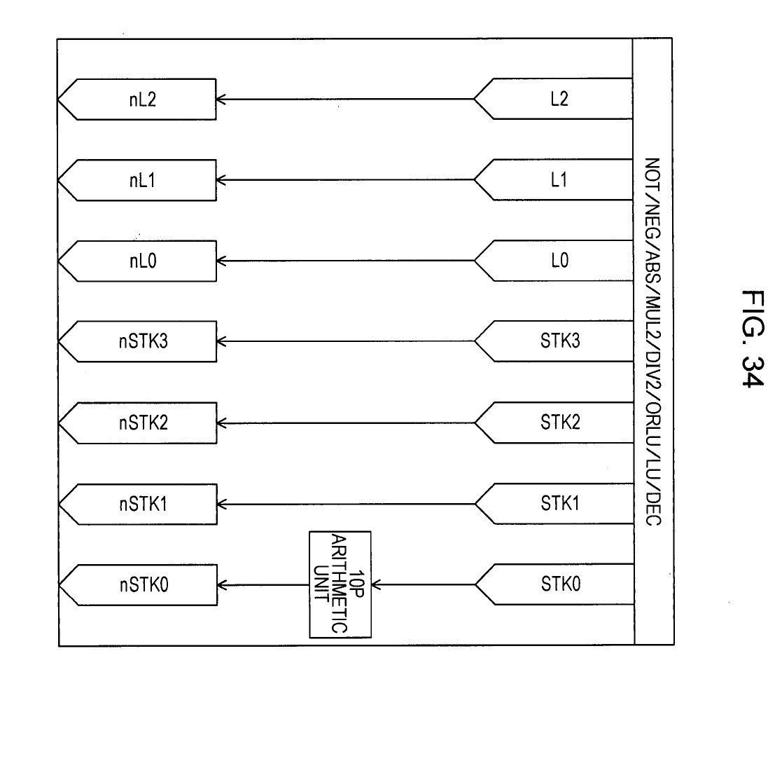

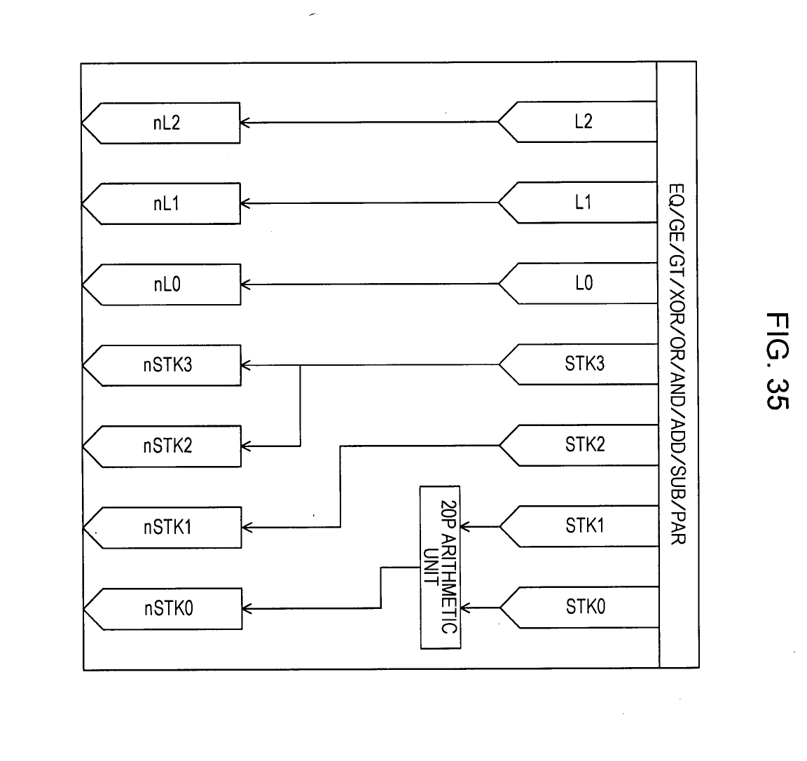

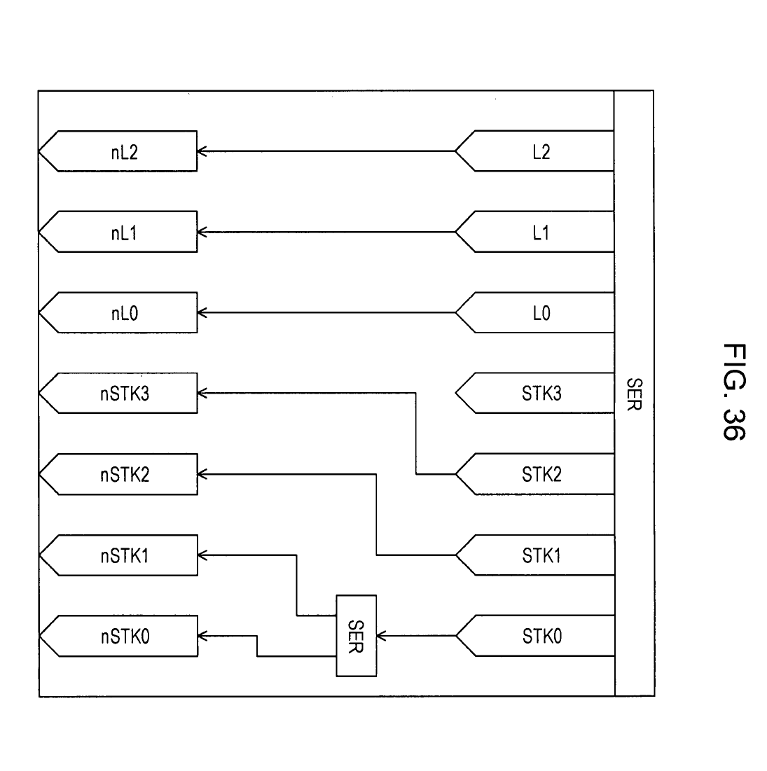

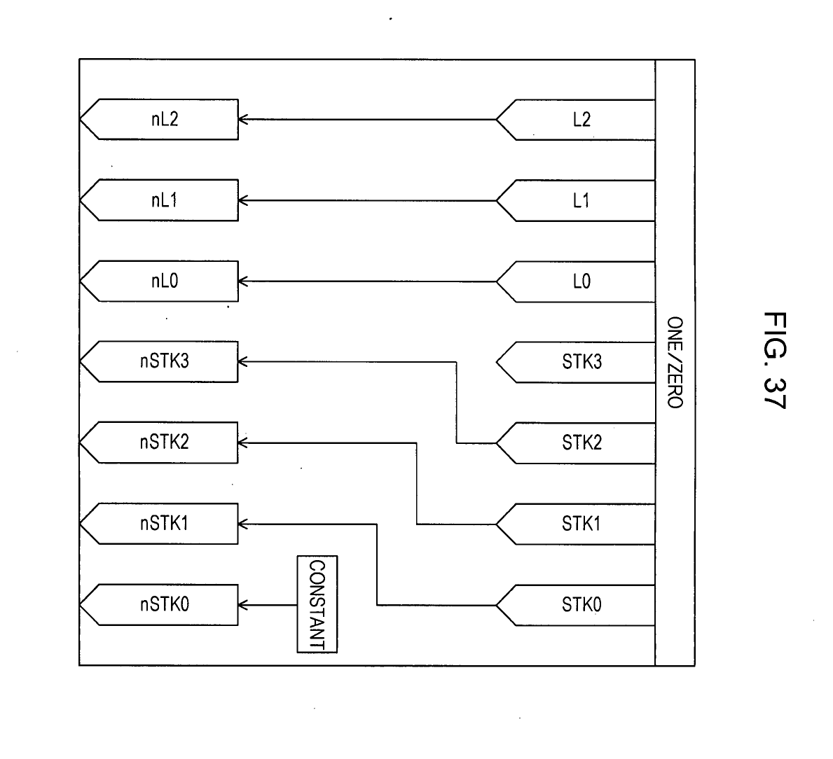

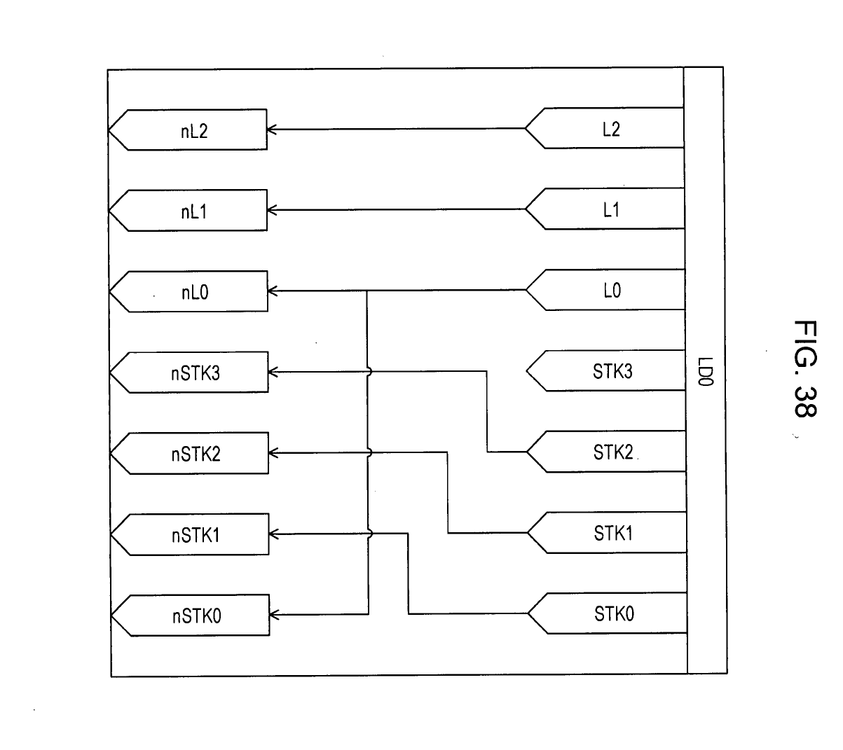

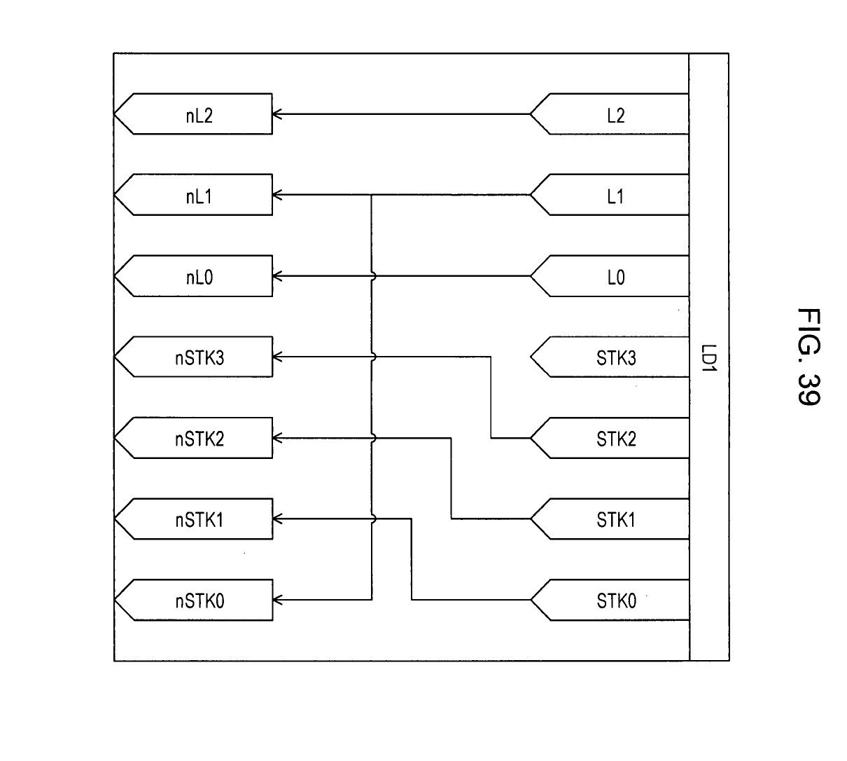

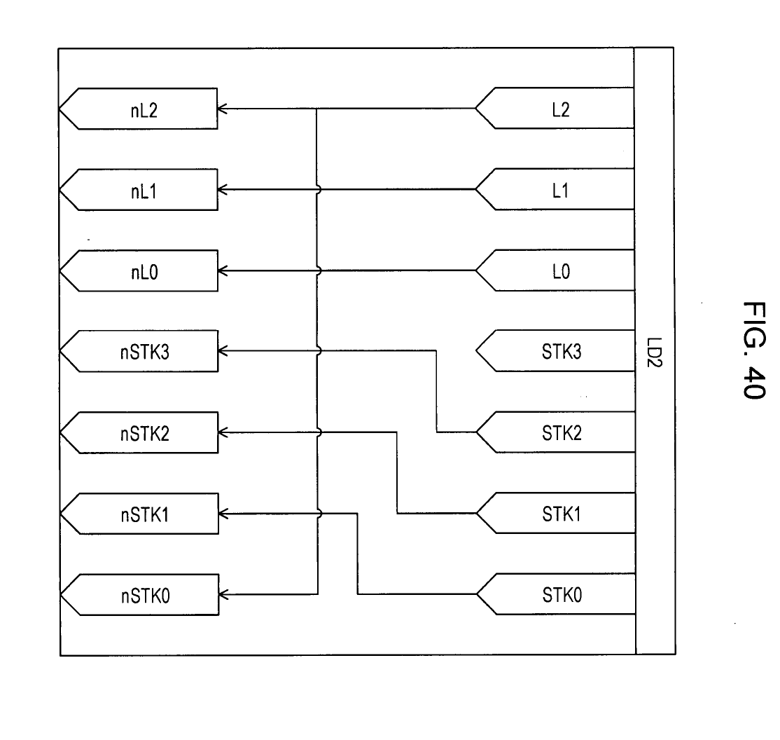

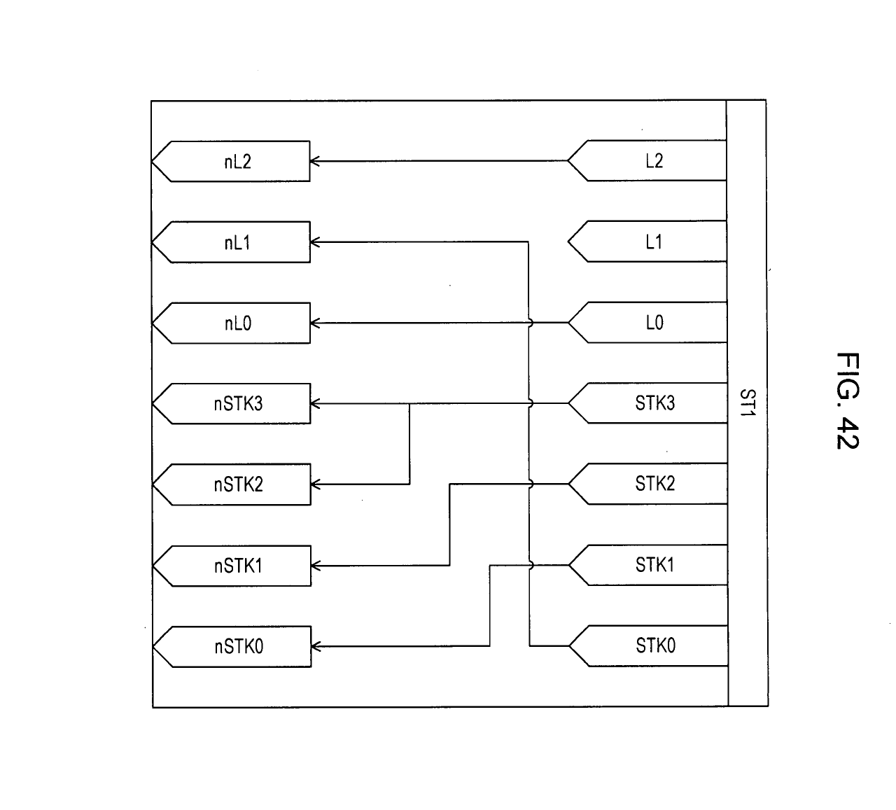

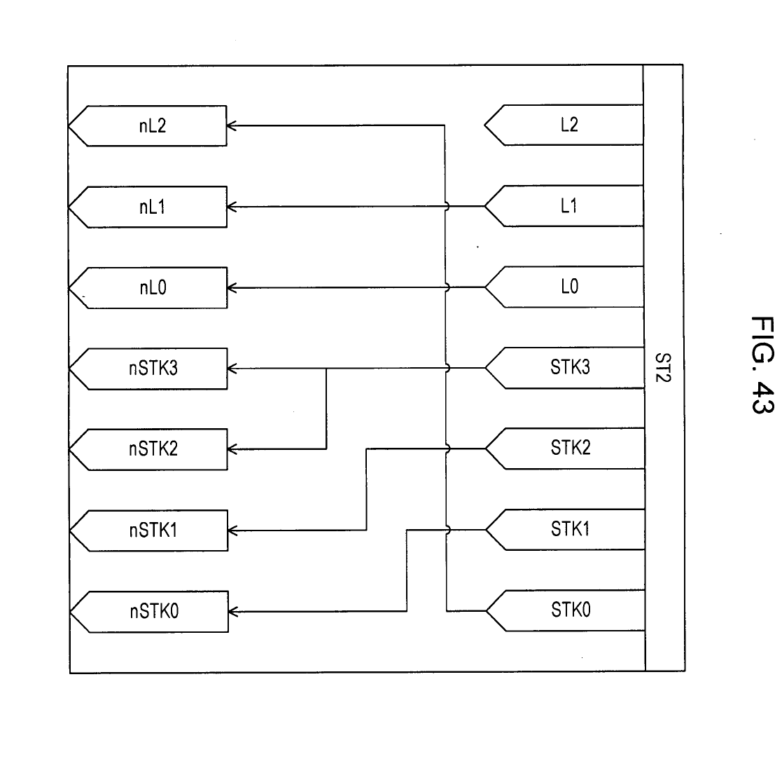

FIGS. 26 to 43 illustrate an example of a data operation performed by each of the microinstructions in a micro instruction set according to the first embodiment of the present invention. In FIGS. 26 to 43, the name of the microinstruction is shown in the upper section. In addition, STK0 to STK3 indicate the values of the stack registers 421 to 424, respectively, before the instruction is executed. L0 to L2 indicate the values of the local variable registers 425 to 427, respectively, before the instruction is executed. In addition, nSTK0 to nSTK3 indicate the values of the stack registers 421 to 424, respectively, after the instruction has been executed. nL0 to nL2 indicate the values of the local variable registers 425 to 427, respectively, after the instruction has been executed.

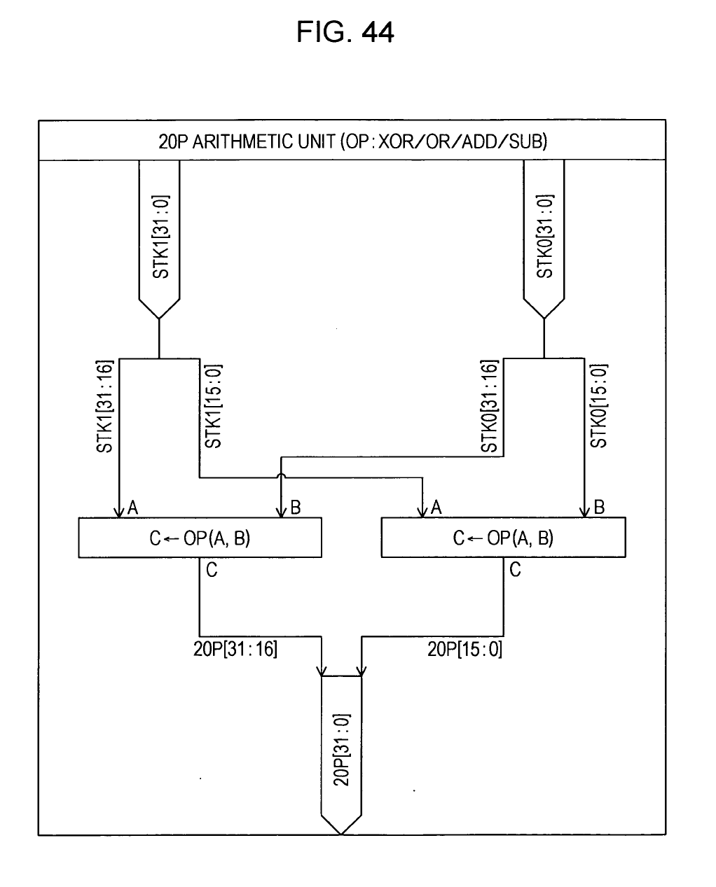

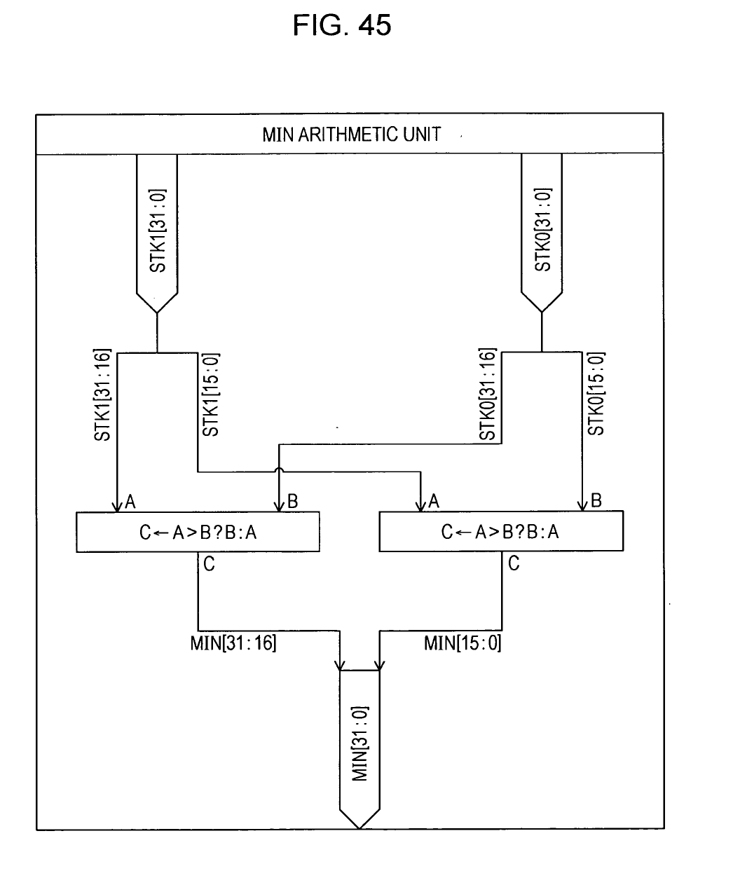

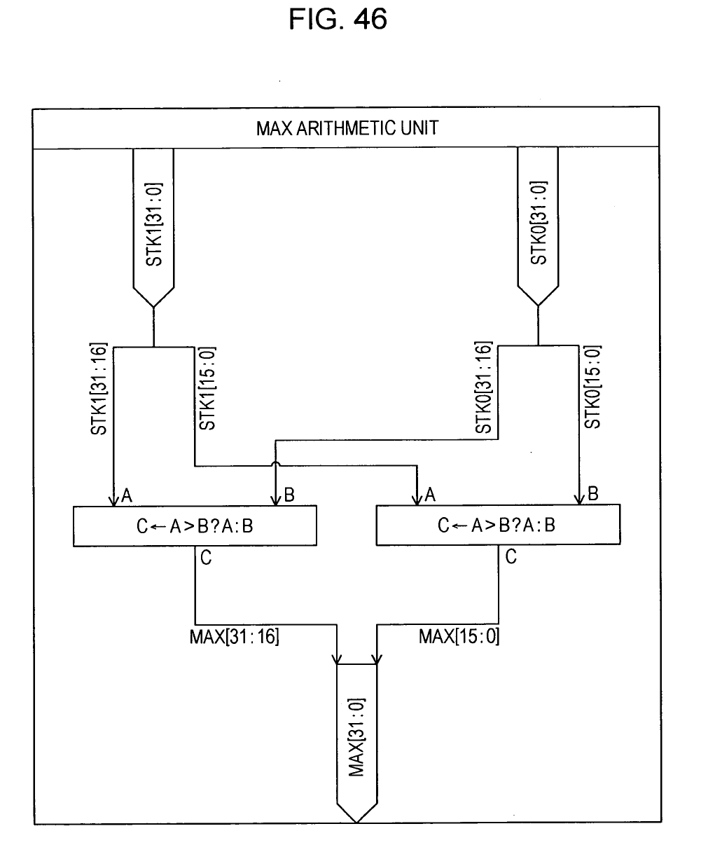

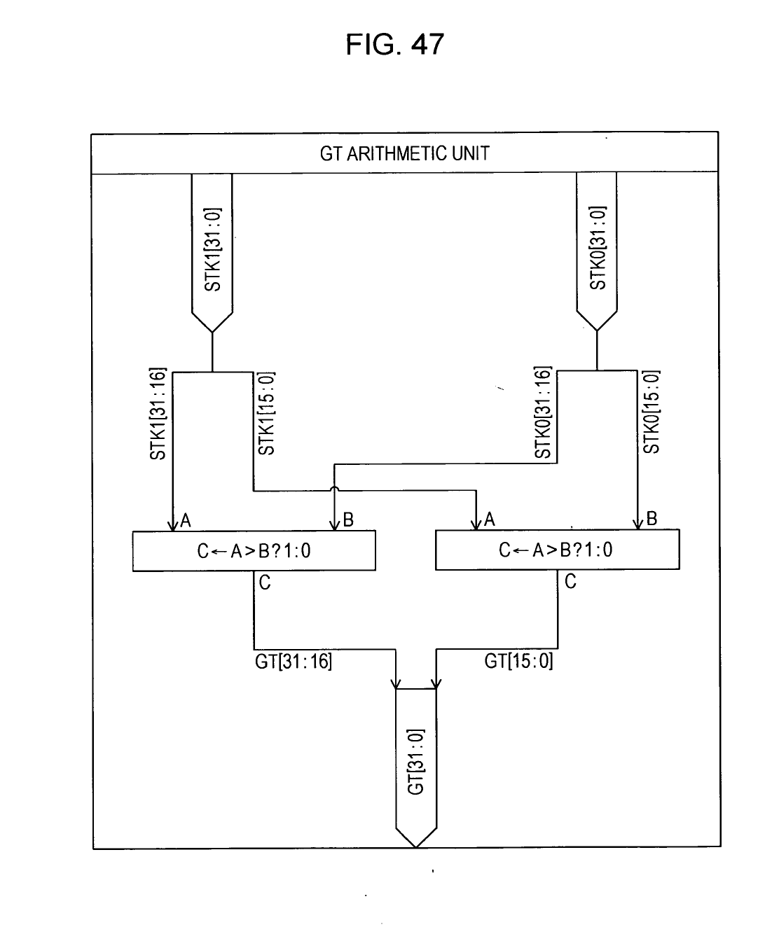

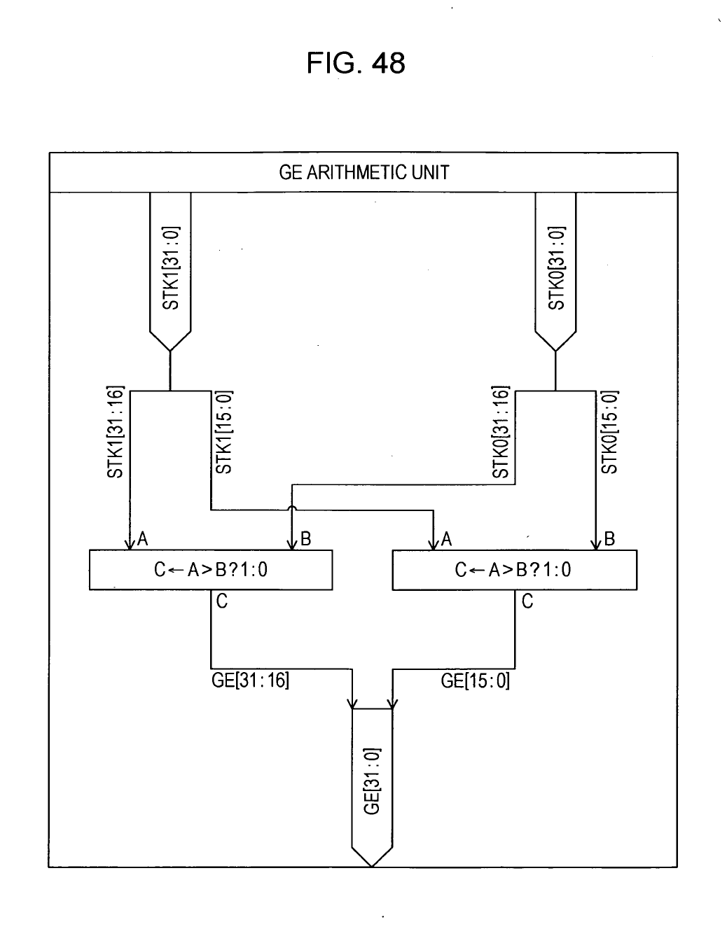

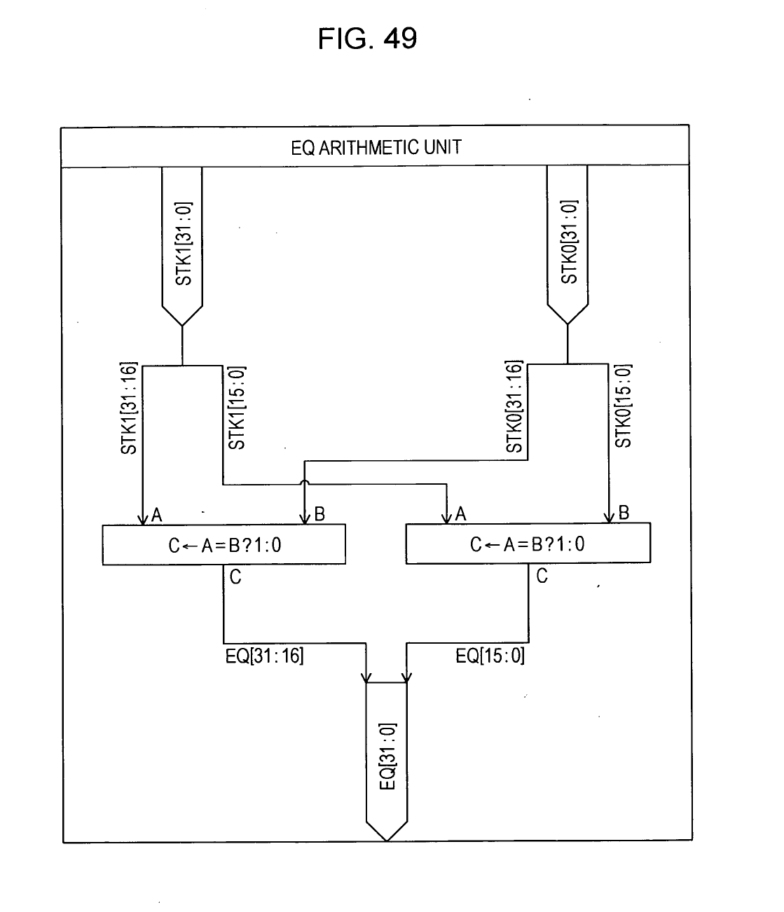

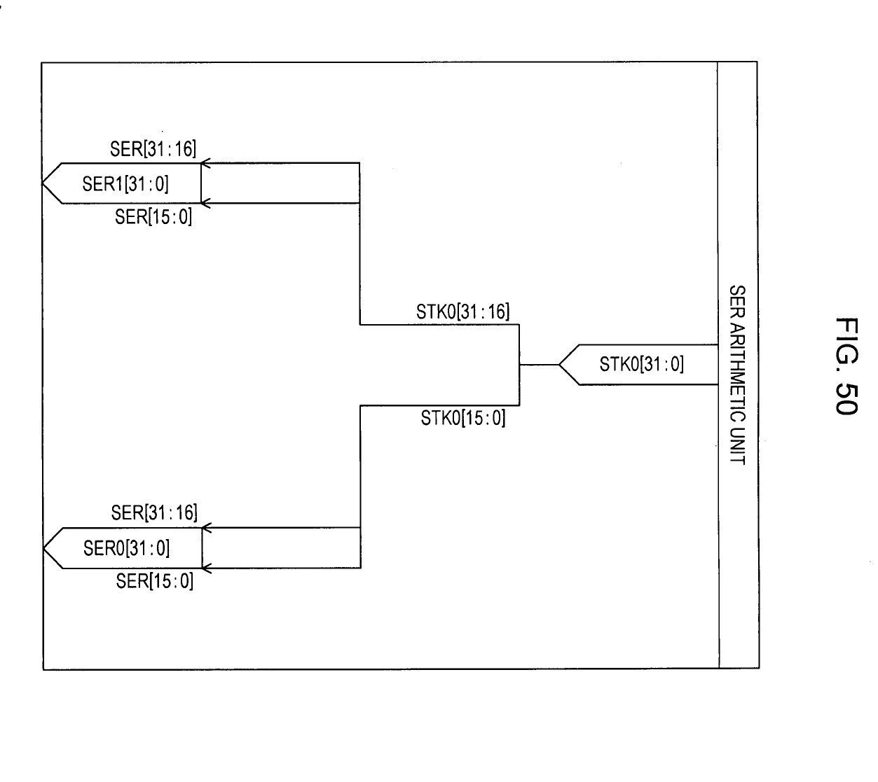

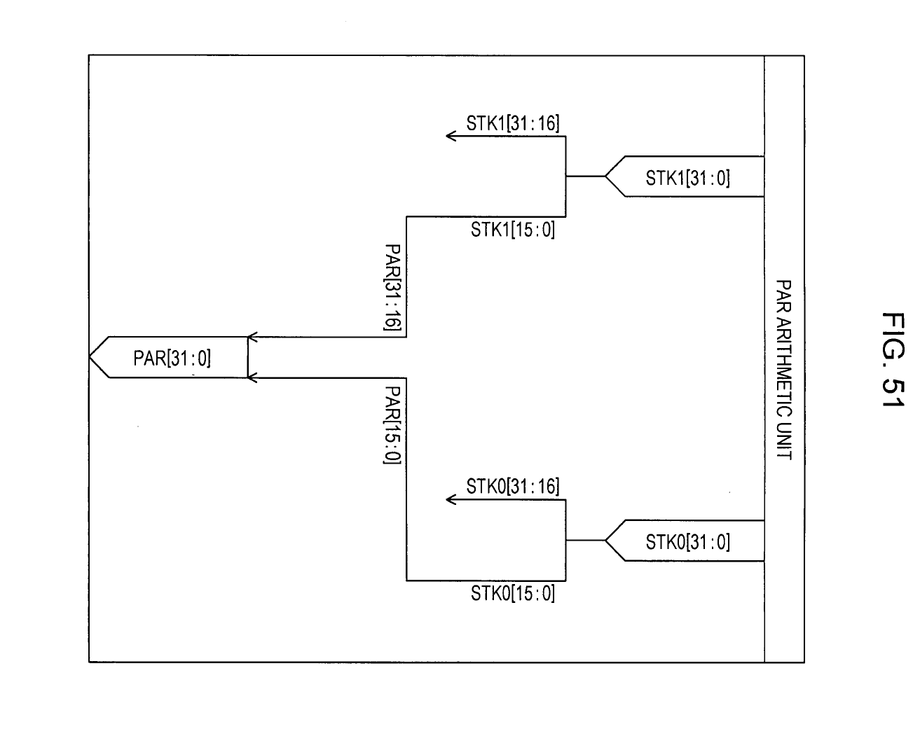

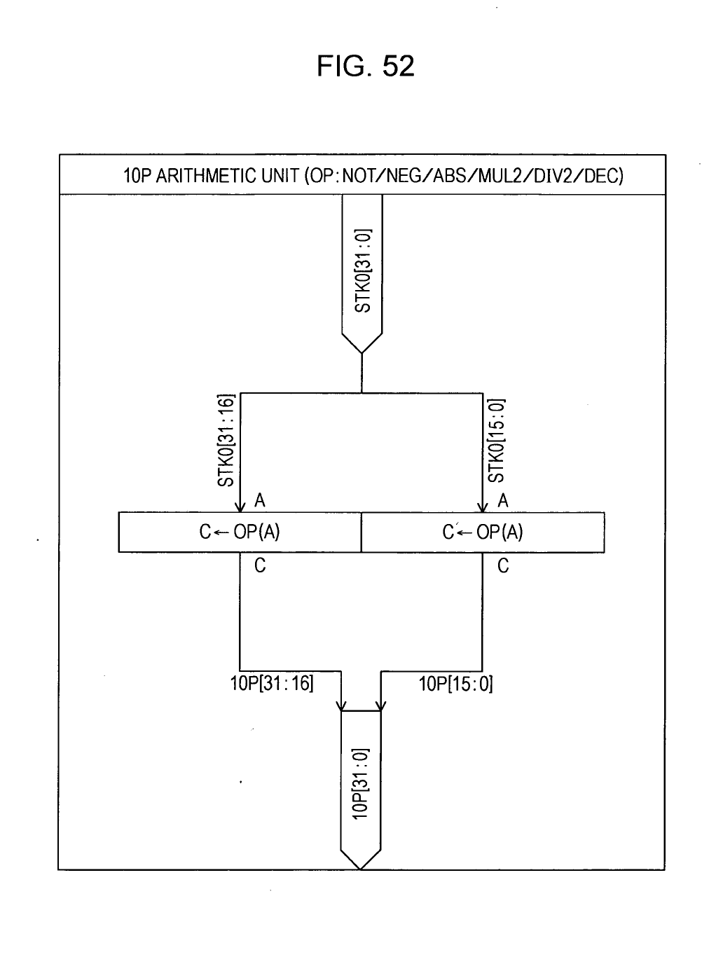

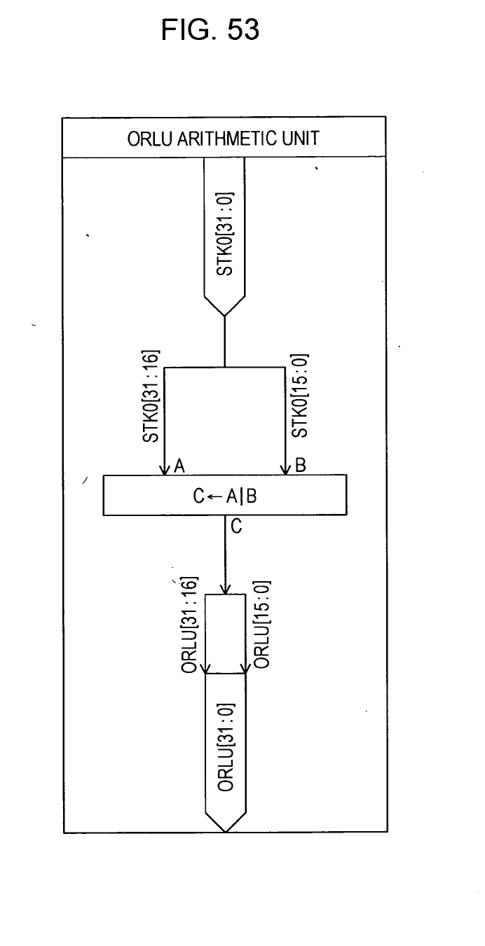

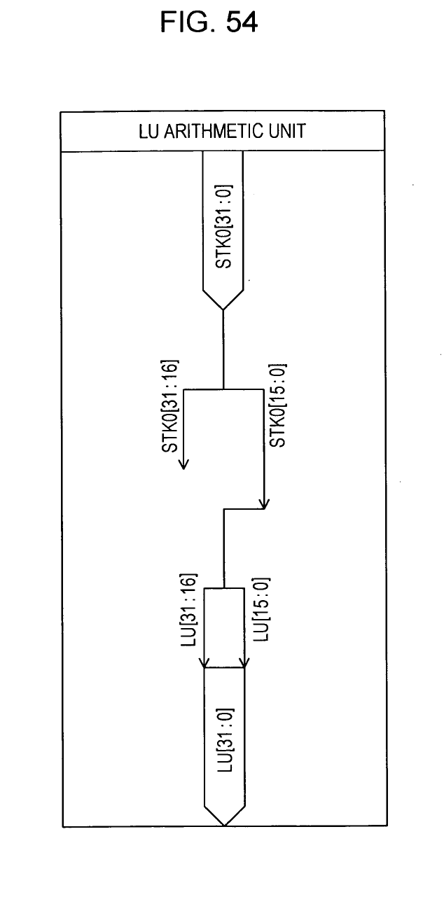

FIGS. 44 to 54 illustrate examples of the configurations of the arithmetic units used for the microinstruction set according to the first embodiment of the present invention. Each of the arithmetic units receives a data item (STK0) popped up from a stack register for the first time or a data item (STK1) popped up for a second time. The arithmetic operations are the same as those illustrated in FIG. 10. Accordingly, descriptions thereof are not repeated.

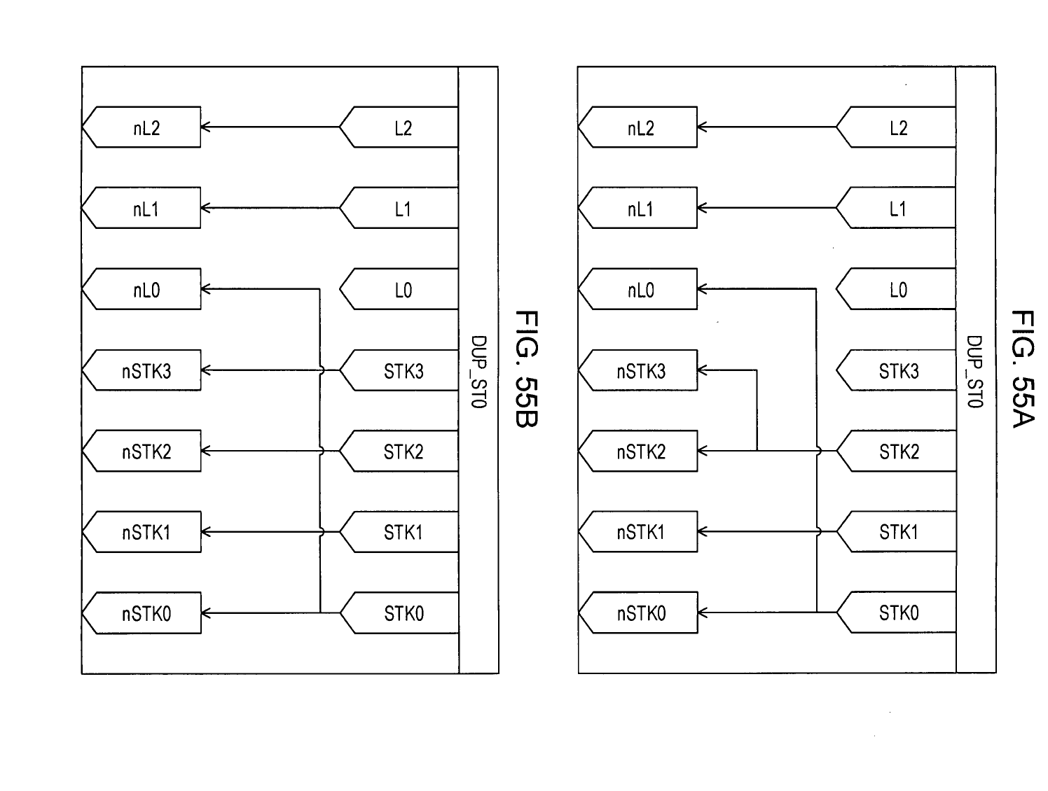

FIGS. 55 to 57 illustrate an example of folding according to the first embodiment of the present invention.

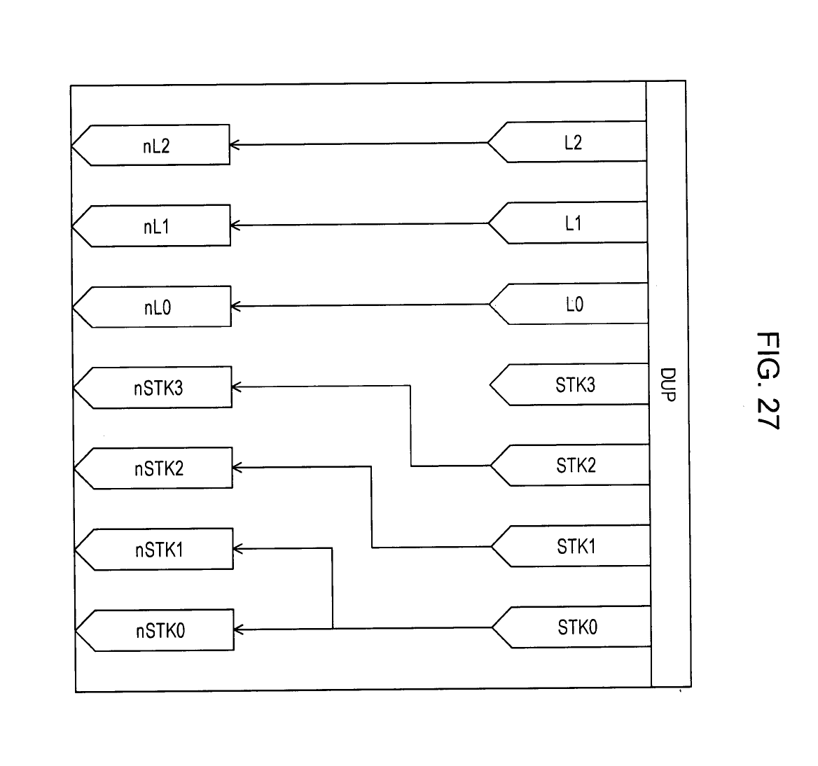

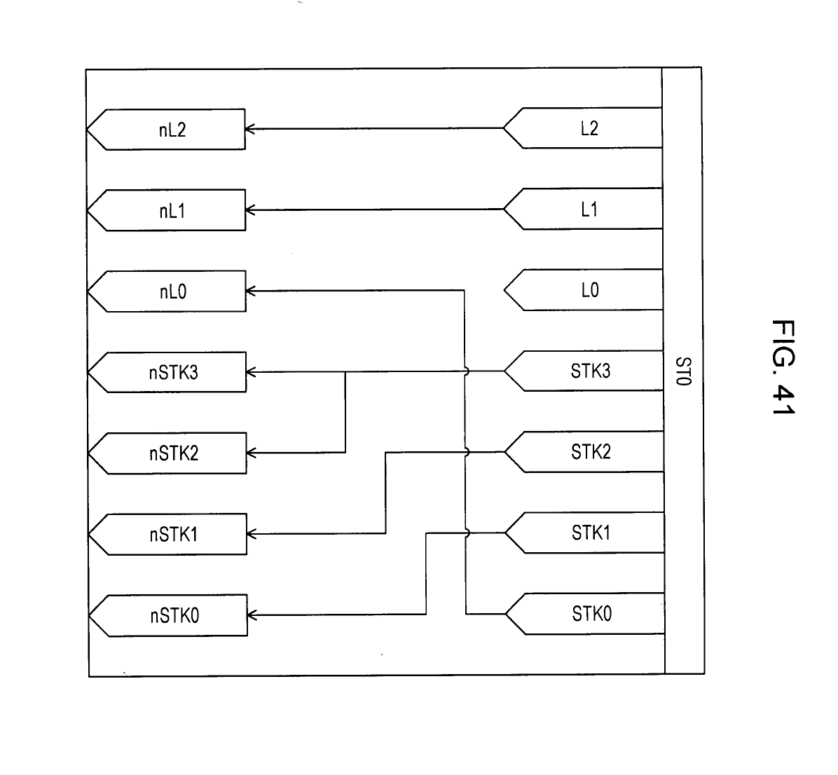

FIG. 55A illustrates an example of folding of DUP_ST0. The DUP instruction illustrated in FIG. 27 and the ST0 illustrated in FIG. 41 are concatenated and rewritten. In addition, FIG. 55B illustrates an example in which the example illustrated in FIG. 55A is modified and optimized so that the data operation is more simplified. Between the DUP instruction and the ST0 instruction, the push operation and the pop operation are canceled out. Therefore, such modification is available. In this way, a data item that disappears due to each of the stack operations when the instructions are sequentially executed can be saved.

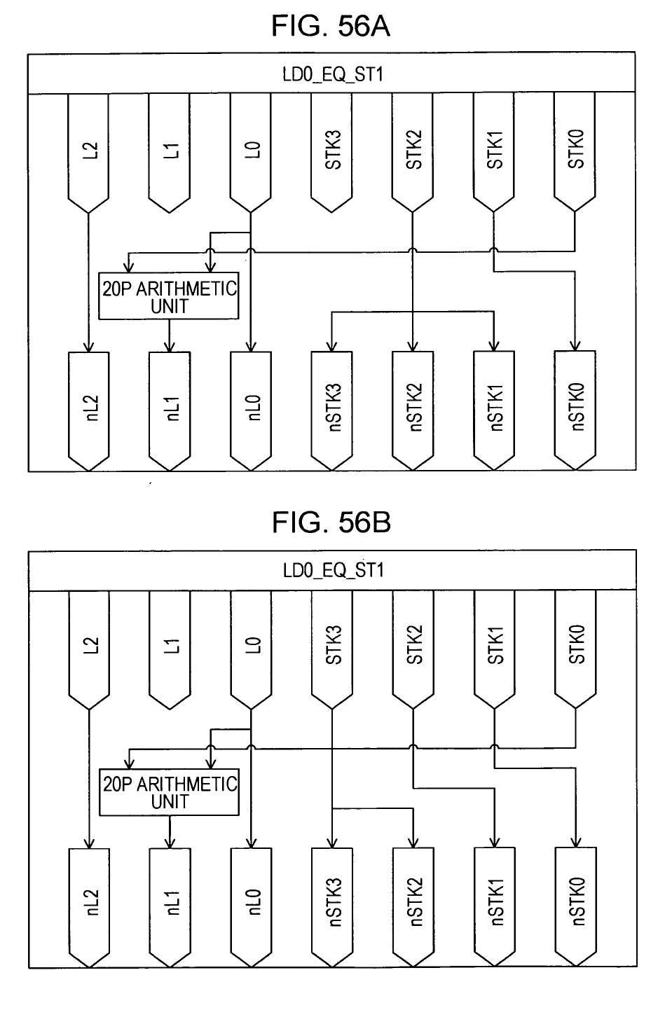

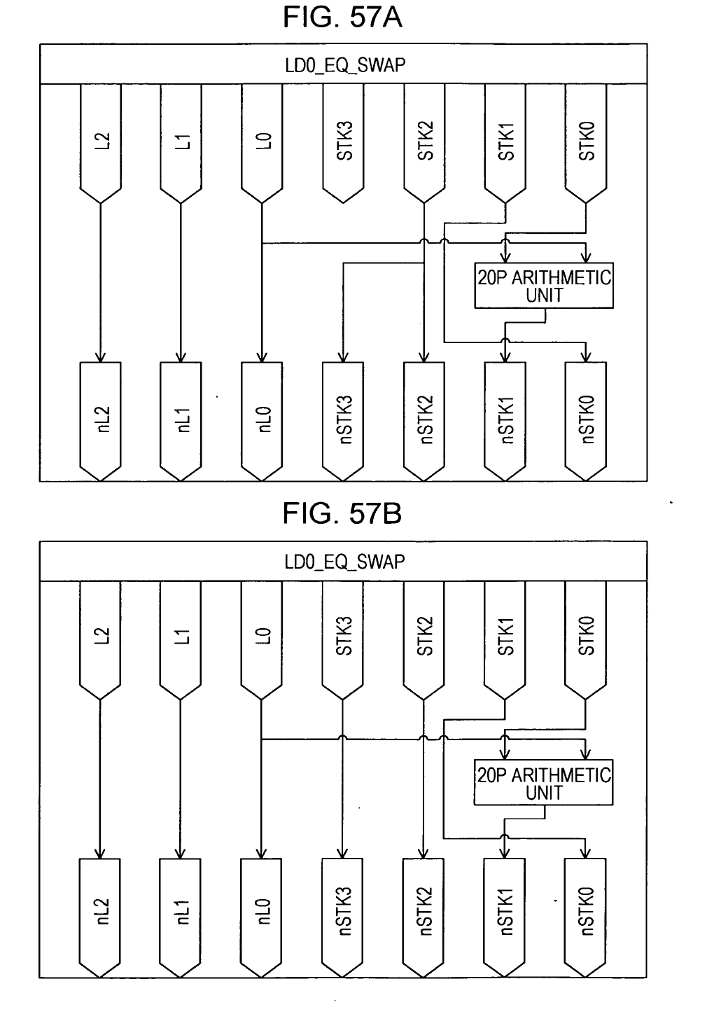

FIG. 56 illustrates an example of folding of LD0_EQ_ST1. FIG. 57 illustrates an example of folding of LD0_EQ_SWAP. For example, in FIG. 57A, STK3 is overwritten with STK2. However, in FIG. 57B, STK3 is preserved. Therefore, the stack state that is the same as the stack state after computation is performed when a stack depth is 5 can be obtained.

Through such optimization, the depth of the stack register can be seen as if the depth were greater than the actual depth by pushing only the result of computation performed by the last instruction when folding is performed.

In addition, as can be seen from a comparison of FIGS. 55A and 55B, a comparison of FIGS. 56A and 56B, and a comparison of FIGS. 57A and 57B, even when folding is performed, data operations do not necessarily become complicated. As in the example illustrated in FIGS. 55A and 55B, by only overwriting L0 with STK0, the operation becomes simpler than that of DUP or ST0 before folding is performed. This is a characteristic of a stack machine.

### Example of Microprogram

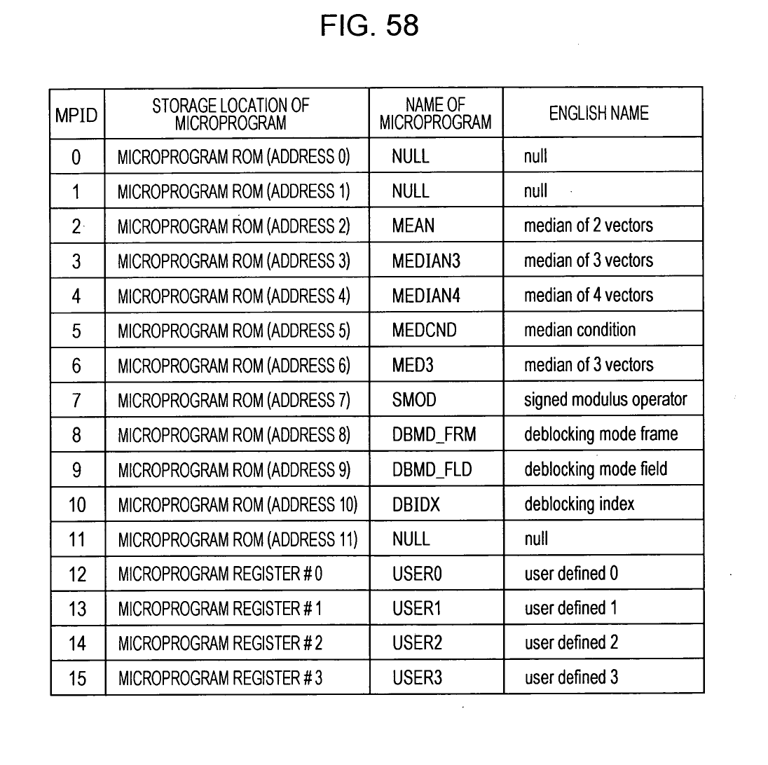

FIG. 58 illustrates an example of a list of microprograms for the information processing system according to the first embodiment of the present invention. In the microprogram memory 230, 12 types of microprograms having MPIDs of “0” to “11” are prestored in the microprogram ROM 231. In addition, a user can store 4 types of microprograms having MPIDs of “12” to “15” in the microprogram registers 232 to 235. The microprograms illustrated in FIG. 58 are examples of practical programs that are usable for a video codec, such as MPEG2, VC1, or H.264.

NUL microprograms (MPID=0, 1, and 11) are microprograms that are completed without performing data operation. When the microprogram is executed, it is necessary that an argument that complies with the interface be pushed onto a stack register or the argument be set in a local variable register. An instruction of the higher-layer processor 100 that starts execution of the microprogram can transfer data items in only general-purpose registers RT and RS at a time. In order to transfer three or more data items, it is necessary that a data item be pushed. Accordingly, a macro instruction that performs only a push operation is provided so that three or more arguments can be set before execution. In order to realize a push dedicated instruction using a mechanism of the instructions of the higher-layer processor 100 that starts execution of a microprogram, the NULL microprogram is used. That is, by setting the MPID to “0” or “1” and using the NULL microprogram, a macro instruction that performs only data setting can be used.

A MEAN microprogram (MPID=2) is a microprogram that computes a mean value of components of a certain type of two motion vectors. A MEDIAN3 microprogram (MPID=3) is a microprogram that computes the intermediate value of components of a certain type of three motion vectors. A MEDIAN4 microprogram (MPID=4) is a microprogram that computes the intermediate value of components of a certain type of four motion vectors.

A MEDCND microprogram (MPID=5) is a microprogram that performs pre-processing for a MED3 microprogram (MPID=6). In the pre-processing, it is determined whether the condition of exceptional processing is satisfied or not. The MED3 microprogram is a microprogram that computes the intermediate value of components of a certain type of three motion vectors in accordance with the result output from the MEDCND microprogram.

An SMOD microprogram (MPID=7) is a microprogram that performs signed modulus computation as follows:

SMOD(A,b)=((A+b)&(2b−1))−b

A DBMD_FRM microprogram (MPID=8) is a microprogram that performs computation regarding a deblocking mode of H.264 frame processing. A DBMD_FLD microprogram (MPID=9) is a microprogram that performs computation regarding a deblocking mode of H.264 field processing. A DBIDX microprogram (MPID=10) is a microprogram that performs index computation regarding a parameter table of an H.264 deblocking filter.

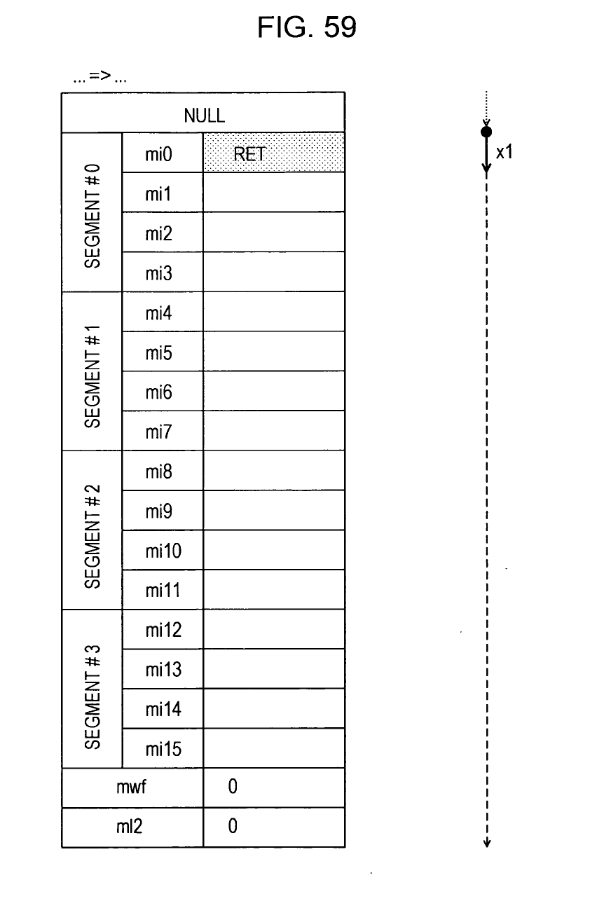

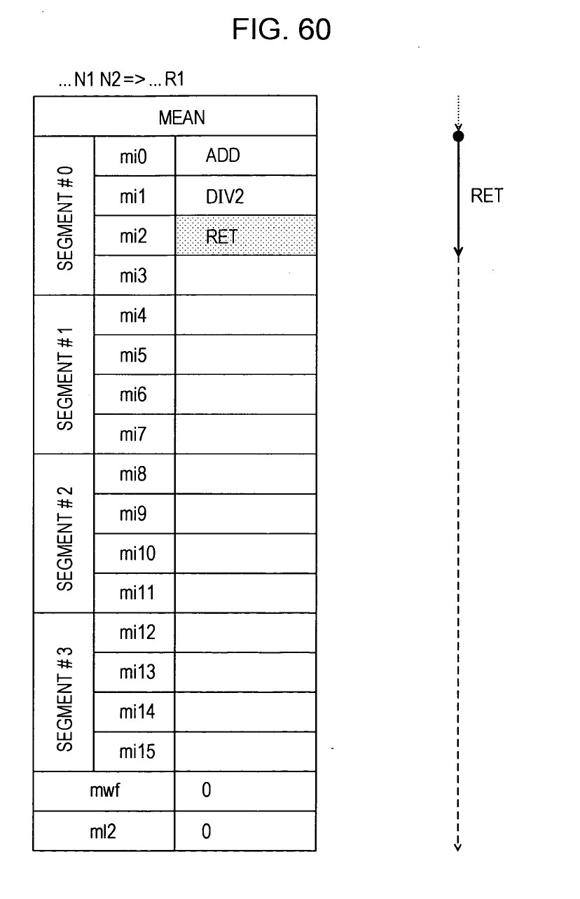

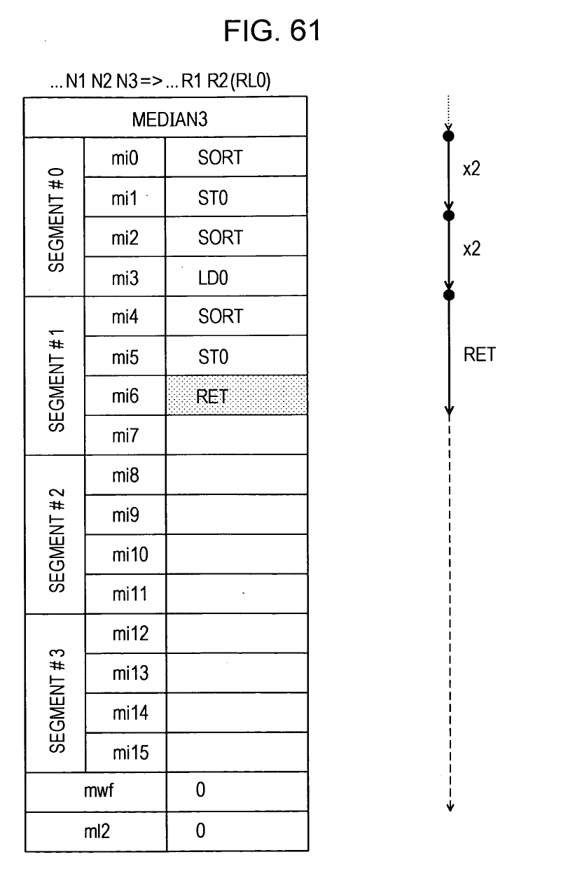

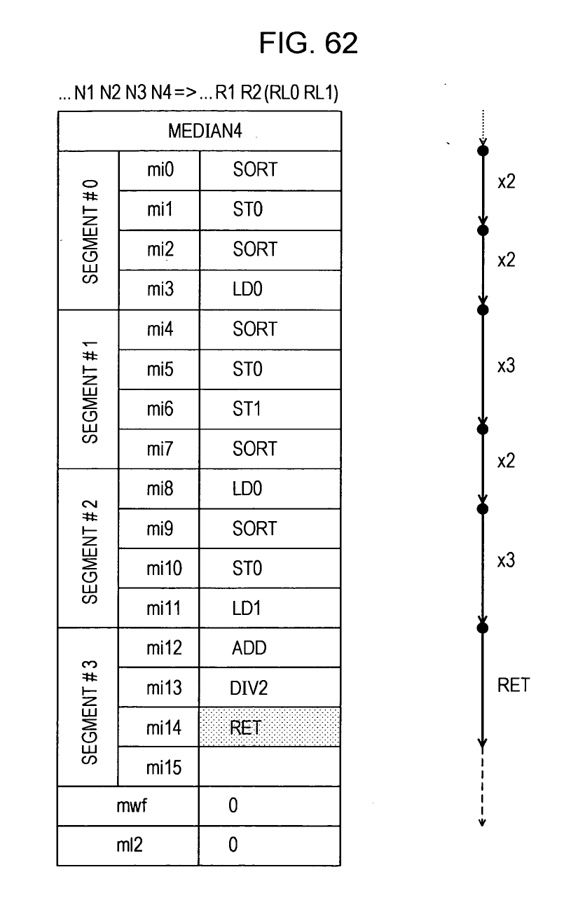

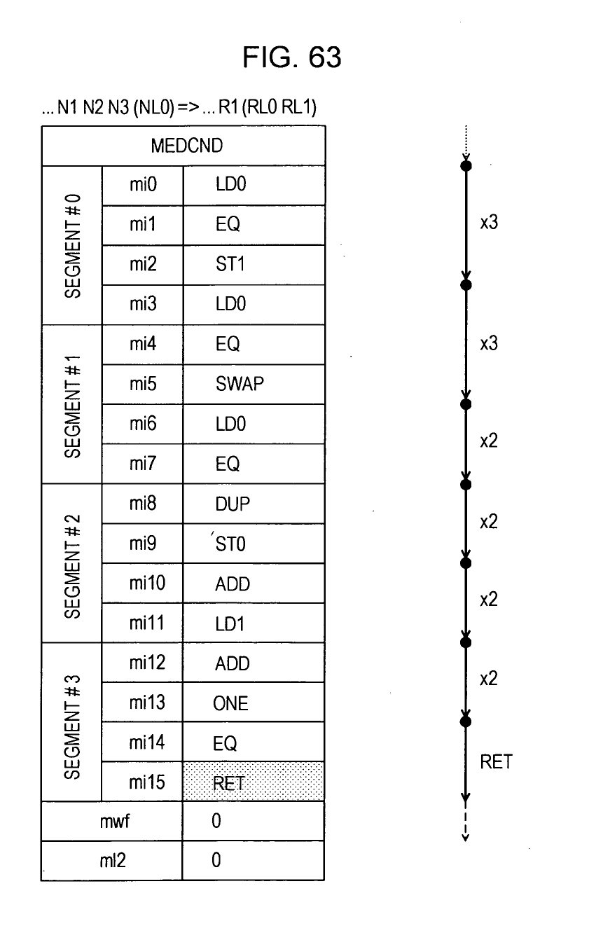

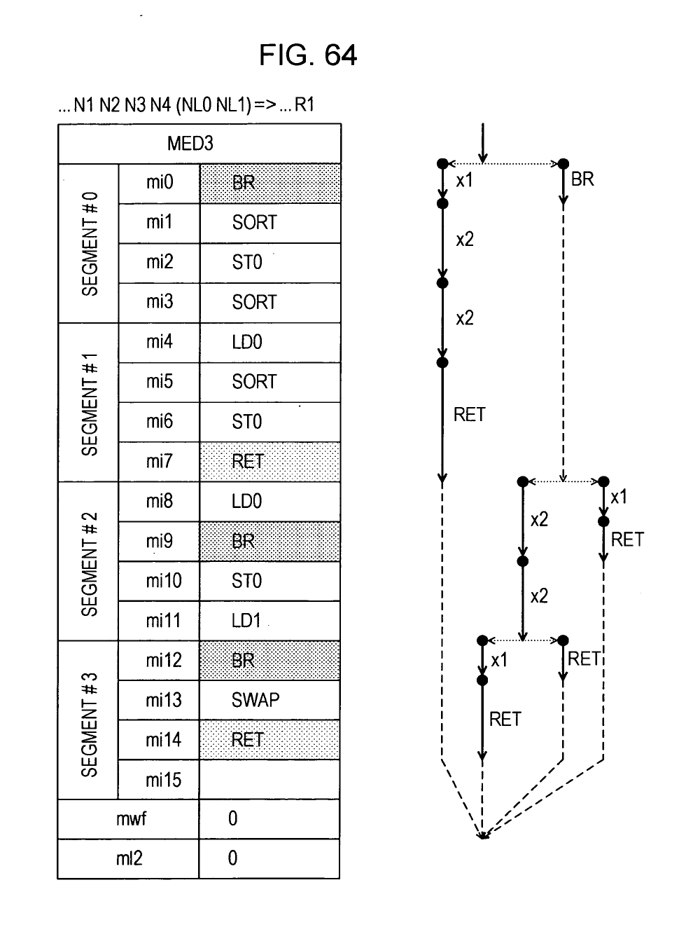

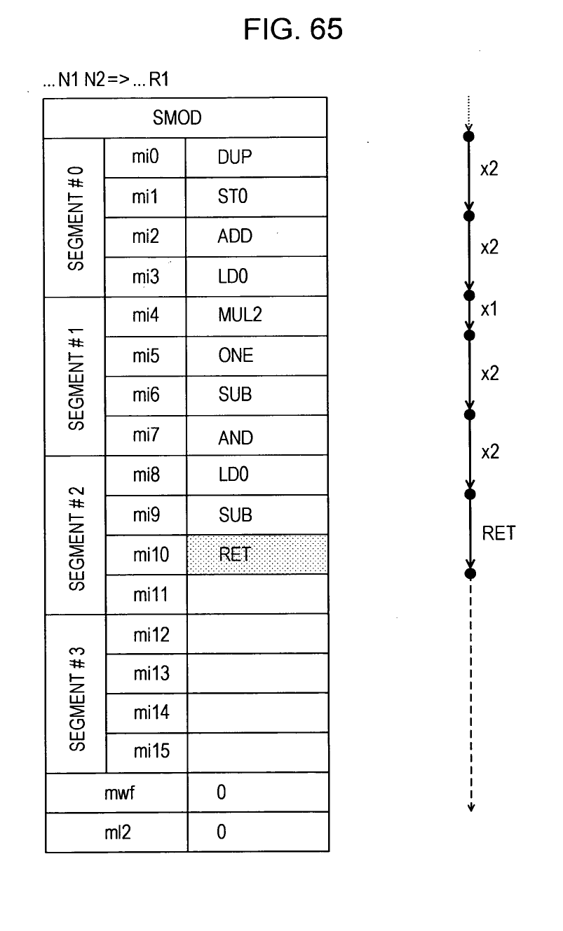

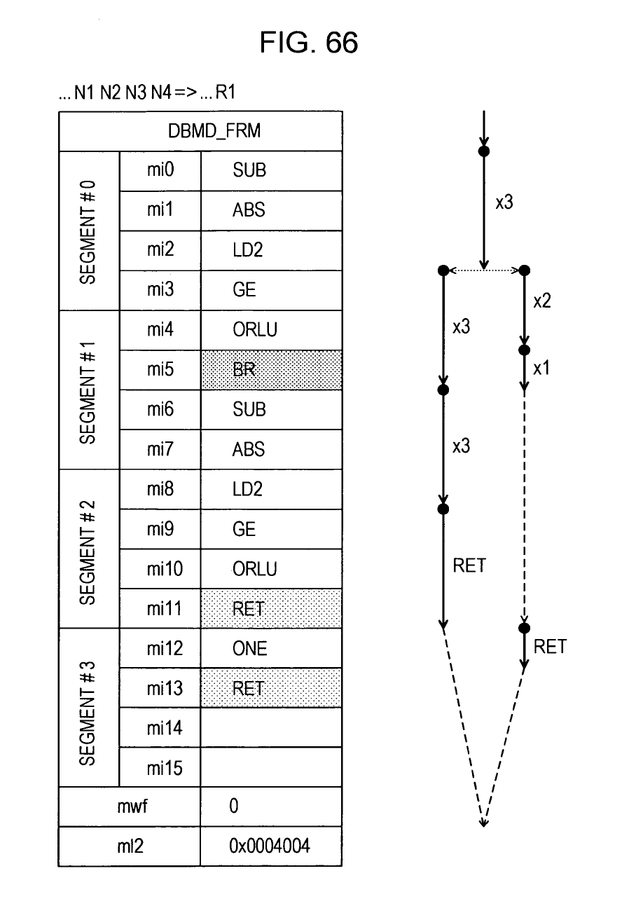

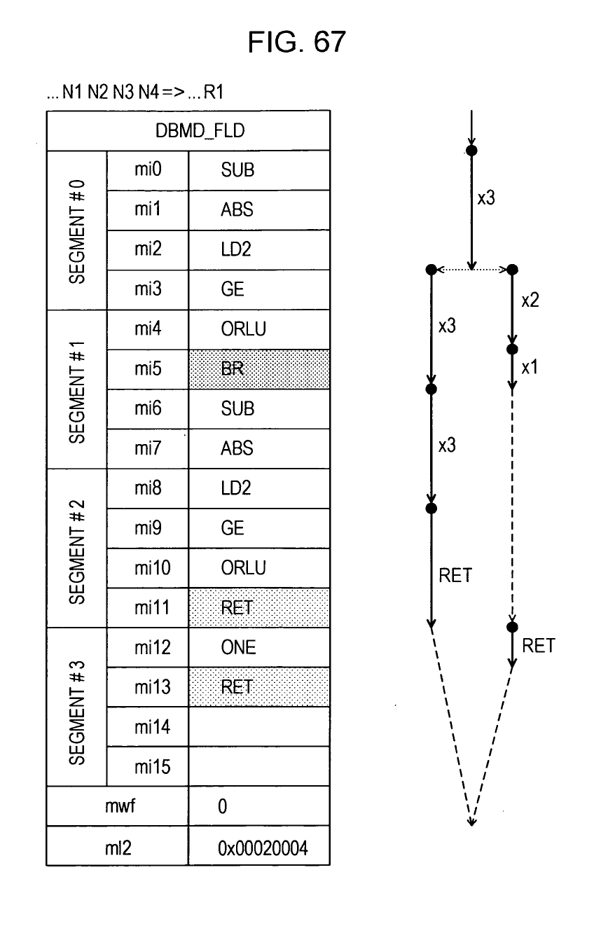

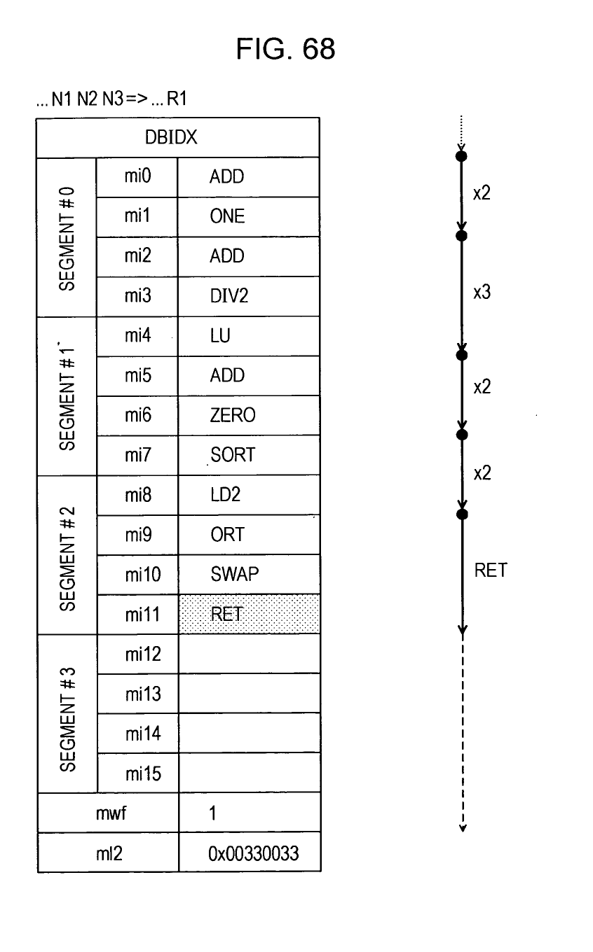

FIGS. 59 to 68 illustrate a branch path of each of the microprograms illustrated in FIG. 58 according to the first embodiment of the present invention. In each of FIGS. 59 to 68, the details of the microprogram are shown in the left section, and a branch path of the microprogram is shown in the right section. The execution type is attached to each branch of the branch path. In addition, the state of the working register is shown in the upper section. The state before the microprogram is executed is shown on the left of “=>”, and the state after the microprogram is executed is shown on the right of “=>”. In each of the stack state, the stack top is located on the right. In addition, a value set in the local variable register is shown in parentheses.

It can be seen from this example that folding of a maximum of three instructions is available even for a practical microprogram. By compressing the instructions, an efficient process can be performed.

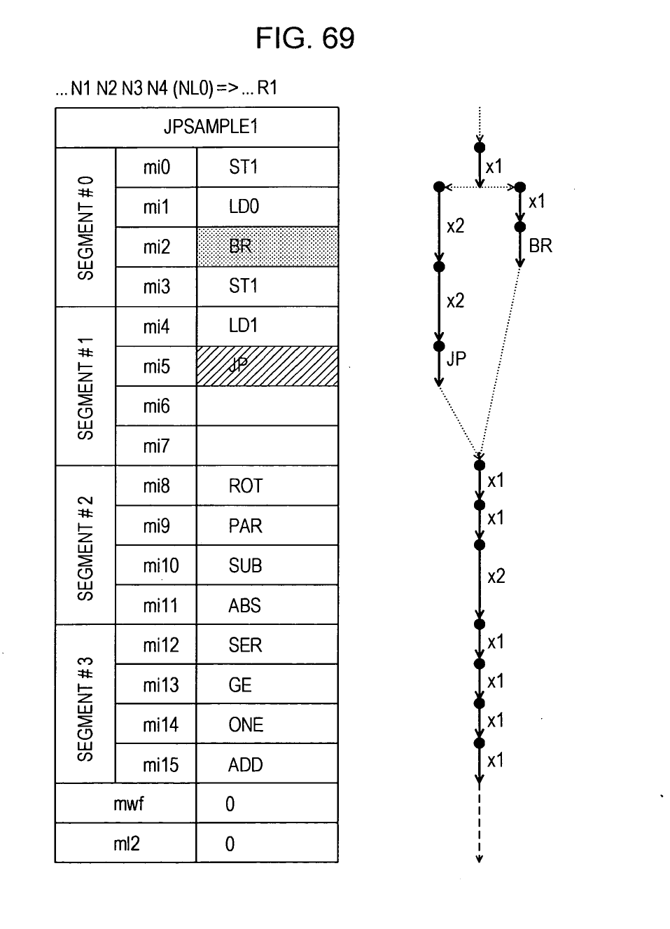

FIG. 69 illustrates a branch path of a first sample using a JP instruction according to the first embodiment of the present invention. In the first sample, a JP instruction which is an unconditional branch instruction is necessary. The branch path is fixed. Accordingly, even when instructions to be processed are not present in mi5, mi6, and mi7, it is necessary for the microprogram to be executed. In such a case, the control is branched to the next segment by using a JP instruction so that the number of cycles is minimized.

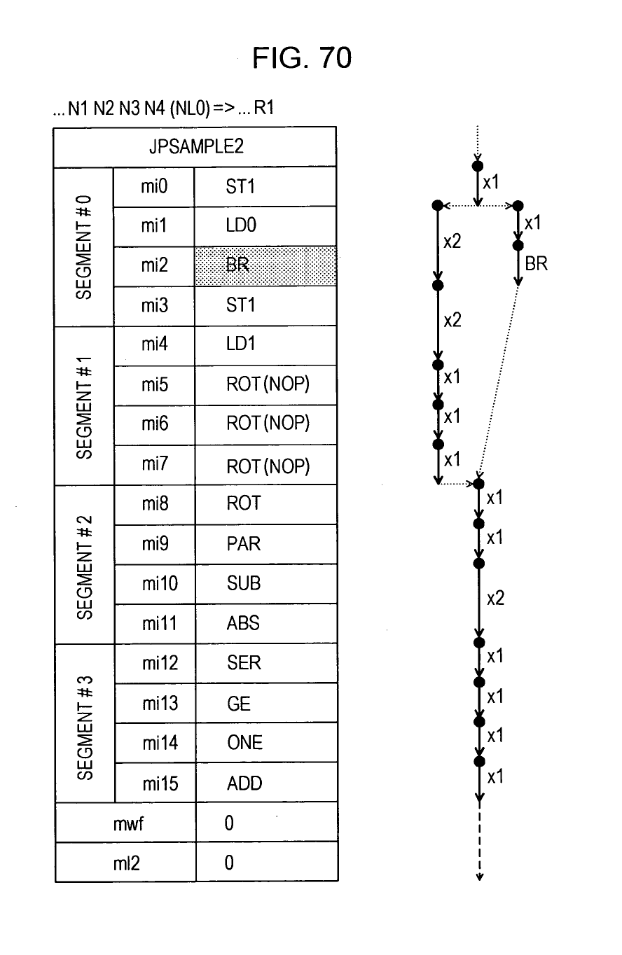

FIG. 70 illustrates a branch path of a second sample using a JP instruction according to the first embodiment of the present invention. In the second sample, the microprogram does not include a JP instruction. When a JP instruction is not used, three NOP instructions may be arranged for adjustment. However, in order to perform folding, it is desirable that an arithmetic instruction is assigned in place of using NOP instructions. Accordingly, since data is restored by executing a ROT instruction three times, the use of a NOP instruction is eliminated in this example. Note that in the case of two NOP instructions, a SWAP instruction can be executed twice.

### Interface to Higher-Layer Processor

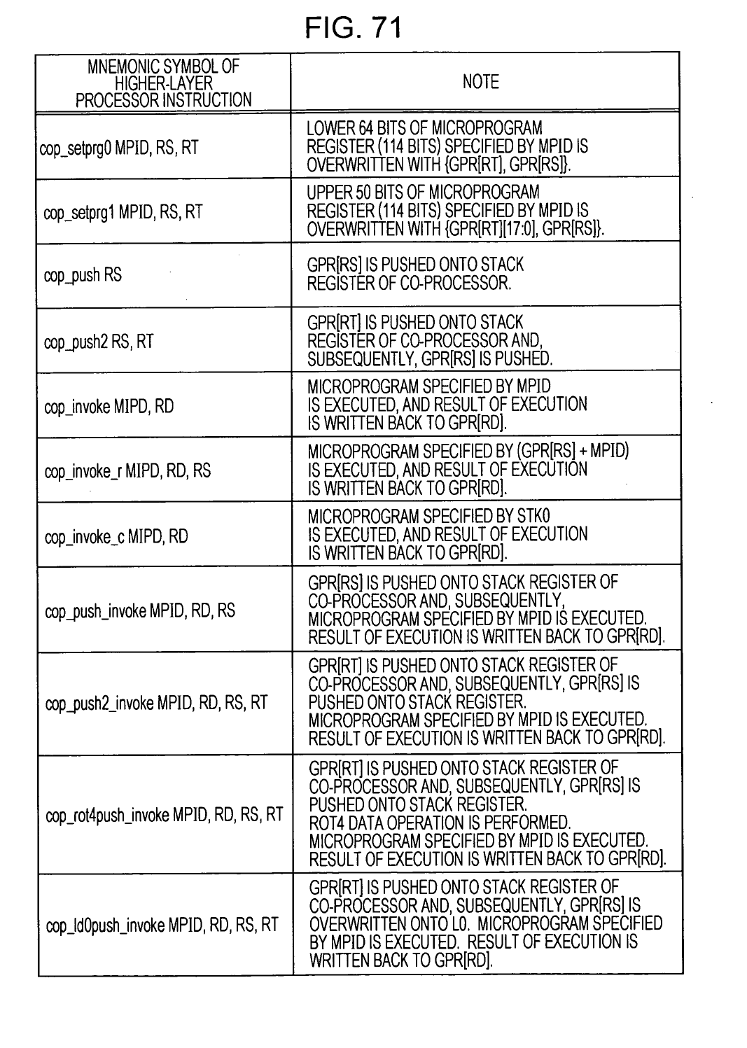

FIG. 71 illustrates an example of a list of co-processor instructions of the higher-layer processor 100 according to the first embodiment of the present invention. The prefix “cop_” of a mnemonic symbol indicates that the instruction is a co-processor instruction.

cop_setprg0 and cop_setprg1 are instructions used for rewriting the microprogram registers 232 to 235. cop_push and cop_push2 are instructions used for pushing data stored in a general-purpose register into the stack registers 421 to 424.

The other instructions that includes “invoke” in the mnemonic symbol thereof are instructions used for instructing the microinstruction processing co-processor 200 to execute a microprogram. A plurality of types of instructions are provided because the design methods for the working register 242 differ from each other. A cop_invoke instruction is an instruction used for instructing the microinstruction processing co-processor 200 to execute a microprogram corresponding to the number MPID specified in the instruction. A cop_rot4push_invoke instruction is an instruction for pushing the value of a register of the higher-layer processor 100 onto a stack, retrieving the oldest data in the stack, pushing the retrieved oldest data onto the top of the stack, and instructing the microinstruction processing co-processor 200 to execute a microprogram corresponding to the number MPID. A cop_invoke_r instruction is an instruction for determining the number MPID using the value of a register of the higher-layer processor 100 and instructing the microinstruction processing co-processor 200 to execute the microprogram corresponding to the number MPID. A cop_invoke_c instruction is an instruction for popping up the value at the top of the stack, determining the number MPID of a microprogram to be executed using the popped value, and instructing the microinstruction processing co-processor 200 to execute the microprogram corresponding to the number MPID.

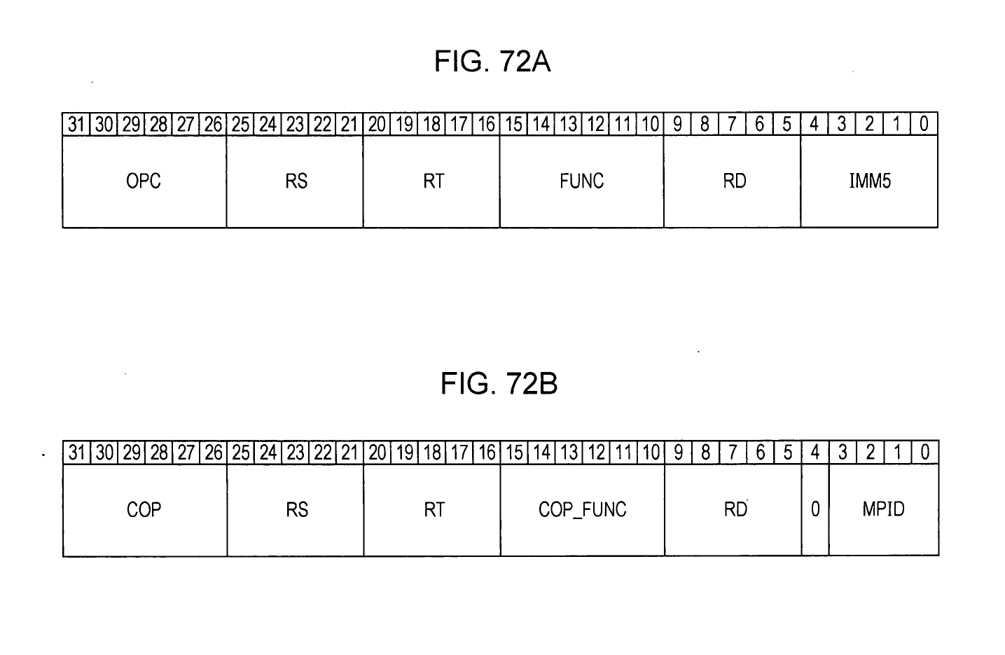

FIGS. 72A and 72B illustrate examples of an instruction format of the higher-layer processor 100 according to the first embodiment of the present invention. FIG. 72A illustrates a basic instruction format. The basic instruction format has a 32-bit field structure including an opcode (OPC), read operands (RS and RT), a function (FUNC), a write operand (RD), and an immediate value (IMM5).

FIG. 72B illustrates the instruction format of a co-processor instruction. The opcode field indicates a co-processor instruction (COP). The function field indicates the type of co-processor instruction (COP FUNC). In addition, the immediate value field can indicate a microprogram number (MPID).

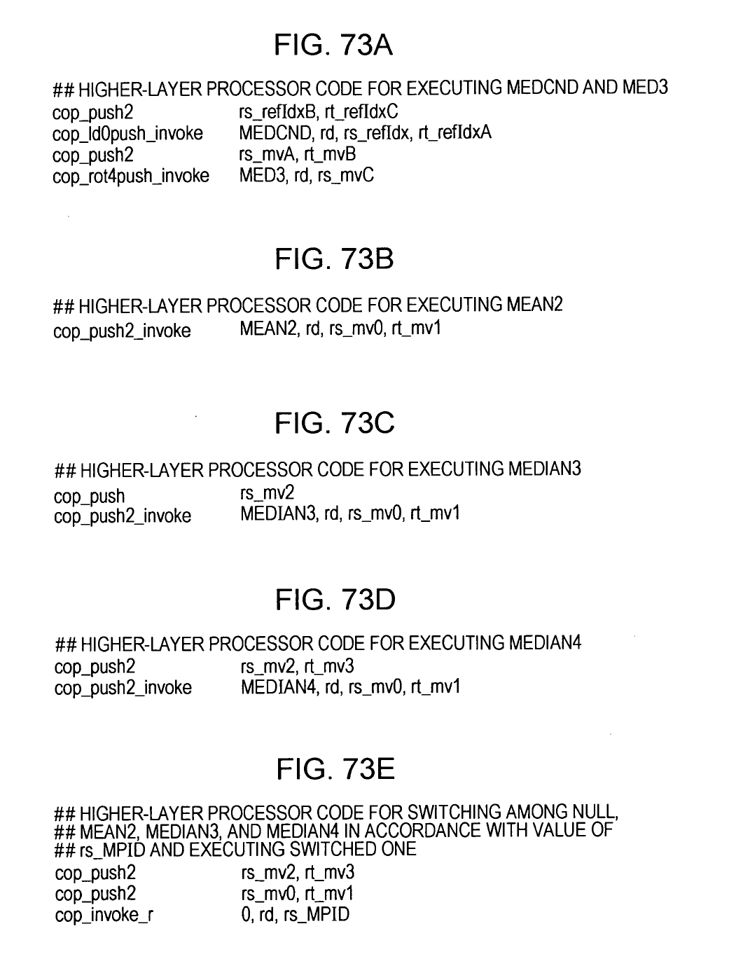

FIGS. 73A to 73E illustrate an instruction group used for instructing execution of a microprogram by the higher-layer processor 100 according to the first embodiment of the present invention.

FIG. 73A illustrates a co-processor instruction used for executing a MEDCND microprogram and a MED3 microprogram. By using the cop_push2 instruction and the cop_ld0push_invoke instruction, the MEDCND microprogram is executed. In addition, by using the cop_push2 instruction and the cop_rot4push_invoke instruction, the MED3 microprogram is executed. In this example, condition determination is made by the MEDCND, and the result is stored in the working register 242 of the microinstruction processing co-processor 200. Subsequently, a new argument is pushed onto the working register 242, and a median process to select an intermediate value of three values is performed. Since the new argument is pushed, the cop_rot4push_invoke instruction is used in order to move the execution result of the MEDCND to the top of the stack before execution is started.

FIG. 73B illustrates a co-processor instruction used for executing the MEAN2. FIG. 73C illustrates a co-processor instruction used for executing the MEDIAN3. FIG. 73D illustrates a co-processor instruction used for executing the MEDIAN4.

FIG. 73E illustrates a co-processor instruction used for switching among the NULL, MEAN2, MEDIAN3, and MEDIAN4 using the value of an rs_MPID and executing the switched one. The cop_invoke_r instruction is used for the switching. When the microprograms are assigned as illustrated in FIG. 58 and if the rs_MPID indicates the specified value “0” or “1”, the NULL microprogram is executed. Thus, the value at the top of the stack is written back. If the rs_MPID indicates the specified value “2”, the execution result of the MEAN2 is written back. If the rs_MPID indicates the specified value “3”, the execution result of the MEDIAN3 is written back. If the rs_MPID indicates the specified value “4”, the execution result of the MEDIAN4 is written back. In general, when such switching is performed by the higher-layer processor 100, complicated branch processing is necessary. However, in this example, only four instructions realize the branch processing. Note that when the same MPID determination is made using STK0 which is the execution result of the immediately previous microprogram, the cop_invoke_c instruction can be used.

As described above, according to the first embodiment of the present invention, by limiting the branch destination of branch instructions such as a JP instruction, a BR instruction, and a RET instruction, the instruction compression efficiency can be increased. In addition, a prefetch operation is facilitated. Furthermore, deadlock can be prevented.

### 2. Second Embodiment

In the first embodiment, the microprogram execution unit 240 is configured as a stack machine. However, the configuration of the microprogram execution unit 240 is not limited thereto. In the following second embodiment, the microprogram execution unit 240 is configured as a queue machine. Note that the basic configuration of an information processing system is the same as that of the first embodiment. Accordingly, the detailed description of the basic configuration is not repeated.

### Basic Concept of Queue Machine

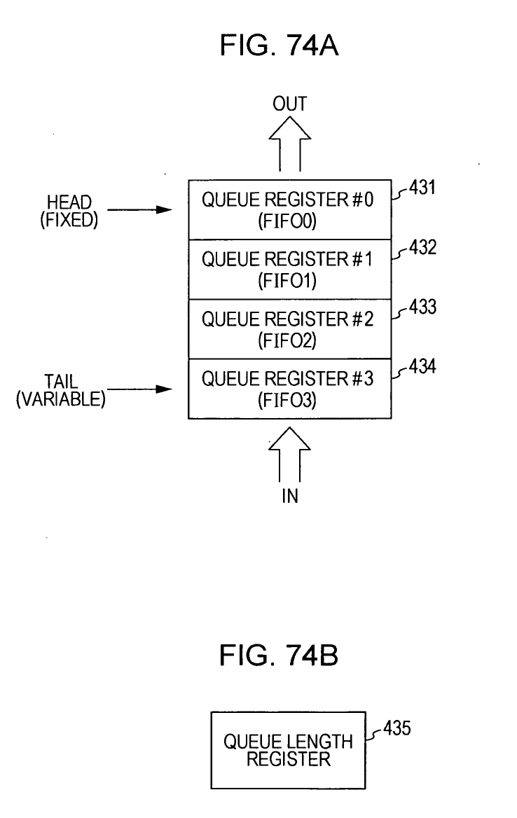

FIGS. 74A and 74B illustrate an example of the configuration of a queue register stored in the working register 242 according to the second embodiment of the present invention. A queue machine employs a queue register using a FIFO queue. In this example, a FIFO queue including four queue registers 431 to 434 is used. Note that the queue registers 431 to 434 are an example of a queue defined in Claims.

In stack machines, data is popped up from the top of a stack, and computation is performed. Thereafter, the result of the computation is pushed onto the top of the stack. In contrast, in queue machines, data is output from the head of the queue, and computation is performed. Thereafter, the result of the computation is input to the tail of the queue. In this way, processing is performed. In order to realize a queue serving as the working register 242 of the microprogram execution unit 240, the head of the queue is fixed to the queue register 431, and the length of the queue is stored in a queue length register 435. Thus, the function of a queue machine is realized. Accordingly, by using the queue registers 431 to 434 in the working register 242, the functions that are the same as those of the first embodiment can be realized.

That is, according to the second embodiment of the present invention, by employing a queue machine as the configuration of the microprogram execution unit 240, an advantage that is the same as that of the first embodiment can be provided. In particular, since a queue machine is optimized in accordance with the depth of a queue, a queue machine has an advantage in that the microinstruction level parallelism can be more easily extracted as the depth of the queue increases. Accordingly, a queue machine is more suitable for parallel computing, such as SIMD.

### 3. Modifications

While the embodiments of the present invention have been described with reference to the applications in which a stack machine or a queue machine is employed for processing microinstructions, the technique is not intended to be limited to such applications of microprograms. For example, the present invention is applicable to an ordinary instruction set.

In addition, while the embodiments of the present invention have been described with reference to the applications in which a stack machine or a queue machine is employed in an execution unit of a co-processor, the technique is not intended to be limited to a co-processor. For example, the present invention is applicable to an ordinary processor.

The described embodiments of the present invention are to be considered in all respects only as illustrative and not restrictive. As noted in the embodiments of the present invention, each of the elements in the embodiment of the present invention has a correspondence to a certain feature of the present invention described in the claims. Similarly, a certain feature of the present invention described in the claims has a correspondence to an element in the embodiment of the present invention having the same name. However, the present invention is not limited to the embodiments, and various modifications can be made without departing from the scope of the present invention.

Furthermore, the processing procedure described in the embodiments of the present invention may be considered as a method including the series of steps of the processing procedure, may be considered as a program that causes a computer to execute the series of steps of the processing procedure, or may be considered as a recording medium that stores the program. Examples of the recording medium include a compact disc (CD), a mini disc (MD), a digital versatile disk (DVD), a memory card, a blu-ray disc (registered trade name).

The present application contains subject matter related to that disclosed in Japanese Priority Patent Application JP 2009-297764 filed in the Japan Patent Office on Dec. 28, 2009, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A processor comprising:
an instruction buffer that separates a sequence of instructions formed from a plurality of instructions having no operand into a plurality of segments and stores the segments;
a data holding unit that holds data to be processed by using the plurality of instructions;
a decoder that references the data held in the data holding unit and sequentially decodes at least one of the instructions from the instruction located at the top of the sequence of instructions one by one;
an instruction execution unit that executes the instruction in accordance with a result of decoding performed by the decoder; and
an instruction sequence update control unit that controls updating of the sequence of instructions in accordance with the result of decoding performed by the decoder;
wherein when the decoded top instruction is a branch instruction and if a branch is taken, the instruction sequence update control unit updates the sequence of instructions so that the top instruction of any one of the segments comes to be located at the top of the sequence of instructions, and if a branch is not taken, the instruction sequence update control unit updates the sequence of instructions so that an instruction immediately next to the branch instruction comes to be located at the top of the sequence of instructions.

2. The processor according to claim 1, wherein a branch destination of the branch instruction is limited to an instruction at the top of the segment ahead of the segment including the branch instruction.

3. The processor according to claim 2, wherein the decoder decodes a function type regarding a function for executing an instruction and an execution type regarding updating of the sequence of instructions after the instruction is executed, and wherein the instruction execution unit executes the instruction in accordance with the function type, and wherein the instruction sequence update control unit controls updating of the sequence of instructions in accordance with the execution type.

4. The processor according to claim 3, wherein the decoder references the data held in the data holding unit and sequentially decodes a plurality of the instructions starting from the instruction located at the top of the sequence of instructions, and wherein the instruction execution unit concurrently executes a number of the instructions equal to a number determined in accordance with the function type, and wherein the instruction sequence update control unit controls updating of the sequence of instructions so that a number of the instructions equal to a number determined in accordance with the execution type are output from the instruction buffer.

5. The processor according to claim 4, wherein the instruction sequence update control unit has a function for shifting the instructions of only the top segment of the plurality of segments one by one and holds a state flag indicating whether each of the instructions contained in the top segment is held in only the top segment.

6. The processor according to claim 2, wherein data stored in the data holding unit includes a stack, and wherein a data item held at the top of the stack is output when execution of the sequence of instructions is completed.

7. The processor according to claim 6, wherein the stack has a predetermined number of stages, and if a number of data items that exceeds the predetermined number of stages are input to the stack, data items disappear from a data item held at the bottom of the stack.

8. The processor according to claim 6, further comprising:
a data format specifying unit that specifies a format of the data item output when execution of the sequence of instructions is completed.

9. The processor according to claim 2, wherein the data held in the data holding unit includes a queue, and wherein a data item held at the tail of the queue is output when execution of the sequence of instructions is completed.

10. The processor according to claim 9, further comprising:
a data format specifying unit that specifies a format of the data item output when execution of the sequence of instructions is completed.

11. A co-processor comprising:
an instruction buffer that receives, from a higher-layer processor, a sequence of instructions formed from a plurality of instructions having no operand, separates the instructions into a plurality of segments, and stores the segments;
a data holding unit that holds data to be processed by using the plurality of instructions;
a decoder that references the data held in the data holding unit and sequentially decodes at least one of the instructions from the instruction located at the top of the sequence of instructions one by one;
an instruction execution unit that executes the instruction in accordance with a result of decoding performed by the decoder;
an instruction sequence update control unit that controls updating of the sequence of instructions in accordance with the result of decoding performed by the decoder; and
an output unit that outputs the data held in the data holding unit when execution of the sequence of instructions is completed;
wherein when the decoded top instruction is a branch instruction and if a branch is taken, the instruction sequence update control unit updates the sequence of instructions so that the top instruction of any one of the segments comes to be located at the top of the sequence of instructions, and if a branch is not taken, the instruction sequence update control unit updates the sequence of instructions so that an instruction immediately next to the branch instruction comes to be located at the top of the sequence of instructions.

12. An information processing system comprising:
a higher-layer processor; and
a co-processor;
wherein higher-layer processor outputs, to the co-processor, a sequence of instructions formed from a plurality of instructions having no operand, and the co-processor receives the sequence of instructions from the higher-layer processor and outputs, to the higher-layer processor, a result of execution of the sequence of instructions when execution of the sequence of instructions is completed, and wherein the co-processor includes an instruction buffer that receives, from the higher-layer processor, a sequence of instructions formed from a plurality of instructions having no operand, separates the instructions into a plurality of segments, and stores the segments, a data holding unit that holds data to be processed by using the plurality of instructions, a decoder that references the data held in the data holding unit and sequentially decodes at least one of the instructions from the instruction located at the top of the sequence of instructions, an instruction execution unit that executes the instruction in accordance with a result of decoding performed by the decoder, an instruction sequence update control unit that controls updating of the sequence of instructions in accordance with the result of decoding performed by the decoder, and an output unit that outputs the data held in the data holding unit when execution of the sequence of instructions is completed, and wherein when the decoded top instruction is a branch instruction and if a branch is taken, the instruction sequence update control unit updates the sequence of instructions so that the top instruction of any one of the segments comes to be located at the top of the sequence of instructions, and if a branch is not taken, the instruction sequence update control unit updates the sequence of instructions so that an instruction immediately next to the branch instruction comes to be located at the top of the sequence of instructions.

13. An instruction sequence update control method for use in a processor including an instruction buffer that separates a sequence of instructions formed from a plurality of instructions having no operand into a plurality of segments and stores the segments, a data holding unit that holds data to be processed by using the plurality of instructions, a decoder that references the data held in the data holding unit and sequentially decodes at least one of the instructions from the instruction located at the top of the sequence of instructions, an instruction execution unit that executes the instruction in accordance with a result of decoding performed by the decoder, and an instruction sequence update control unit that controls updating of the sequence of instructions in accordance with the result of decoding performed by the decoder, the method comprising:
a first step of, when the decoded top instruction is a branch instruction and if a branch is taken, updating the sequence of instructions so that the top instruction of any one of the segments comes to be located at the top of the sequence of instructions; and
a second step of, if a branch is not taken, updating the sequence of instructions so that an instruction immediately next to the branch instruction comes to be located at the top of the sequence of instructions.
